(19) United States
(12) Patent Application Publication
(10) Pub. No.: US 2016/0283304 A1
(43) Pub. Date: Sep. 29, 2016

(54) PERFORMANCE PREDICTION METHOD, PERFORMANCE PREDICTION SYSTEM AND PROGRAM

(71) Applicant: HITACHI, LTD., Tokyo (JP)

(72) Inventors: Kazuo HORIKAWA, Tokyo (JP); Norihiro HARA, Tokyo (JP)

(21) Appl. No.: 14/777,933

(22) PCT Filed: Dec. 20, 2013
(86) PCT No.: PCT/JP2013/084274

§ 371 Date: Sep. 17, 2015

(51) Int. Cl. G06F 11/07; G06N 7/00

(52) U.S. Cl. CPC G06F 11/079; G06N 7/005; G06F 11/0709; G06F 11/076

(57) ABSTRACT

A performance prediction method, performance prediction system and program for predicting a performance of a monitoring target system including processing devices. A plurality of types of measurement values are acquired from the monitoring target system at regular intervals. A value at a future time of a reference index which is a portion of the measurement values is predicted, and the probability, based on a probability model, that a target event will be generated is calculated, the target event being an event in which a specific measurement value, which is different from the reference index at the future time, lies within the specific range, with the value of the reference index regarded as a prerequisite. An operation results value of the monitoring target system is included in the measurement values and an operation plan value of the monitoring target system is included in the reference index, which is time-series predicted.

### TECHNICAL FIELD

The present invention relates to a performance prediction method, performance prediction system and program, and can be suitably applied to an information processing system which detects predictors for the occurrence of faults in a customer monitoring target system and which provides monitoring services for notifying a customer of the detected predictors.

### BACKGROUND ART

In recent years, as information processing systems have assumed an increasingly important position as the foundation of corporate activities and social infrastructures, faults generated in information processing systems can no longer be overlooked. In other words, examples of fault events have been observed to have a huge social and economic impact and such events include events where an information processing system breaks down to the point of being unusable due to the occurrence of a fault, and events, in an online system, where, even if the system cannot be said to be unusable, usage is difficult as a result of a major deterioration in response performance.

In light of this situation, various technologies, which seek to permit early detection of the occurrence of a fault in such an information processing system and which conduct a root cause analysis of the occurred fault and take swift countermeasures, have been developed and applied to system operation management tasks.

In addition, in recent years, attention has been directed toward the importance of fault predictor detection technologies which detect the predictors of such fault generation before same occurs. With such technology, a fatal situation is prevented from arising by taking measures to preempt fault generation, thereby improving system availability and therefore improving the economic and social value provided by the system.

The technology disclosed in Patent Literature 1, for example, exists as a technology for tackling such predictor detection. Patent Literature 1 discloses a system for predicting the occurrence of an important event in a computer cluster, wherein this prediction system performs prediction by inputting information such as event logs and system parameter logs to a Bayesian network-based model.

### CITATION LIST

### Patent Literature

### [PTL1]

Specification of U.S. Pat. No. 7,451,210

### SUMMARY OF INVENTION

### Technical Problem

In current practical systems, there has been an increase in distributed processing systems which implement service provision by having software running on a plurality of servers and operating interactively. Furthermore, even on a single server, a plurality of programs operate interactively while fulfilling their respective roles as the OS (Operating System), middleware and application program. The key issue with such a system is whether the individual services provided by the system fulfill the required performance. For example, the response performance of the online service is also one such requirement.

In monitoring such systems, it is important nowadays to monitor not only failures and utilization of individual devices but also the input amount and output performance of the services provided by the devices being monitored. In case the performance of an online service is poor, a customer (end user) is frustrated and ends up stopping using the service, leading to loss of the customer.

In the foregoing PTL1, a Bayesian network is used in predicting future system states. With the Bayesian network, measurement values of the past times (time stamps) of items being monitored can be input in order to learn the probability of a given monitored item falling within a certain range of values, and, following this learning, calculation can be performed such that a portion of the monitored item values are taken as a prerequisite, that is, as an input, and the probability of another monitored item falling within a certain range of values is output.

A technology of the Bayesian network possesses the following properties. That is, there are three properties, namely:

Property 1: the higher the number of measurement values input as prerequisites, the higher the prediction accuracy;

Property 2: The greater the number of nodes (the monitored items, that is, measurement values) constituting the Bayesian network, the greater the learning time; and

Property 3: The greater the number of times when the measurement values used in the learning are taken, the greater the learning time.

That is, with performance prediction using the Bayesian network, there is a trade-off between processing speed and prediction accuracy which depends on the number of nodes constituting the Bayesian network and the number of times (when the measurement values are taken) used in the generation of the Bayesian network.

In view of the above points, in the foregoing PTL1, since the performance prediction is performed by using only the measurement values pertaining to the inherent performance of the monitoring target system, there is a problem in that the number of monitored items that can be input as prerequisites, as described in Property 1, is very small. Further, the actual behavior of the monitoring target system also varies depending on how the monitoring target system is operated, and there is therefore also the problem that when a performance prediction is made using only the measurement values related to the inherent performance of the monitoring target system, a sufficiently accurate prediction can sometimes not be made.

In addition, in PTL1, in case there is an increase in the number of monitored items, there is a problem in that the learning time is huge and also the problem that prediction which is erroneous due to the passage of time and due to learning processing that also uses past measurement values which is unsuitable after the system behavior has changed.

The present invention was conceived in view of the above points and a first object of the present invention is to provide a performance prediction method, performance prediction system and program which enable more accurate performance prediction to be performed. A second object of the present invention is to provide a performance prediction method, performance prediction system and program which enable earlier prediction of compromised service performance.

### Solution to Problem

In order to solve these problems, the present invention is a performance prediction method for predicting a performance of a monitoring target system including one or more information processing devices, the performance prediction method comprising a first step of acquiring a plurality types of measurement values from the monitoring target system at regular intervals, a second step of generating a probability model for calculating a probability on which the measurement values respectively lye within a specific value range, a third step of predicting a value at a future time of a reference index which is a portion of the measurement values, and a fourth step of calculating a probability on which a target event will occur, based on the probability model, the target event being an event in which a specific measurement value, which is different from the reference index at the future time, lies within the specific range, with the value of the reference index regarded as a prerequisite, wherein an operation results value of the monitoring target system is included in the measurement values of the second step, wherein an operation plan value of the monitoring target system is included in the reference index of the third step, and wherein the reference index is time-series predicted in the third step.

Furthermore, the present invention is a performance prediction system for predicting a performance of a monitoring target system including one or more information processing devices, the performance prediction system comprising an accumulation device which acquires and accumulates a plurality types of measurement values from the monitoring target system at regular intervals, and a performance prediction device which generates a probability model for calculating a probability on which the measurement values respectively lye within a specific value range, predicts a value at a future time of a reference index which is a portion of the measurement values, and calculates the probability, based on the probability model, on which a target event occur, the target event being an event in which a specific measurement value, which is different from the reference index at the future time, lies within the specific range, with the value of the reference index regarded as a prerequisite, wherein an operation results value of the monitoring target system is included in the measurement values, wherein an operation plan value of the monitoring target system is included in the reference index, and wherein the performance prediction device time-series predicts the reference index.

In addition, the present invention is a program for causing an information processing device to execute performance prediction processing for predicting a performance of a monitoring target system including one or more information processing devices, said performance prediction processing comprising a first step of generating a probability model for calculating a probability on which a plurality types of measurement values, acquired at regular intervals from the monitoring target system, lie within a specific value range, a second step of predicting a value at a future time of a reference index which is a portion of the measurement values, and a third step of calculating a probability on which a target event occur, based on the probability model, the target event being an event in which a specific measurement value, which is different from the reference index at the future time, lies within the specific range, with the value of the reference index regarded as a prerequisite, wherein an operation results value of the monitoring target system is included in the measurement values of the first step, wherein an operation plan value of the monitoring target system is included in the reference index of the second step, and wherein the reference index is time-series predicted in the second step.

According to the performance prediction method, performance prediction system and program of the present invention, performance prediction which also takes into account operation plans and operation results of a monitoring target system can be performed.

### Advantageous Effects of Invention

A performance prediction method, performance prediction system and program which enable more accurate performance prediction can be realized.

### BRIEF DESCRIPTION OF DRAWINGS

FIG. 1 is a block diagram showing a configuration example of an information processing device.

FIG. 2 is a block diagram showing an overall configuration of an information processing system according to the present embodiment.

FIG. 3 is a block diagram showing a conceptual configuration of a monitoring target system.

FIG. 4A is a conceptual view conceptually showing a configuration of a processor performance information management table.

FIG. 4B is a conceptual view conceptually showing a configuration of a memory performance information management table.

FIG. 5A is a conceptual view conceptually showing a configuration of a measurement value combination table.

FIG. 5B a conceptual view conceptually showing a configuration of a measurement value and performance index combination table.

FIG. 6 is a block diagram showing a logical configuration of a predictor server.

FIG. 7 is a conceptual view conceptually showing a configuration of a system profile table.

FIG. 8 is a conceptual view conceptually showing a configuration of a prediction profile table.

FIG. 9A is a conceptual view conceptually showing a configuration of scheduler information.

FIG. 9B is a conceptual view conceptually showing a configuration of a task list table.

FIG. 10A is a flowchart showing a processing routine for task activation processing.

FIG. 10B is a flowchart showing a processing routine for task execution control processing.

FIG. 10C is a flowchart showing a processing routine for task end recovery processing.

FIG. 11A is a flowchart showing a processing routine for abort processing.

FIG. 11B is a flowchart showing a processing routine for interval shortening trial processing.

FIG. 12A is a flowchart showing a processing routine for remodeling processing.

FIG. 12B is a flowchart showing a processing routine for fitting processing.

FIG. 13A is a conceptual view conceptually showing a configuration of a model repository.

FIG. 13B is a conceptual view conceptually showing a configuration of a prediction model repository.

FIG. 13C is a conceptual view conceptually showing a configuration of a learning target period repository.

FIG. 13D is a conceptual view conceptually showing a configuration of a grouping repository.

FIG. 14A is a flowchart showing a processing routine for inference processing.

FIG. 14B is a flowchart showing a processing routine for time-series prediction processing.

FIG. 14C is a flowchart showing a processing routine for probability inference processing.

FIG. 15 is a configuration example of a Bayesian network which is configured from monitored items of only information processing system performance and service inputs and performance.

FIG. 16 is a configuration example of a Bayesian network which is configured from monitored items which also include task operation information and system operation information in addition to computer system performance information and service inputs and performance.

FIG. 17A is a block diagram showing a logical configuration of a web server.

FIG. 17B is a conceptual view conceptually showing a configuration of an output data repository and internal table.

FIG. 18 is a block diagram showing a logical configuration of a management server.

FIG. 19 is a conceptual view conceptually showing a configuration of a type name repository.

FIG. 20 is a conceptual view conceptually showing a configuration of a sales prediction and results repository.

FIG. 21 is a conceptual view conceptually showing a configuration of a business day calendar repository.

FIG. 22 is a conceptual view conceptually showing a configuration of an operation plan repository.

FIG. 23 is a conceptual view conceptually showing a configuration of an operation results repository.

FIG. 24 is a conceptual view conceptually showing a configuration of a service-task layer-task server mapping repository.

FIG. 25 is a flowchart showing a processing routine for sales prediction acquisition and recording processing.

FIG. 26 is a flowchart showing a processing routine for sales results acquisition and recording processing.

FIG. 27 is a flowchart showing a processing routine for service plan acquisition and recording processing.

FIG. 28 is a flowchart showing a processing routine for task server operation plan acquisition and recording processing.

FIG. 29 is a flowchart showing a processing routine for task server operation results acquisition and recording processing.

FIG. 30 is a flowchart showing a processing routine for service results acquisition and recording processing.

FIG. 31A is a flowchart showing a processing routine for request reception processing.

FIG. 31B is a flowchart showing a processing routine for request reception processing.

FIG. 32 is a flowchart showing a processing routine for learning period adjustment processing.

FIG. 33 is a conceptual view showing a data structure of various data which is used in the Bayesian network reduction processing.

FIG. 34A is a flowchart showing a processing routine for Bayesian network reduction processing.

FIG. 34B is a flowchart showing a processing routine for Bayesian network reduction processing.

FIG. 34C is a flowchart showing a processing routine for adoption processing.

FIG. 35 is a conceptual view showing a data structure of various data which is used in reduced Bayesian network compulsory operation node addition processing.

FIG. 36 is a flowchart showing a processing routine for reduced Bayesian network compulsory node addition processing.

FIG. 37 is a schematic diagram showing an outline of a screen configuration example of a Bayesian network display screen.

FIG. 38 is a conceptual view conceptually showing a configuration of Bayesian network display configuration information.

FIG. 39 is a flowchart showing a processing routine for Bayesian network display screen display processing.

FIG. 40 is a schematic diagram showing an outline of a screen configuration example of a target event generation probability screen.

FIG. 41 is a conceptual view conceptually showing a configuration of target event generation probability display configuration information.

FIG. 42 is a flowchart showing a processing routine for target event generation probability display processing.

FIG. 43 is a conceptual view of a data structure of various data which is used in second time-series prediction processing.

FIG. 44 is a flowchart showing a processing routine for second time-series prediction processing.

FIG. 45 is a block diagram showing a configuration of an information processing system according to another embodiment.

### DESCRIPTION OF EMBODIMENTS

An embodiment of the present invention will be described in detail hereinbelow with reference to the drawings.

In this specification, the main terms are used as defined below:

(A) Monitored items: quantifiable items in the monitoring target system. Example: memory utilization of information processing device (ap1.mem).

(B) Measurement values: values obtained by measuring the monitored items. Example: actual measured value of memory utilization of information processing device (ap1.mem=1024 megabytes).

(C) Target index: most interesting among the measurement values. In the present embodiment, this is the output performance of the monitoring target system (svcA.art).

(D) Target event: when the target index falls or does not fall in a certain value range, this is called a ‘target event.’ For example, ‘svcA.art>5 sec’ is a target event. Hereinafter, a target event is sometimes referred to as a ‘prediction event.’

(E) Non-target index: neither the target index nor a reference index, node of Bayesian network (ap1.cpu).

(F) Non-target event: second target index (ap1.cpu>0.9) in claims.

(G) Reference index: prerequisite input to Bayesian network inference processing. For example, the number of simultaneous service connections ‘svcA.cu’, ‘does prediction target time fall within range 8:00 to 16:00?’, ‘has brick-and-mortar store opened by prediction target date (time)?’ and ‘multiplicity of application server layer (AP layer)=1’ are reference indices of the present embodiment.

(H) Time-series prediction: linear prediction or average value of past identical times.

(I) Inference: Probability inference using Bayesian network. Note that hereinafter ‘time-series prediction’ and ‘inference’ are used basically as described hereinabove. There are also cases where ‘prediction’ alone is used and where ‘inference’ is used in the general sense.

### (1) Configuration of Information Processing System According to the Present Embodiment

The configuration of an information processing system according to the present embodiment will be described below. Upon doing so, the configuration of individual information processing devices which the information processing system according to the embodiment comprises will first be described.

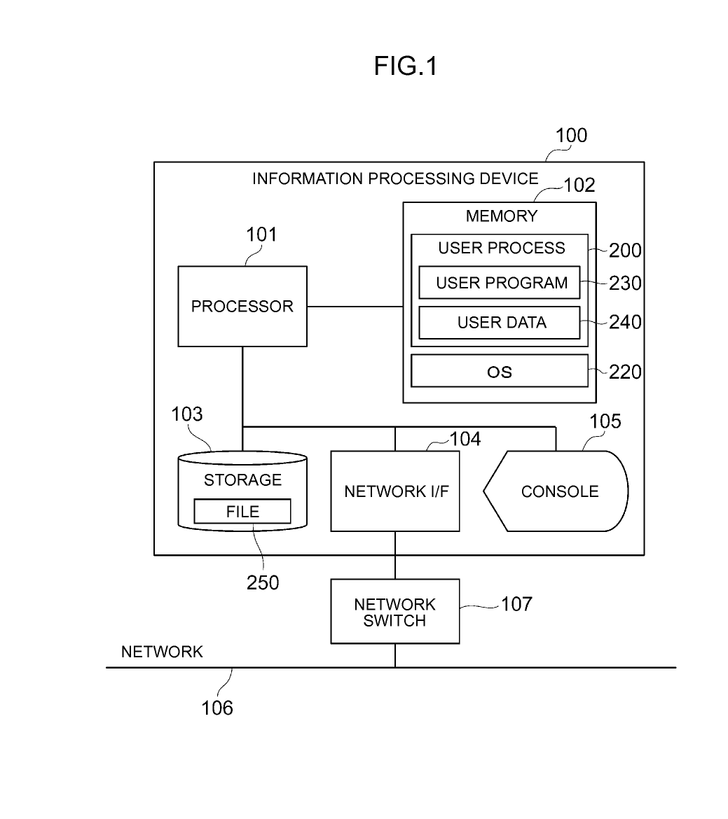

FIG. 1 shows an example of a configuration of an information processing device. An information processing device 100 is configured, for example, from a rack mount server, a blade server or a personal computer, or the like, and comprises a processor 101, a memory 102, storage 103, a network I/F (Interface) 104 and a console 105. The processor 101 is connected to the memory 102, storage 103, network I/F 104 and console 105. The network I/F 104 is connected to a network 106 via a network switch 107.

The information processing device 100 comprises a plurality of all of the processor 101, memory 102, storage 103, network I/F 104 and console 105. Further, the storage 103 is, for example, a hard disk drive (HDD) or a solid state drive (SSD) or the like, or a combination of a plurality thereof. Further, the network 106 is, for example, a wireless network based on the Ethernet (registered trademark) protocol or IEEE (Institute of Electrical and Electronics Engineers) 802.11 protocol or a wide-area network based on the SDH/SONET (Synchronous Digital Hierarchy/Synchronous Optical NETwork) protocol, or a network obtained by combining a plurality of these network technologies.

The storage 103 records data in an non-volatile state and is readable. The network I/F 104 is able to communicate with a network I/F 104 of another information processing device 100 via the network 106 which is connected to the former network I/F 104. The console 105 uses a display device to display text information, graphical information, and the like, and is able to receive information from a connected human interface device (not shown).

In the information processing device 100, a user process 200 and an operating system (OS) 220 are installed in the memory 102. The user process 200 and operating system 220 are both programs which are executed by the processor 101. Thus, the information processing device 100 is able to read and write data from/to the memory 102 and storage 103, communicate with the user process 200 and operating system 220 installed in the memory 102 of another information processing device 100 via the network I/F 104 and network 106, and receive and display information on the console 105.

The user process 200 may exist in a plurality in a single information processing device 100. The user process 200 is configured from a user program 230 and user data 240. The user program 230 contains instructions executed by the processor 101. The user data 240 is data specific to the user process 200, and a file 250 on the storage 103 which has been memory-mapped by the operating system 220. The user program 230 is able to use the file read/write function of the operating system 220 in the system core and read and/or write files which have been memory-mapped by the operating system 220 by reading from and writing to the memory in response to instructions in the user program 230.

The operating system 220 and user program 230 are each stored as files 250 of the storage 103. While the information processing device 100 is starting up, the processor 101 reads the operating system 220 from the file to the memory 102 and executes the operating system 220 on the memory 102. When the user process 200 is starting up, the processor 101 reads the user program 230 from the file to the memory 102 and runs the user program 230 in the memory 102.

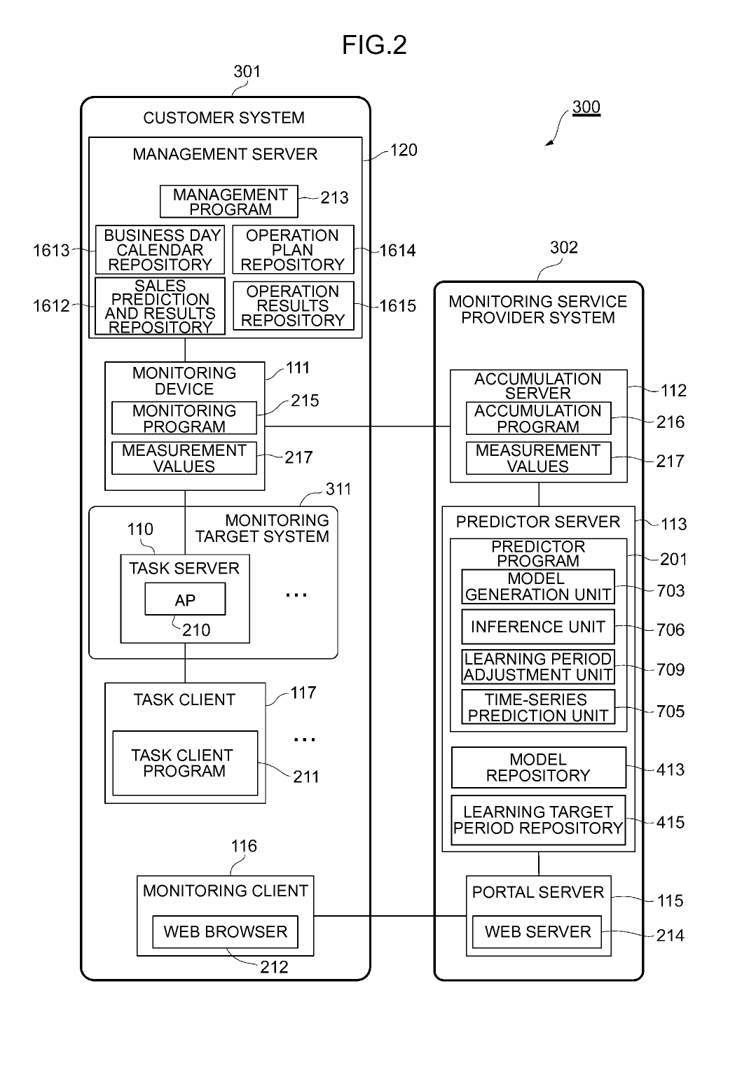

FIG. 2 shows a schematic framework of an information processing system 300 according to the present embodiment. As shown in FIG. 2, the information processing system 300 is configured from a customer system 301 which is provided on the customer site and a monitoring service provider system 302 which is provided on the site of the monitoring service provider.

The customer system 301 and monitoring service provider system 302 both comprise one or more of the information processing device 100 described hereinabove with reference to FIG. 1, and are configured so as to be mutually connected via a network 106 and one or more network switches 107.

The customer site, on which the customer system 301 is provided, and the monitoring service provider site, in which the monitoring service provider system 302 is provided, are typically in geographically remote locations and connected via a wide area network; however, these sites may take a different form, that is, both sites may be in the same data center, for example, and connected via a network in the data center. Irrespective of the form, the customer system 301 and monitoring service provider system 302 are each able to communicate with one another via a connected network.

Communications between this customer system 301 and monitoring service provider system 302 can be limited by the configuration of the network router or firewall device (not shown) or the like on the grounds of maintaining information security, but the communications required according to the present embodiment are configured so as to be enabled.

The customer system 301 comprises a task server 110, a monitoring device 111, a monitoring client 116, a task client 117, and a management server 120, which are each configured from the information processing device 100 (FIG. 1).

Installed on the task server 110 is an application program 210 as the user process 200 (FIG. 1) and the task server 110 executes processing in response to requests from the task client 117 by running the application program 210.

The monitoring device 111 collects measurement values 217 from the task server 110 at regular intervals and stores the collected measurement values 217 after converting same into files. In FIG. 2, a monitoring target system 311 which acquires the measurement values 217 is configured from a plurality of the task server 110. Although the targets for collecting the measurement values 217 are typically the task servers 110, the targets are not limited thereto, rather, monitoring targets can include the task client 117, the network switch 107, NAS (Network Attached Storage) and/or SAN (Small Area Network) storage, and the like. The values of the measurement values 217 which are collected here will be described subsequently.

The monitoring client 116 presents information to the system administrator of the customer system 301 via the console 105 (FIG. 1) and receives information which is input by the system administrator. Installed on the task client 117 is a task client program 211 as the user process 200 (FIG. 1) and the task client 117 executes predetermined processing which depends on the tasks performed by the client by running this program 211.

The task client program 211 communicates with the application program 210 run by the task server 110. As a result of mutual communications between these programs, the method for configuring an application program to achieve a specific task-based objective is called a client-server system and is well known to the person skilled in the art in the form of a web application. The task clients 117 may be installed in a separate location from the customer system 301. The task clients 117 each communicate with the task server 110 via a connected network.

The management server 120 manages plans and results of task operations of the customer system 301 and system operation plans and results. The management server 120 comprises a management program 213, an operation plan repository 1614, an operation results repository 1615, a sales prediction and results repository 1612, and a business day calendar repository 1613. The details of same will be provided subsequently. Repositories are files.

The monitoring service provider system 302 comprises an accumulation server 112, a predictor server 113 and a portal server 115 which are each configured from the information processing device 100 (FIG. 1). The accumulation server 112 receives the measurement values 217 collected by the monitoring device 111 at regular intervals and accumulates the received measurement values 217 after converting same into files. As for the communication for receiving the measurement values 217, either a method for starting communication which is initiated by the monitoring device 111 or a method for starting communication which is conversely initiated by the accumulation server 112 may be selected.

The predictor server 113 acquires the measurement values 217 accumulated by the accumulation server 112 from the accumulation server 112 and performs detection to predict fault generation (non-attainment of the performance of the monitoring target system 311) based on the acquired measurement values 217 and the like. A predictor program 201 is installed on the predictor server 113 as the user process 200 (FIG. 1).

The predictor program 201 is configured from a model generation unit 703 for performing model generation by receiving, as inputs, the measurement values 217 acquired from the accumulation server 112, various information stored in the operation plan repository 1614, and various information stored in the operation results repository 1615; an inference unit 706 for inferring the probability that a target event will be generated (for detecting fault generation predictions) by using models generated by the model generation unit 703; a learning period adjustment unit 709 for adjusting the learning period used in the model generation; and a time-series prediction unit 705, and the like. The components other than the predictor program 201 will be described below in detail. Further, the storage 103 (FIG. 1) of the predictor server 113 stores, as files, a model repository 413 for storing models generated by the predictor program 201 and a learning target period repository 415 where learning periods are recorded, and the like. The other files in the storage 103 of the predictor server 113 will be described in detail hereinbelow.

The portal server 115 transmits the measurement values 217 accumulated by the accumulation server 112 and the results of the predictor server 113 inferring the probability that a target event will be generated (detecting fault generation predictions) to the monitoring client 116 of the customer system 301 in response to a request from the system administrator of the customer system 301. Typically, the web browser 212 which is installed as the user process 200 (FIG. 1) on the monitoring client 116 provided in the customer system 301 issues an information presentation request to the portal server 115 of the monitoring service provider system 302 based on an instruction from the system administrator which is received via the console 105 (FIG. 1). Further, the web browser 212 of the monitoring client 116 displays the information transmitted from the web server 214 of the portal server 115 in response to this request, on the console 105 (FIG. 1).

However, the web browser 212 of the monitoring client 116 may also issue a request to present information to the web server 214 of the portal server 115 at optional intervals which are determined beforehand. Further, as means for presenting the information acquired by the web browser 212 of the monitoring client 116 to the system administrator of the customer system 301, the acquired information is not limited to a case where the acquired information is displayed on a display device of the console 105, rather, optional means which is suitable for the system administrator can be adopted, such as providing this information by means of a phone call or electronic mail.

The task server 110, monitoring device 111, monitoring client 116, task client 117, and management server 120 of the customer system 301, and the accumulation server 112, predictor server 113 and portal server 115 of the monitoring service provider system may all be installed in a plurality with the objective of improving the processing load distribution and availability and so forth, or one information processing device 100 may play the part of these devices of a plurality of types. Note that there is a degree of freedom in the relationships between the physical information processing devices 100 and the roles performed by these devices and the present embodiment is one example among a multiplicity of combinations thereof.

By installing the monitoring service provider system 302 on the monitoring service provider site in this way, the customer system 301 is able to benefit from fault predictor detection services which are provided by the monitoring service provider system 302 without installing the accumulation server 112 and predictor server 113 on the customer site. The accumulation server 112 and predictor server 113 require hardware resources such as a high-speed processor, large-capacity storage and the like for the purpose of data accumulation and processing, and from a customer standpoint, this has the effect of obviating the need to include such high-performance and costly hardware in the customer system.

Further, the monitoring services by the monitoring service provider system 302 can also be provided for a plurality of customer systems 301. FIG. 2 shows an embodiment in which there is one of each of the customer system 301 and monitoring service provider system 302, but this does not mean that an individual monitoring service provider system 302 is required for every customer system 301. System monitoring services can also be provided for a plurality of customer systems 301 by a single monitoring service provider system 302.

In this case, the accumulation server 112, predictor server 113 and portal server 115 which are located in the monitoring service provider system 302 are each supplied for the provision of services for a plurality of customer systems 301. For example, the accumulation server 112 accumulates the accumulation values 217 which are transmitted from the plurality of monitoring devices 111 and the portal server 115 provides information to a plurality of monitoring clients 116. Similarly, the predictor server 113 selects the predictor detection and handling method based on the measurement values collected by the plurality of monitoring devices 111.

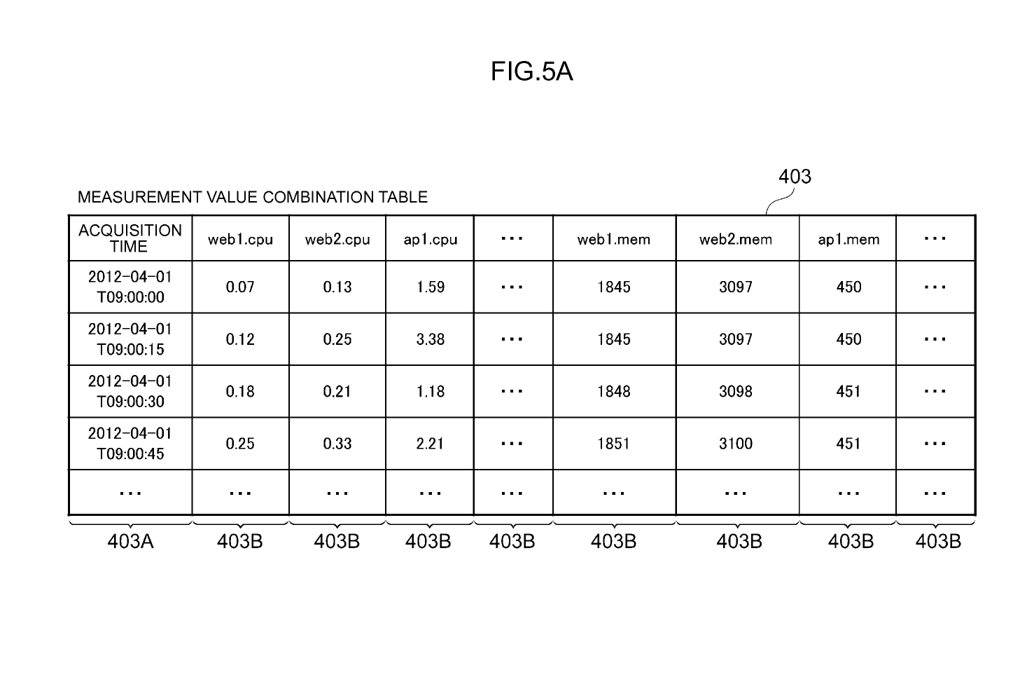

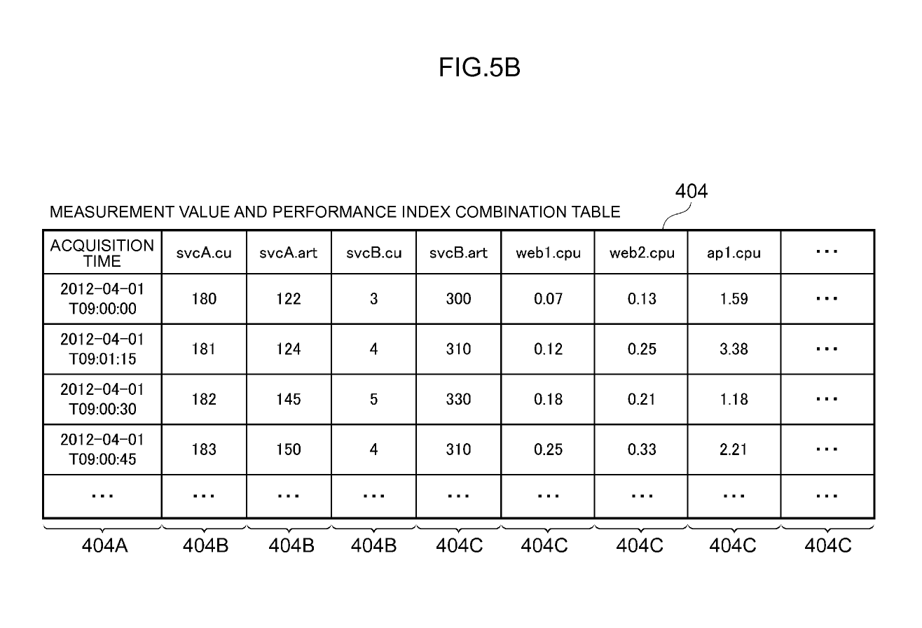

The accumulation server 112, predictor server 113 and portal server 115 of the monitoring service provider system 302 share codes for discriminating between a plurality of customer systems 301 in order to distinguish and handle the respective measurement values 217 collected by the plurality of customer systems 301. Since methods for distinguishing data and providing security protection by assigning codes are well known to the person skilled in the art, such codes are omitted from the following description. In addition, the information stored in the tables described below and the information displayed by the console 105 (FIG. 5) will be similarly omitted.

### (2) Main Components of the Customer System

The configuration of the monitoring target system 311 and management server 120, which are the main components of the customer system 301, and the measurement values 217 collected by the monitoring devices 111 from the monitoring target system 311, as well as the method for managing the measurement values 217, will be described next.

(2-1) Configuration of Monitoring Target System

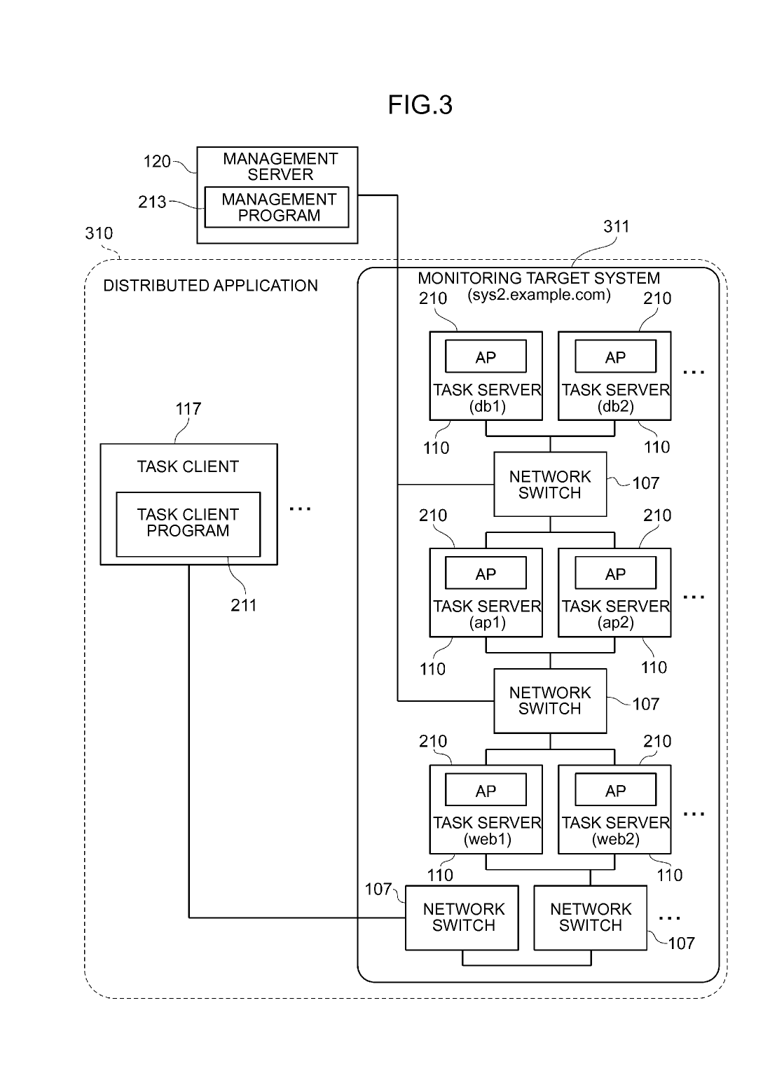

FIG. 3 shows a configuration example of the monitoring target system 311 in the customer system 301. For the service targets of the system monitoring service, the task servers 110 of the customer system 301 are often used as the units but are the units are not limited thereto.

The application program 210 is installed on the task server 110 as the user process 200 (FIG. 1) as described hereinabove. This application program 210 need not be executed by the task server 110 alone. Rather, the form normally taken by an information processing system is one where the plurality of task servers 110 each have application programs fulfilling different roles and so-called middleware programs supporting the execution of such programs, and such that a plurality of programs communicate with one another while being executed to fulfill a certain task-based objective. Generally, an application whereby a multiplicity of programs which are distributed and installed on this plurality of information processing devices operate cooperatively is called a distributed application and such an information processing system is called a distributed processing system.

Typically, installed on the task servers 110 is the application program 210 as the user process 200 (FIG. 1). The task client 117 has a task client program 211 installed as the user process 200. The task server 110 and task client 117 both exist in a plurality and are mutually connected via the network 106 (FIG. 1) by way of the network switch 107 (FIG. 1).

FIG. 3 shows a configuration in which a distributed application 310 comprises a web 3-tier model, that is, a web layer, an application layer, and a database layer, but the configuration is not limited thereto. Further, the management server 120 is connected by the network 106 and network switches 107 to the task servers 110 and is able to acquire the results of task operations and system operations.

The application program 210 and task client program 211 comprise one distributed application 310. In a system monitoring service, the group of devices pertaining to the execution of the distributed application 310 is called the ‘monitoring target system 311,’ and forms the unit for demarcating and distinguishing between the device groups constituting the customer system 301.

However, among the task clients 117, there are also those which, despite being part of the distributed application 310, are clearly unsuitable as targets for monitoring by the monitoring devices 111 on account of being installed separately from the customer system 301 (FIG. 2) or having only temporary connectivity via the network, and so on. Further, in the case of a web application, for example, taking individual task clients 117 as monitoring targets is difficult since a web application is configured to process communications by an unspecified multiplicity of task client programs 211 via the Internet. Such a device can be installed outside the monitoring target system 311.

Generally, the system administrator must not only ascertain the individual operation state of the information processing devices 100 in the customer system 301 but also the operation state of the whole distributed processing system. The concept of a monitoring target system of a system monitoring service was introduced with this idea in mind.

(2-2) Content and Management of Measurement Values

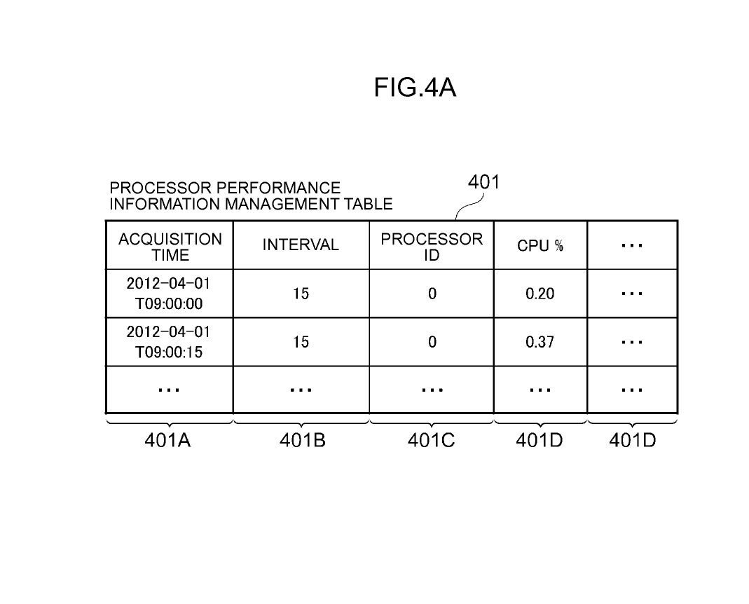

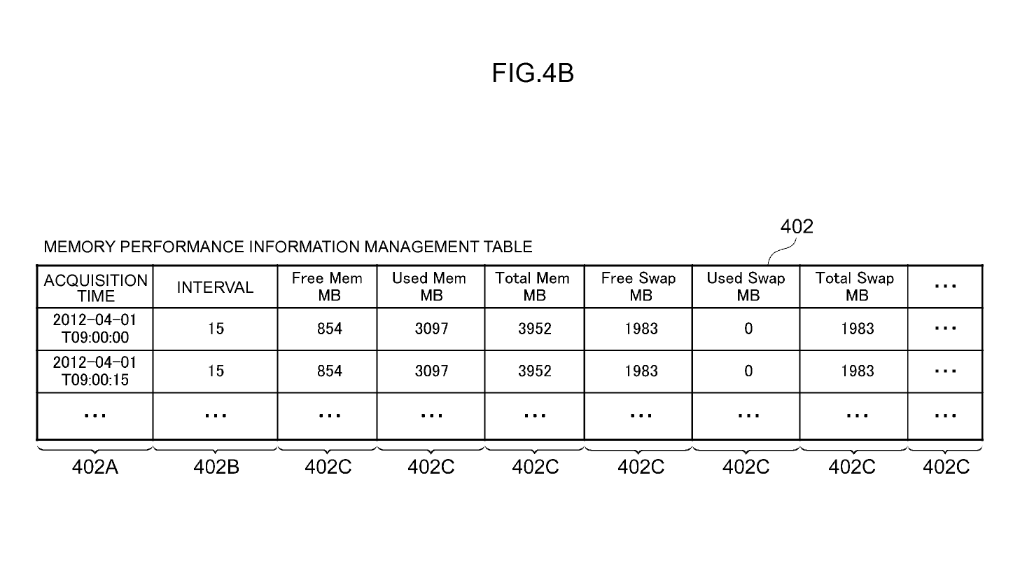

FIGS. 4A and 4B show a configuration example of a processor performance information management table 401 and a memory performance information management table 402 respectively which are used to store the measurement values 217 (FIG. 2) collected by the monitoring device 111 from each of the task servers 110 (FIG. 2) in the monitoring target system 311.

In the present embodiment, the measurement values 217 collected by the monitoring device 111 from each of the task servers 110 are performance information of the processor 101 (FIG. 1) in each task server 110 (hereinafter suitably called ‘processor performance information’) and performance information of the memory 102 (FIG. 1) in each task server 110 (hereinafter suitably called ‘memory performance information’). The monitoring device 111 and accumulation server 112 store and manage the processor performance information acquired from each task server 110 in the processor performance information management table 401 (FIG. 4A) and store and manage memory performance information acquired from each task server 110 in the memory performance information management table 402 (FIG. 4A).

As shown in FIG. 4A, the processor performance information management table 401 is configured from an acquisition time field 401A, an interval field 401B, a processor ID field 401C, and a plurality of measurement value storage fields 401D, and each row shows one processor performance information item.

Further, the acquisition time field 401A stores the time (acquisition time) when the corresponding processor performance information was acquired, and the interval field 401B stores the time (interval) since the previous processor performance information was acquired for the corresponding processor until the current processor performance information was acquired.

In addition, the processor ID field 401C stores the IDs (processor IDs) assigned to the corresponding processors and the measurement value storage fields 401D each store various measurement values related to the processor operation state such as the processor operation rate and idling rate in the period since the previous processor performance information was acquired until the current processor performance information was acquired.

The memory performance information management table 402 is configured from an acquisition time field 402A, an interval field 402B, and a plurality of measurement value storage fields 402C and each row shows one memory performance information item.

Further, the acquisition time field 402A stores the time (acquisition time) when the corresponding memory performance information was acquired and the interval field 402B stores the time (interval) since the previous memory performance information was acquired for the corresponding memory until the current memory performance information was acquired. Additionally, the measurement value storage fields 402C each store various measurement values 217 related to the memory usage status such as the unused capacity, used capacity and total capacity of the corresponding memory respectively.

These measurement values 217 are typically acquired from the operating system and transmitted to the monitoring device 111 by means of a method where an agent (not shown) which is installed as the user process 200 (FIG. 1) on the task server 110 executes commands, reads special files, or uses a dedicated API (Application Program Interface).

In the present embodiment, although two items of information, namely, processor performance information and memory performance information are considered as representative of the measurement values 217, the present embodiment is not limited to these two information items, rather, statistical information which can be collected by the monitoring device 111 can also similarly be taken as the measurement values 217. For example, the data transmission/reception amount for each network port can be collected via the network switch 107 (FIG. 1) using a protocol such as the SNMP (Simple Network Management Protocol). Further, the data transfer amount for each logical unit (LU) can be acquired from the storage 103 by means of a protocol such as CIM/WBEM (Common Information Model/Web-Based Enterprise Management) or S.M.A.R.T. (Self-Monitoring Analysis and Reporting Technology), for example.

FIGS. 5A and 5B show configuration examples of the measurement value combination table 403 and measurement value and performance index combination table 404. The fact that the measurement values 217 collected by the monitoring device 111 contain the times same were acquired has already been mentioned earlier. Using these acquisition times, among the respective measurement values 217 collected by each of the task servers 110 which the monitoring target system 311 comprises, measurement values 217 with the same acquisition times can be combined. Thus, a table created by combining the measurement values 217 collected from each of the task servers 110 which the monitoring target system 311 comprises is the measurement value combination table 403 shown in FIG. 5A. Hence, the measurement value combination table 403 is created for each monitoring target system 311.

As shown in FIG. 5A, the measurement value combination table 403 is configured from an acquisition time field 403A and a plurality of measurement value fields 403B. Further, the acquisition time field 403A stores the time the measurement value 217 of that column was acquired (acquisition time) and the measurement value fields 403B each store the respective values of the measurement value 217 corresponding to those measurement value fields 403B.

Furthermore, the input amount and performance of the distributed application 310 (FIG. 3) of the monitoring target system 311 can also be similarly combined. FIG. 5B shows a configuration example of the measurement value and performance index combination table 404 which is configured by combining the input amount and performance of the distributed application 310 of the monitoring target system 311.

As shown in FIG. 5B, the measurement value and performance index combination table 404 is configured from an acquisition time field 404A, a plurality of distributed application input amount/performance fields 404B and a plurality of measurement value fields 404C.

The acquisition time field 404A stores the times the measurement values and the like for that row were acquired (acquisition times) and the distributed application input amount/performance fields 404B each store the input amount or performance of the distributed application 310 in the corresponding monitoring target system 311. For example, in the example of FIG. 5B, ‘svcA.cu’ denotes the number of users simultaneously connected to a service A, ‘svcA.art’ denotes the average response time of service A. In a case where there is a plurality of web servers, ‘svcA.cu’ is the total of ‘svcA.cu’ on a plurality of web servers, and ‘svcA.art’ is a weighted average denoted by the following equation for ‘svcA.art’ on a plurality of web servers:

$$\begin{matrix}[ Equation 1 ] & \\ \frac{\begin{matrix}web 1. svcA . art \times web 1. svcA . cu + \\ web 2. svcA . art \times web 1. svcA . cu\end{matrix}}{web 1. svcA . cu + web 2. svcA . cu} & ( 1 )\end{matrix}$$

Furthermore, the measurement value fields 404C each store the respective corresponding measurement values which are collected from each of the task servers 110 which the monitoring target system 311 comprises.

This combination processing (that is, the creation of the measurement value combination table 403 and measurement value and performance index combination table 404) may also be carried out by any device among the monitoring device 111, accumulation server 112 and predictor server 113.

(2-3) Configuration of Management Server

(2-3-1) Logical Configuration of Management Server

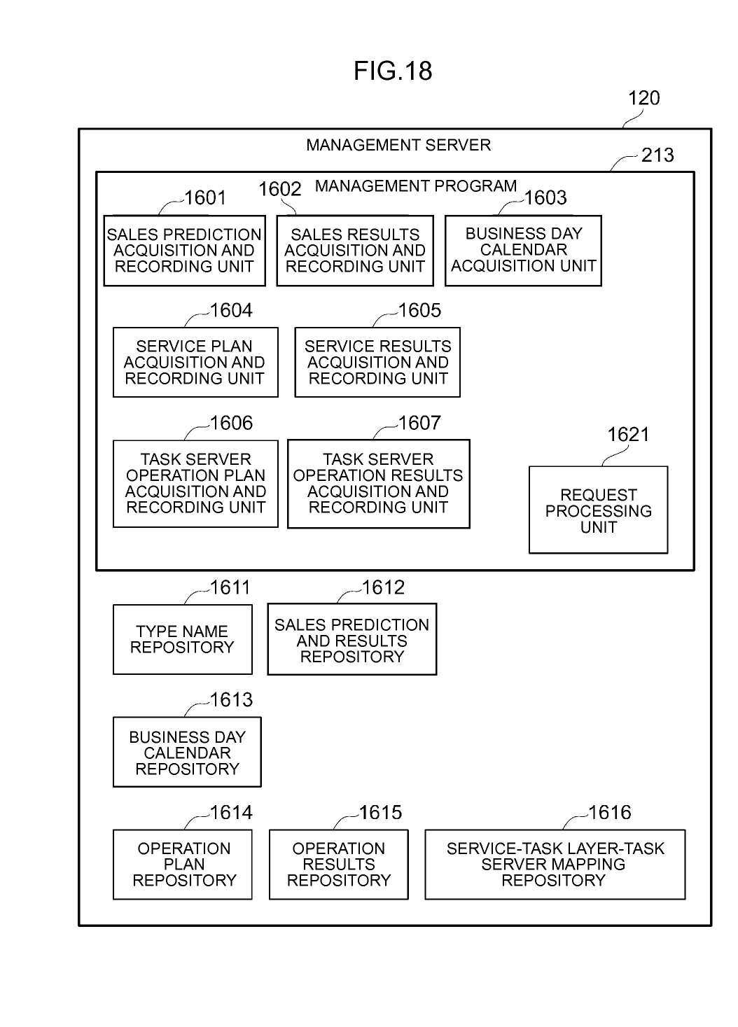

FIG. 18 shows the logical configuration of the management program 213 which is executed by the management server 120 and a repository group which is read/written by the management program 213.

The management program 213 is configured comprising a sales prediction acquisition and recording unit 1601, a sales results acquisition and recording unit 1602, a business day calendar acquisition unit 1603, a service plan acquisition and recording unit 1604, a service results acquisition and recording unit 1605, a task server operation plan acquisition and recording unit 1606, a task server operation results acquisition and recording unit 1607, and a request processing unit 1621, which are all objects.

Furthermore, the management server 120 comprises, as a repository group, a type name repository 1611, a sales prediction and results repository 1612, a business day calendar repository 1613, an operation plan repository 1614, an operation results repository 1615, and a service-task layer-task server mapping repository 1616. These repositories are held as files in the storage 103 (FIG. 1).

The management program 213 receives a request from the monitoring device 111 and issues a response to the request. Details of the processing will be provided in detail subsequently. The objective of the management program 213 is to enable, by providing a task operation plan and results and a system operation plan and results to the accumulation server 112 in the same way as the other monitored items (measurement values 217), the predictor program 201 to use the task operation plan and results and a system operation plan and results in computing the learning and inference of the target event generation probability (predictor detection of fault generation). While the monitoring device 111 is transmitting the foregoing request to the management program 213 and receiving a response, the accumulation server 112 accumulates the responses while handling the responses as measurement values 217 in the same way as other measurement values.

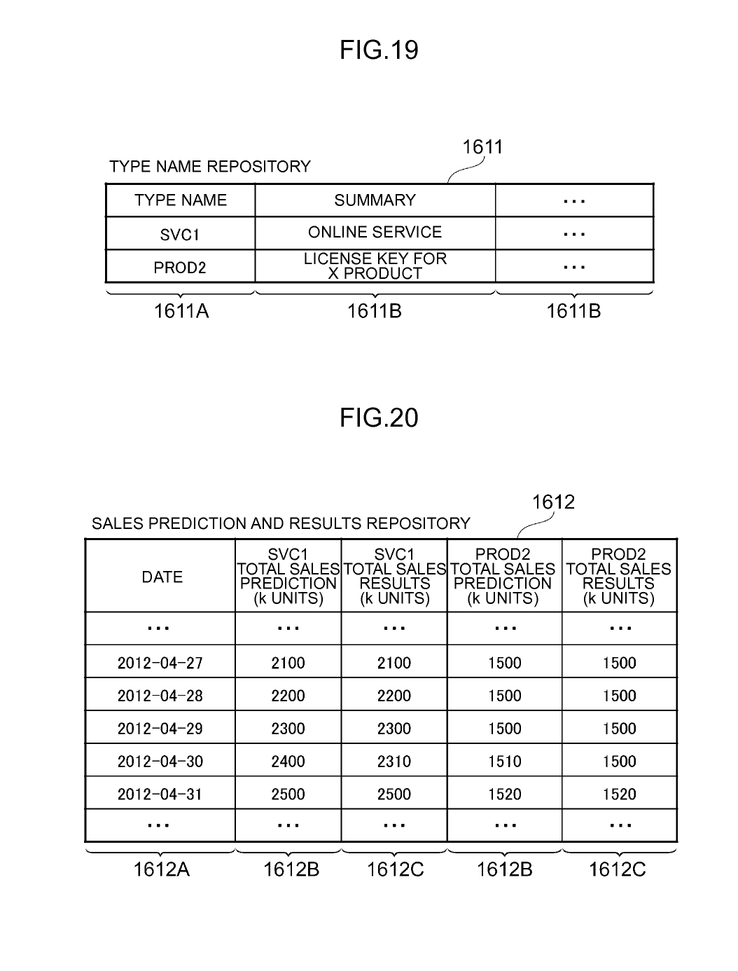

FIG. 19 shows the configuration of the type name repository 1611. The type name repository 1611 is a repository which is used to accumulate a list of type names of products or services which are being handled (sold, for example) by the task of the monitoring target system 311 (FIG. 3). In reality, as shown in FIG. 19, the type name repository 1611 has as table structure which is configured from a type name field 1611A and a plurality of summary fields 1611B. Further, the type name field 1611A stores the type names of the products or services handled by the task of the monitoring target system 311, and the summary fields 1611B each store a summary relating to the corresponding product or service.

The information which is accumulated by the type name repository 1611 is task operation information. In the present embodiment, ‘handling’ of the product or service type name by the system task serving as the monitoring target will be described to mean ‘sales.’ However, the present invention is not limited to sales, rather, instead of sales, the present invention can also be applied to a monitoring target system 311 where ‘handling’ of the product or service involves order taking, order placement, manufacture, purchase or shipment.

FIG. 20 shows a configuration of the sales prediction and results repository 1612. The sales prediction and results repository 1612 is a repository which is used to accumulate and manage the total sales prediction and total sales results, on each date, for the product or service registered in the type name repository 1611. Here, total sales results denotes the total number actually sold, on the day and past dates respectively, of a product or service with a model number which is of interest. Further, total sales prediction denotes the total number of sales predicted or planned on the day or on future dates for the product or service with a model number which is of interest.

As shown in FIG. 20, the sales prediction and results repository 1612 has a table structure which is configured from a date field 1612A, and a total sales prediction field 1612B and total sales results field 1612C for each product or service registered in the type name repository 1611.

Further, the date field 1612A stores the dates on a day by day basis and the total sales prediction field 1612B and total sales results field 1612C each store the total sales prediction value or total sales results of each of the corresponding products or services. The information accumulated by the sales prediction and results repository 1612 is task operation information.

According to the present embodiment, ‘svcA,’ which is executed by the monitoring target system 311, performs ‘online service’ sales called ‘SVC1,’ ‘db1’ holds the total sales count of ‘svcA,’ ‘svcB’ sells a ‘license key for product X’ called ‘PROD2,’ and ‘db2’ holds the total sales count for ‘PROD2.’

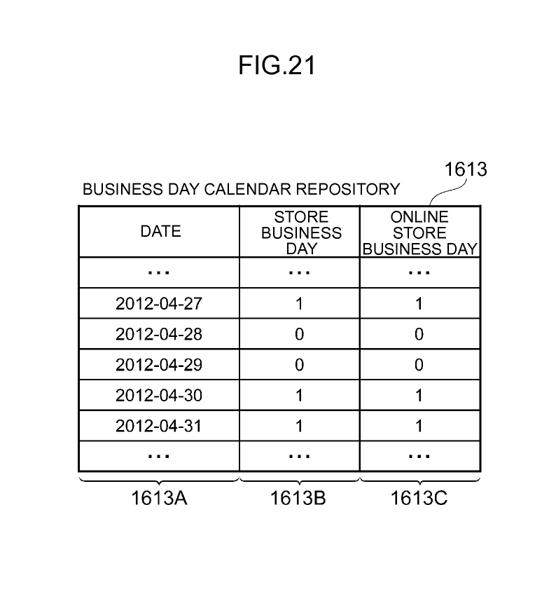

FIG. 21 shows a configuration of the business day calendar repository 1613. As shown in FIG. 21, the business day calendar repository 1613 has a table structure which is configured from a date field 1613A, a store business day field 1613B and an online store business day field 1613C.

Further, the date field 1613A stores dates on a day by day basis and the store business day field 1613B stores a flag indicating whether or not the corresponding date is a business day of the corresponding manned store (‘1’ in the case of a business day and ‘0’ if not a business day). In addition, the online store business day field 1613C stores a flag indicating whether or not the corresponding date is a business day of a corresponding online store (unmanned store) (‘1’ in the case of a business day and ‘0’ if not a business day).

Information accumulated by the business day calendar repository 1613 is task operation information. Further, an online store is provided by a service B (svcB) of the monitoring target system 311.

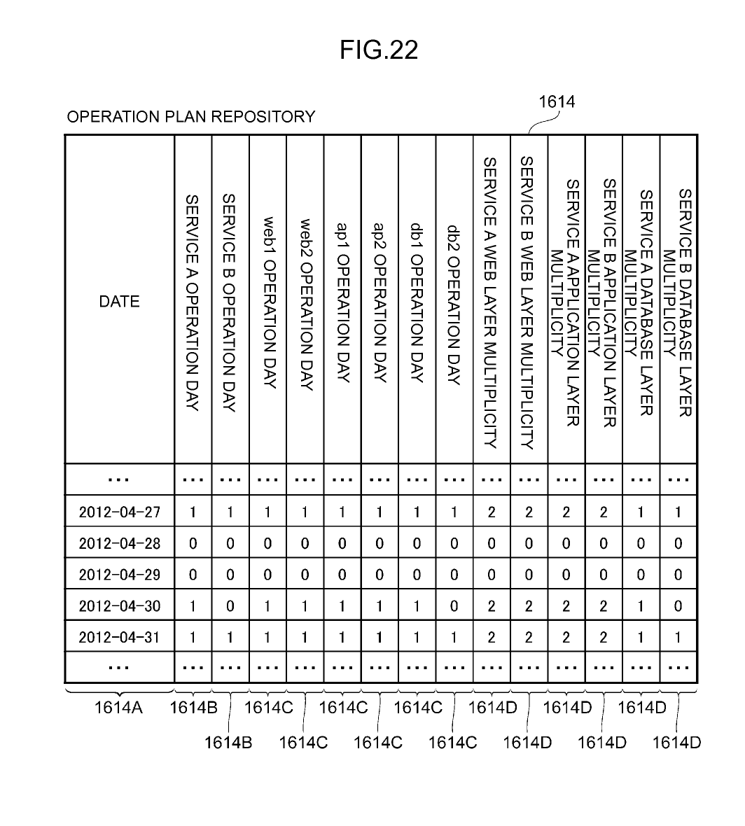

FIG. 22 shows a configuration of an operation plan repository 1614. The operation plan repository 1614 is a repository which is used to manage each service and operation plans of each task layer multiplicity for each task server 110 and each service, on the respective dates.

In reality, as shown in FIG. 22, the operation plan repository 1614 has a table structure which is configured from a date field 1614A, a plurality of service operation day fields 1614B which are provided in association with each service, a plurality of task server operation day fields 1614C which are provided in association with each task server 110, and a task layer multiplicity field 1614D for each service.

Further, the date field 1614A stores dates on a day by day basis and the service operation day fields 1614B each store a flag indicating whether or not there is a plan to operate the corresponding service on the corresponding dates (‘1’ in the case of a plan to operate and ‘0’ when no plan exists). Furthermore, the task server operation day field 1614C stores a flag which indicates whether or not there is a plan to operate the corresponding task server 110 on the corresponding dates (‘1’ in the case of a plan to operate and ‘0’ when no plan exists), and the task layer multiplicity fields 1614D each store the number (multiplicity) of task servers 110 which have been scheduled to execute the corresponding task layer processing on the corresponding dates.

For example, in the case of FIG. 22, it can be seen that the date ‘2012-04-31’ is the operation day for both ‘service A’ and ‘service B’ and each of the task servers 110 ‘web1,’ ‘web2,’ ‘ap1,’ ‘ap2,’ ‘db1’ and ‘db2’ are operated on this day, that the ‘service A web multiplicity,’ ‘service B web multiplicity,’ ‘service A application layer multiplicity’ and ‘service B application layer multiplicity’ in this case are each ‘2’, and that the ‘service A database layer multiplicity’ and ‘service B database layer multiplicity’ in this case are each ‘1.’ The information accumulated by the operation plan repository 1614 is system operation information.

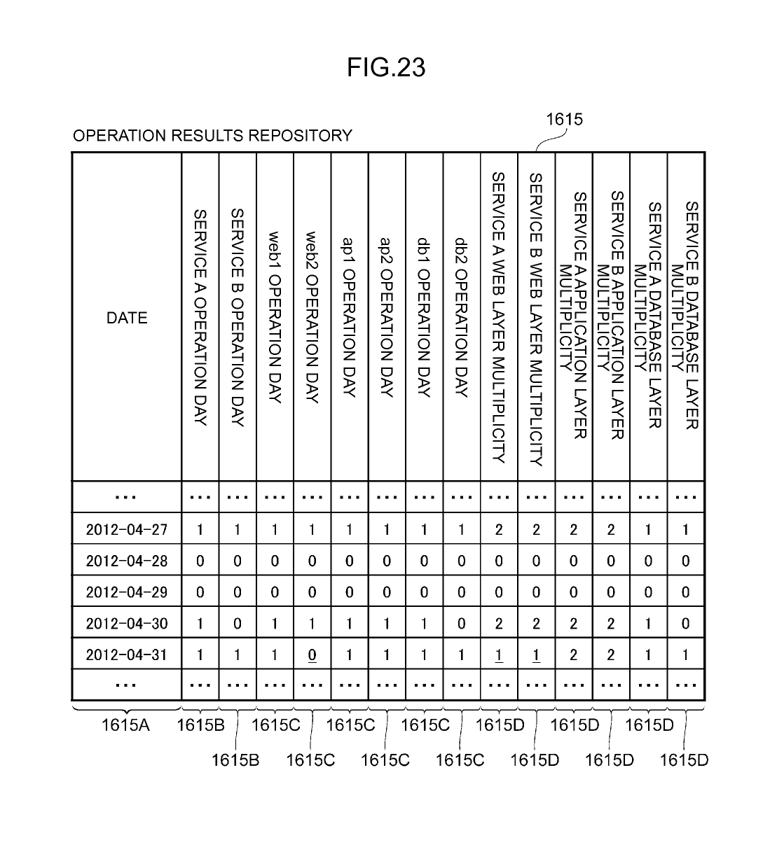

FIG. 23 shows a configuration of the operation results repository 1615. The operation results repository 1615 is a repository which is used to accumulate and manage each service and the operation results of each task layer multiplicity for each task server 110 and each service, on the respective dates.

In reality, as shown in FIG. 23, the operation results repository 1615 has a table structure which is configured from a date field 1615A, a plurality of service operation day fields 1615B which are provided in association with each service, a plurality of task server operation day fields 1615C which are provided in association with each of the task servers 110, and a task layer multiplicity field 1615D for each service.

Further, the date field 1615A stores dates on a day by day basis and the service operation day fields 1615B each store a flag indicating whether or not the corresponding service is operated on each of the corresponding dates (‘1’ in a case where the service is operated and ‘0’ when it is not operated). Further, the task server operation day field 1615C stores a flag indicating whether or not the corresponding task server 110 is operated on each of the corresponding dates (‘1’ in a case where the server is operated and ‘0’ when it is not operated), and task layer multiplicity fields 1615D each store the number (multiplicity) of task servers 110 which execute the processing of the corresponding task layer on each of the corresponding dates.

For example, in the case of FIG. 23, it can be seen that, for the date ‘2012-04-31,’ ‘service A’ and ‘service B’ are both operated, ‘web1,’ ‘ap1,’ ‘ap2,’ ‘db1,’ and ‘db2’ are operated while ‘web2’ is not operated, and ‘service A web multiplicity’ and ‘service B web multiplicity’ in this case are ‘1,’ ‘service A application layer multiplicity’ and ‘service B application layer multiplicity’ are ‘2’ and ‘service A database layer multiplicity’ and ‘service B database layer multiplicity’ are ‘1.’ Unlike FIG. 22, this is an example where the ‘operation plan’ for ‘web2’ was scheduled for operation but was not operated for the results, and therefore ‘2’ is indicated for the scheduling of ‘service A web multiplicity’ and ‘service B web multiplicity’ whereas the results have been reduced to ‘1.’ The information accumulated by the operation results repository 1615 is system operation information.

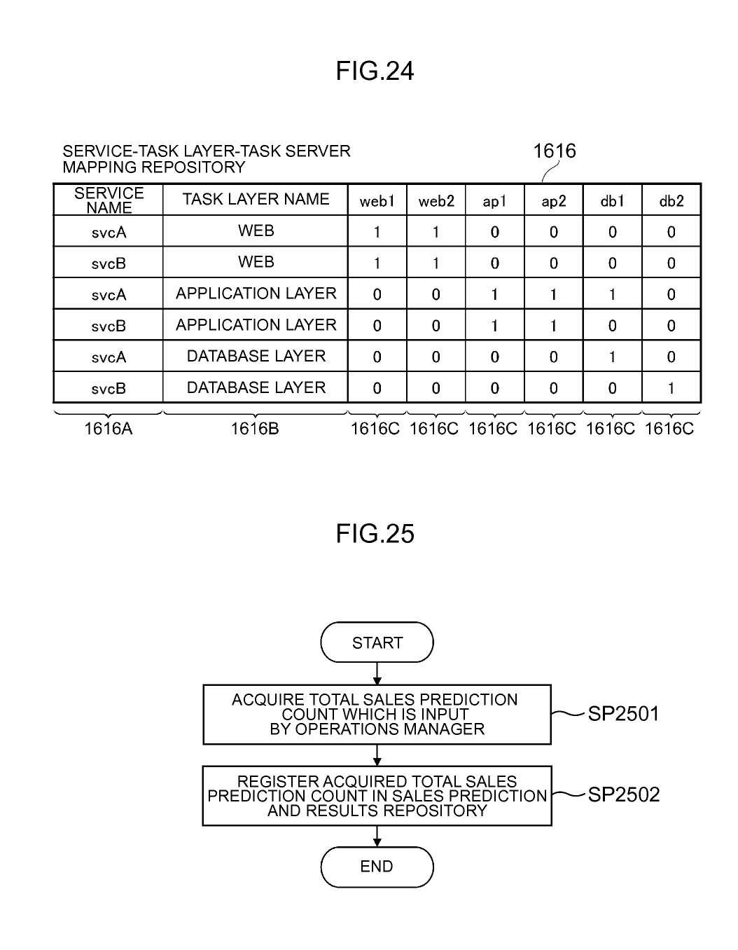

FIG. 24 shows a configuration of a service-task layer-task server mapping repository 1616. As shown in FIG. 24, the service-task layer-task server mapping repository 1616 has a table structure which is configured from a service name field 1616A and a task layer name field 1616B, and a plurality of task server fields 1616C which are each associated with the respective task servers 110.

Further, the service name field 1616A stores the service names of the services provided by the corresponding monitoring target system 311 (FIG. 3), and the task layer name field 1616B stores the layer names of the task layers in which the corresponding services are provided. In addition, the task server fields 1616C each store a flag indicating whether or not the corresponding task servers 110 execute processing in the corresponding task layer of the corresponding service (‘1’ is indicated in a case where the corresponding task server 110 executes processing in the corresponding task layer of the corresponding service and ‘0’ if not).

For example, in the case of FIG. 24, it can be seen that the task server 110 known as ‘web1’ executes processing in the web layer of the service ‘svcA’ (service A) and the web layer of the service ‘svcB’ (service B) but does not execute the processing pertaining to the other task layers of the other services. The information accumulated by the service-task layer-task server mapping repository 1616 is system operation information.

(2-3-2) Various Processing of Management Server

(2-3-2-1) Sales Prediction Acquisition and Recording Processing

FIG. 25 shows a processing routine for sales prediction acquisition and recording processing which is executed by the sales prediction acquisition and recording unit 1601. The sales prediction acquisition and recording unit 1601 registers the total sales prediction count on each date of each product or service input by the system administrator of the customer system 301 (FIG. 2) using the console 105 (FIG. 1) of the management server 120, in the foregoing sales prediction and results repository 1612 described hereinabove with reference to FIG. 20, for example, according to the processing result shown in FIG. 25.

In reality, when the system administrator of the customer system 301 inputs the total sales prediction count on each date of the product or service to the management server 120, the sales prediction acquisition and recording unit 1601 starts the sales prediction acquisition and recording processing and first acquires the total sales prediction count on each date of the product or service (SP2501).

The sales prediction acquisition and recording unit 1601 subsequently stores the total sales prediction count on each date of the product or service acquired in step SP2501 in each of the corresponding total sales prediction fields 1612B of the sales prediction and results repository 1612 (SP2502) and then ends this sales prediction acquisition and recording processing.

Note that, in the foregoing example, the system administrator of the customer system 301 inputs the total sales prediction count on each date of the product or service to the management server 120 and the sales prediction acquisition and recording unit 1601 acquires the total sales prediction count on each date of the product or service thus input, but in a case where a dedicated sales prediction server (task management server) is in a separate location, for example, the sales prediction acquisition and recording unit 1601 may acquire the sales prediction from the sales prediction server and register the acquired sales prediction in the sales prediction and results repository 1612.

(2-3-2-2) Sales Results Acquisition and Recording Processing

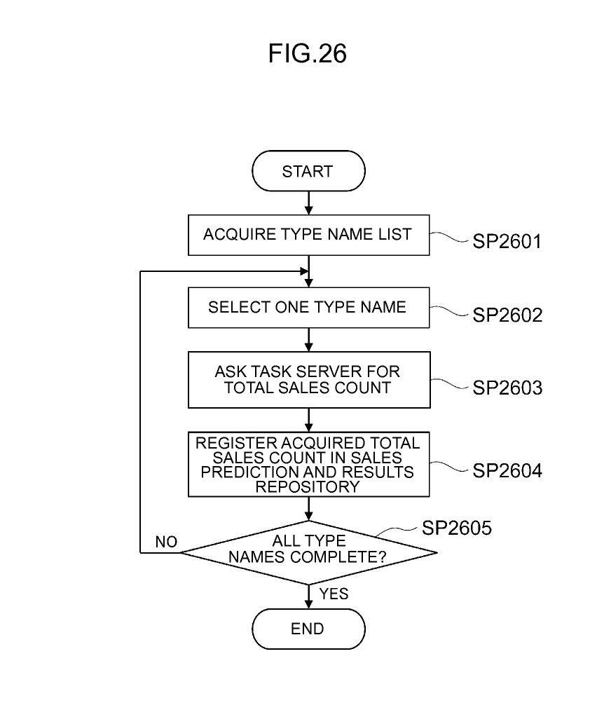

FIG. 26 shows a processing routine for sales results acquisition and recording processing which is executed by the sales results acquisition and recording unit 1602. The sales results acquisition and recording unit 1602 registers the sales results of the product or service in the monitoring target system 311 (FIG. 3) in the sales prediction and results repository 1612 described hereinabove with reference to FIG. 20, according to the processing routine shown in FIG. 26.

In reality, the sales results acquisition and recording unit 1602 starts the sales results acquisition and recording processing at a predetermined time when business has ended for the day, each day, for example, and first acquires a list of type names (hereinafter referred to as the ‘type name list’) of the product or service provided by the monitoring target system 311, from the type name repository 1611 (SP2601).

The sales results acquisition and recording unit 1602 subsequently selects one type name from the type name list acquired in step SP2601 (SP2602) and, for the product or service with the selected type name, asks each task server 110 of the monitoring target system 311 for the total sales count in Japan of the product or service (SP2603).

The sales results acquisition and recording unit 1602 then stores the total sales count in Japan of the product or service with the type name selected in step SP2602 which was acquired as a result of the inquiry of step SP2603, in the corresponding total sales results field 1612C of the sales prediction and results repository 1612 (SP2604) and then judges whether or not execution of the processing of steps SP2602 to SP2604 is complete for all the type names registered in the type name list acquired in step SP2601 (SP2605).

If a negative result is obtained in this judgment, the sales results acquisition and recording unit 1602 returns to step SP2602 and subsequently repeats the processing of steps SP2602 to 2605 while sequentially switching the type name selected in step SP2602 to another unprocessed type name. If an affirmative result is obtained in step SP2605 as a result of already completing execution of the processing of steps SP2602 to SP2604 for all the type names which are registered in the type name list acquired in step SP2602, the sales results acquisition and recording unit 1602 then ends the sales results acquisition and recording processing.

(2-3-2-3) Business Day Calendar Creation Processing

Meanwhile, the business day calendar acquisition unit 1603 acquires task information (store business day information) on whether or not the respective dates are online store business days (in the present embodiment, this means whether or not the dates are service A business days) or store business days (this means whether or not the dates are business days of a physical store (commercial facility) handling the same product or service), and records this information in the business day calendar repository 1613 (FIG. 21).

The store business day information is input to the management server 120 by the system administrator of the customer system 301 by using the console 105 (FIG. 1) of the management server 120, for example. However, if a dedicated store business day management server (task management server) is provided in a separate location, for example, the business day calendar acquisition unit 1603 may also acquire store business day information from the store business day management server.

(2-3-2-4) Service Plan Acquisition and Recording Processing

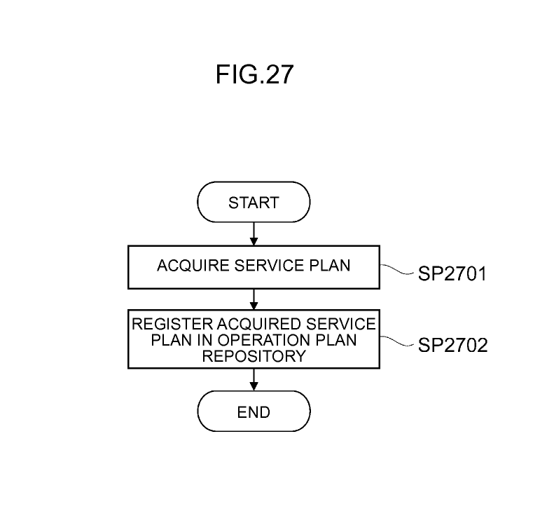

FIG. 27 shows a processing routine for service plan acquisition and recording processing which is executed by the service plan acquisition and recording unit 1604. The service plan acquisition and recording unit 1604 registers the service plan on each date which is input by the system administrator of the customer system 301 using the console 105 (FIG. 1) of the management server 120, in the operation plan repository 1614 (FIG. 22), for example, according to the processing routine shown in FIG. 27.

In reality, if the service administrator of the customer system 301 inputs information relating to the service name of each service operated in the monitoring target system 311 (FIG. 3) and to the existence of an operation on each date of the service (hereinafter called ‘service plan information’) to the management server 120, the service plan acquisition and recording unit 1604 starts the service plan acquisition and recording processing and first acquires the service plan information (SP2701).

The service plan acquisition and recording unit 1604 subsequently registers the service plan information acquired in step SP2701 in the operation plan repository 1614 (SP2702). More specifically, the service plan acquisition and recording unit 1604 stores, for each service, ‘1’ in the corresponding service operation day field 1614B in the operation plan repository 1614 in a case where there is a plan to operate the service and ‘0’ when there is no plan to operate same, based on the service plan information acquired in step SP2701. Further, the service plan acquisition and recording unit 1604 then ends the service plan acquisition and recording processing.

Note that, in the foregoing example, although the service plan acquisition and recording unit 1604 acquires the service plan information which is input to the management server 120 by the service administrator of the customer system 301, in a case where a dedicated service management server (a server or task server management server for managing a service plan) is in a separate location, for example, step SP2701 may be substituted so that the service plan acquisition and recording unit 1604 acquires the service plan information from the service management server.

(2-3-2-5) Task Server Operation Plan Acquisition and Recording Processing

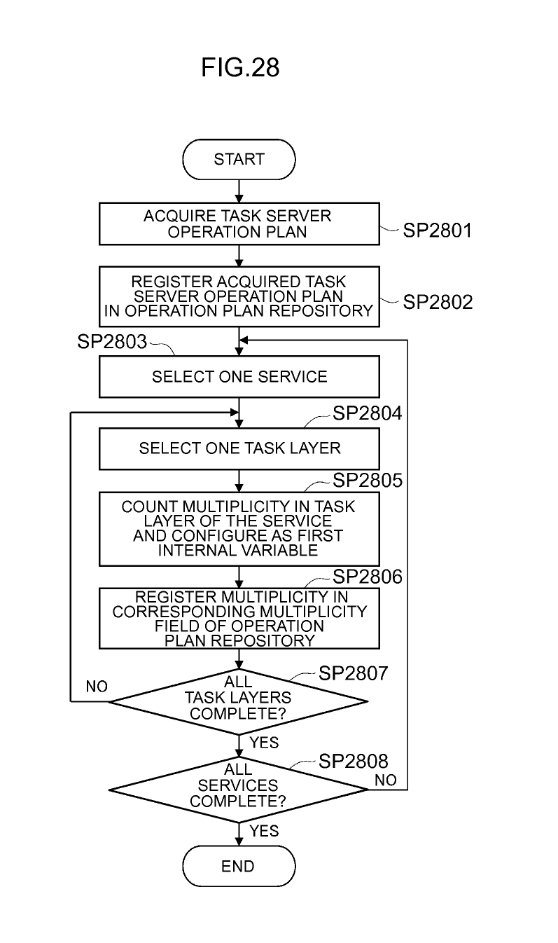

FIG. 28 shows a processing routine for task server operation plan acquisition and recording processing which is executed by the task server operation plan acquisition and recording unit 1606. The task server operation plan acquisition and recording unit 1606 registers information relating to the operation of the task server 110 including the presence or absence of an operation of the task server 110 on each date (hereinafter called ‘task server operation plan information’) which is input by the system administrator of the customer system 301 (FIG. 3) using the console 105 (FIG. 1) of the management server 120, in the operation plan repository 1614 (FIG. 22), for example, according to the processing routine shown in FIG. 28.

In reality, when the system administrator of the customer system 301 inputs task server operation plan information on each task server 110 in the monitoring target system 311, the task server operation plan acquisition and recording unit 1606 starts the task server operation plan acquisition and recording processing and first acquires the task server operation plan information (SP2801).

The task server operation plan acquisition and recording unit 1606 then registers the task server operation plan information acquired in step SP2801 in the operation plan repository 1614 (SP2802). More specifically, the task server operation plan acquisition and recording unit 1606 stores, for each task server 110, ‘1’ in the corresponding task server operation day field 1614C in the operation plan repository 1614 in a case where there is a plan to operate the task server 110 and ‘0’ when there is no plan to operate same, respectively, based on the task server operation plan information acquired in step SP2801.

The task server operation plan acquisition and recording unit 1606 then selects one service from among the services registered in the service-task layer-task server mapping repository 1616 (FIG. 24) (SP2803) and selects one task layer from among the task layers registered in the service-task layer-task server mapping repository 1616 (SP2804).

The task server operation plan acquisition and recording unit 1606 then selects a row among the rows in the service-task layer-task server mapping repository 1616 in which the service conforms to the service selected in step SP2803 and the task layer conforms to the task layer selected in step SP2804. Further, the task server operation plan acquisition and recording unit 1606 acquires the total number, on each date, of instances of a task server 110 for which ‘1’ is stored in the task server field 1616C in the selected row and where ‘1’ is stored in the task server operation day field 1614C of the task server 110 in the operation plan repository 1614, and configures each acquired total number for each date as a local variable (hereinafter called a first internal variable) which is used in the task server operation plan acquisition and recording processing (SP2805).

For example, in a case where the service selected in step SP2804 is ‘service A (svcA)’ and the task layer selected in step SP2804 is ‘web,’ the task server operation plan acquisition and recording unit 1606 first selects the row in which ‘service A (svcA)’ is stored in the service name field 1616A and ‘web’ is stored in the task layer name field 1616B among the rows of the service-task layer-task server mapping repository 1616. In the example in FIG. 20, since the task servers 110 for which ‘1’ is stored in the task server field 1616C in this row are ‘web1’ and ‘web2,’ the task server operation plan acquisition and recording unit 1606 acquires, on each day, the respective total numbers of instances where ‘1’ is stored in the task server operation day field 1614C for ‘web1’ and ‘web2’ in the operation plan repository 1614. For example, in the case of the date ‘2012-04-31,’ this total value is ‘2’ and therefore this is configured as a first internal variable on the date ‘2012-04-31.’

Further, the task server operation plan acquisition and recording unit 1606 stores the respective total numbers for each date configured as the first internal variable in step SP2805 in the task layer multiplicity field 1614D for the corresponding date among the task layer multiplicity fields 1614D corresponding to the service selected in step SP2803 and the task layer selected in step SP2804, among the task layer multiplicity fields 1614D of the operation plan repository 1614 (SP2806). For example, in the above example, ‘2’ is stored in the task layer multiplicity field 1614D corresponding to ‘2012-04-31’ among the task layer multiplicity fields 1614D corresponding to the ‘service A web layer multiplicity’ of the operation plan repository 1614.

Thereafter, the task server operation plan acquisition and recording unit 1606 judges whether or not execution of the processing of step SP2805 and SP2806 is complete for all the task layers which are registered in the service-task layer-task server mapping repository 1616, for the service selected in step SP2803 (SP2807). Further, if a negative result is obtained in this judgment, the task server operation plan acquisition and recording unit 1606 returns to step SP2804 and then repeats the processing of steps SP2804 to SP2807 while sequentially switching the task layer selected in step SP2804 to another unprocessed task layer.

Further, if an affirmative result is obtained in step SP2807 as a result of already completing execution of the processing of steps SP2805 and SP2806 for all the task layers which are registered in the service-task layer-task server mapping repository 1616, for the service selected in step SP2803, the task server operation plan acquisition and recording unit 1606 judges whether or not execution of the processing of steps SP2804 to SP2807 is complete for all the services which are registered in the service-task layer-task server mapping repository 1616 (SP2808).

Further, if a negative result is obtained in this judgment, the task server operation plan acquisition and recording unit 1606 returns to step SP2803 and then repeats the processing of steps SP2803 to SP2807 while sequentially switching the service selected in step SP2803 to another unprocessed service.

If an affirmative result is obtained in step SP2808 as a result of already completing execution of the processing of steps SP2803 to 2807 for all the services which are registered in the service-task layer-task server mapping repository 1616, the task server operation plan acquisition and recording unit 1606 then ends the task server operation plan acquisition and recording processing.

Note that, although the task server operation plan acquisition and recording unit 1606 acquires the task server operation plan information which was input to the management server 120 by the system administrator of the customer system 301 in the above example, in a case where a dedicated task server management server (a server which manages scheduling such that a particular task server operates on a particular day and does not operate on another) is located in a separate location, for example, the processing of step SP2601 may be substituted such that the task server operation plan acquisition and recording unit 1606 acquires the task server operation plan information from the task server monitoring server.

(2-3-2-6) Task Server Operation Results Acquisition and Recording Processing

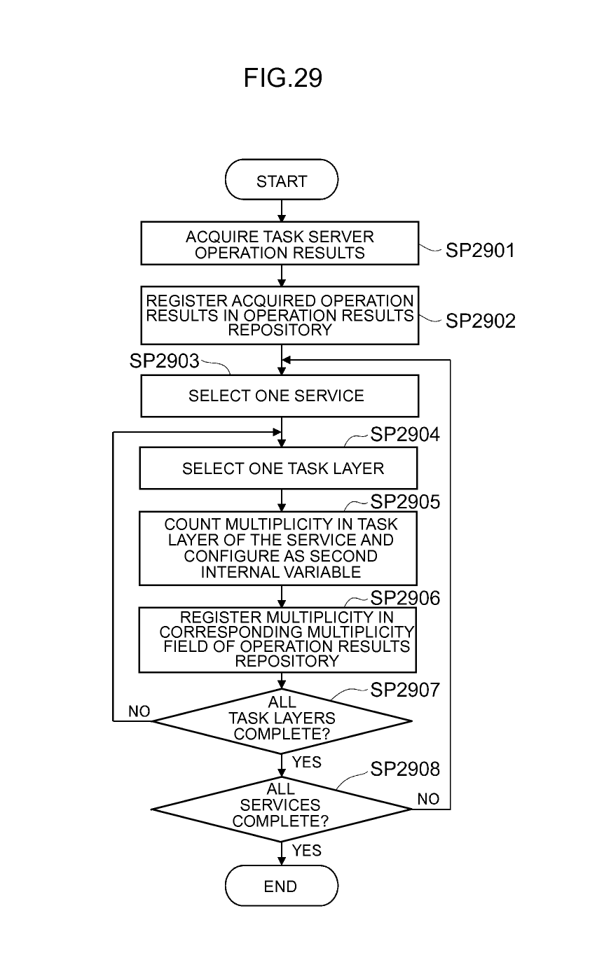

FIG. 29 shows a processing routine for task server operation results acquisition and recording processing which is executed at regular intervals (for example, at midnight every day) by the task server operation results acquisition and recording unit 1607. The task server operation results acquisition and recording unit 1607 registers information relating to the operation results of the task server 110 (hereinafter called ‘task server operation results information’) in the operation results repository 1615 (FIG. 23) according to the processing routine shown in FIG. 29.

In reality, upon starting the task server operation results acquisition and recording processing, the task server operation results acquisition and recording unit 1607 first acquires information relating to the operation results (presence or absence of operation) of each task server 110 on the corresponding date (hereinafter called ‘task server operation results information’) from the monitoring device 111 (SP2901). Note that, here, ‘corresponding date’ corresponds to the previous day's date if the task server operation results acquisition and recording unit 1607 executes the task server operation results acquisition and recording processing at midnight every day, for example.

The task server operation results acquisition and recording unit 1607 then registers the task server operation results information acquired in step SP2901 in the operation results repository 1615 (SP2902). More specifically, the task server operation results acquisition and recording unit 1607 stores, for each task server 110, ‘1’ in a case where the task server 110 is operated (run) on the day of the corresponding date and ‘0’ if same is not operated (run), respectively, in the corresponding task server operation day field 1615C of the operation results repository 1615, based on the task server operation results information acquired in step SP2901.

The task server operation results acquisition and recording unit 1607 then selects one service from among the services registered in the service-task layer-task server mapping repository 1616 (FIG. 24) (SP2903) and selects one task layer from among the task layers which are registered in the service-task layer-task server mapping repository 1616 (SP2904).

In addition, the task server operation results acquisition and recording unit 1607 then selects a row among the rows in the service-task layer-task server mapping repository 1616 in which the service conforms to the service selected in step SP2903 and the task layer conforms to the task layer selected in step SP3904. Further, the task server operation results acquisition and recording unit 1607 acquires the total number of instances of a task server 110 for which ‘1’ is stored in the task server field 1616C in the selected row and where ‘1’ is stored in the task server operation day field 1615C in the row of the corresponding date of the task server 110 in the operation results repository 1615, and configures each acquired total number as a local variable (hereinafter called a second internal variable) which is used in the task server operation results acquisition and recording processing (SP2905).

For example, in a case where the service selected in step SP2903 is ‘service A (svcA)’ and the task layer selected in step SP2904 is ‘web,’ the task server operation results acquisition and recording unit 1607 first selects the row in which ‘service A (svcA)’ is stored in the service name field 1616A and ‘web’ is stored in the task layer name field 1616B among the rows of the service-task layer-task server mapping repository 1616. In the example in FIG. 20, since the task servers 110 for which ‘1’ is stored in the task server field 1616C in this row are ‘web1’ and ‘web2,’ the task server operation results acquisition and recording unit 1607 acquires the total number of instances where ‘1’ is stored in the task server operation day field 1615C for ‘web1’ and ‘web2’ in the operation results repository 1615. For example, in the case of the date ‘2012-04-31,’ this total value is ‘1’ and therefore this is configured as the second internal variable on the date ‘2012-04-31.’

Further, the task server operation results acquisition and recording unit 1607 stores the value configured as the second internal variable in step SP2905 in the task layer multiplicity field 1615D for the corresponding date among the task layer multiplicity fields 1615D corresponding to the service selected in step SP2903 and the task layer selected in step SP2904, among the task layer multiplicity fields 1615D of the operation results repository 1615 (SP2906). For example, in the above example, ‘1’ is stored in the task layer multiplicity field 1614D corresponding to ‘2012-04-31’ among the task layer multiplicity fields 1614D corresponding to the ‘service A web layer multiplicity.’

Thereafter, the task server operation results acquisition and recording unit 1607 judges whether or not execution of the processing of step SP2905 and SP2906 is complete for all the task layers which are registered in the service-task layer-task server mapping repository 1616, for the service selected in step SP2903 (SP2907). Further, if a negative result is obtained in this judgment, the task server operation results acquisition and recording unit 1607 returns to step SP2904 and then repeats the processing of steps SP2904 to SP2907 while sequentially switching the task layer selected in step SP2904 to another unprocessed task layer.

Further, if an affirmative result is obtained in step SP2907 as a result of already completing execution of the processing of steps SP2905 and SP2906 for all the task layers which are registered in the service-task layer-task server mapping repository 1616, for the service selected in step SP2903, the task server operation results acquisition and recording unit 1607 judges whether or not execution of the processing of steps SP2904 to SP2907 is complete for all the services which are registered in the service-task layer-task server mapping repository 1616 (SP2908).

Further, if a negative result is obtained in this judgment, the task server operation results acquisition and recording unit 1607 returns to step SP2903 and then repeats the processing of steps SP2903 to SP2908 while sequentially switching the service selected in step SP2903 to another unprocessed service.

If an affirmative result is obtained in step SP2908 as a result of already completing execution of the processing of steps SP2903 to 2907 for all the services which are registered in the service-task layer-task server mapping repository 1616, the task server operation results acquisition and recording unit 1607 then ends the task server operation results acquisition and recording processing.

(2-3-2-7) Service Results Acquisition and Recording Processing

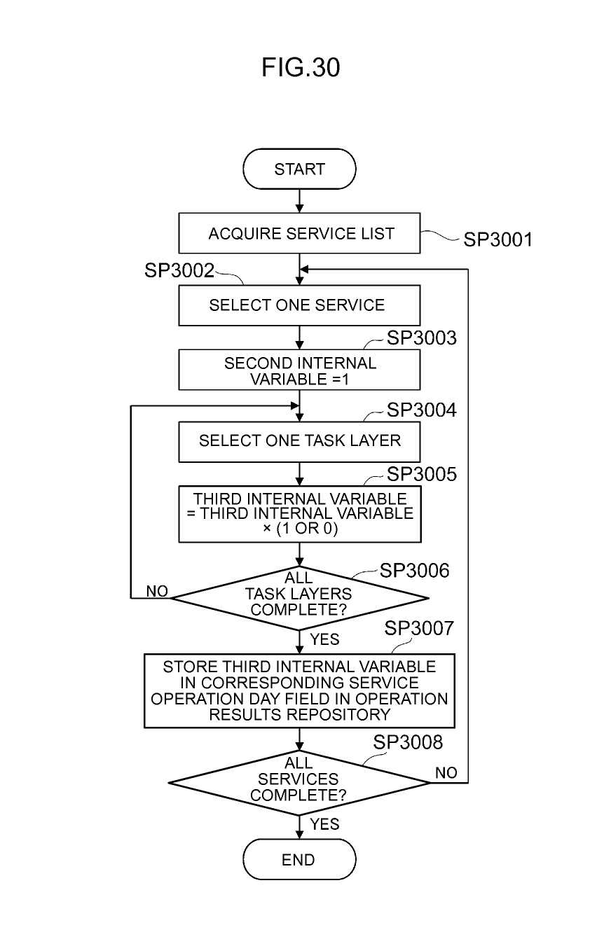

Meanwhile, FIG. 30 shows a processing routine for service results acquisition and recording processing which is executed at regular intervals (for example, at midnight every day) by the service results acquisition and recording unit 1605. The service results acquisition and recording unit 1605 registers the service results provided by the monitoring target system 311 (FIG. 3) in the operation results repository 1615 (FIG. 23) according to the processing routine shown in FIG. 30.

In reality, upon starting the service results acquisition and recording processing, the service results acquisition and recording unit 1605 first acquires a list displaying all the service names of the services provided in the monitoring target system 311 (FIG. 3) (hereinafter referred to as the ‘service list’) from the operation results repository 1615 (SP3001).

The service results acquisition and recording unit 1605 subsequently selects one service from among the services displayed in the service list acquired in step SP3001 (SP3002) and then configures the value of the local variable (hereinafter called a third internal variable) which is used in the service results acquisition and recording processing as ‘1’ (SP3003).

The service results acquisition and recording unit 1605 subsequently selects one task layer pertaining to the service selected in step SP3002 from among the task layers which are registered in the service-task layer-task server mapping repository 1616 (FIG. 24) (SP3004).

The service results acquisition and recording unit 1606 reads the task layer multiplicity which is stored in the task layer multiplicity field 1615D corresponding to the task layer which was selected in step SP3004 of the service selected in step SP3002 among the task layer multiplicity fields 1615D in the operation results repository 1615 (FIG. 23). The service results acquisition and recording unit 1606 then multiplies the third internal variable by ‘1’ in a case where the task layer multiplicity is 1 or more and by ‘0’ if the task layer multiplicity is less than 1 (0, that is), and configures the multiplication result as a new third internal variable which corresponds to the task layer of the service (SP3005).

For example, in a case where the service selected in step SP3002 is ‘service A’ and the task layer selected in step SP3004 is ‘web,’ the service results acquisition and recording unit 1606 reads the task layer multiplicity which is stored in the task layer multiplicity field 1615D known as ‘service A web layer multiplicity’ of the operation results repository 1615 in step SP3005. In the example in FIG. 23, since this value is ‘2,’ the service results acquisition and recording unit 1606 multiplies the third internal variable by ‘1’ and configures the calculation result as a new third internal variable.

The service results acquisition and recording unit 1606 subsequently judges whether or not the execution of processing of steps SP3004 and SP3005 is complete for all the task layers which pertain to the service selected in step SP3002 and which are registered in the service-task layer-task server mapping repository 1616 (FIG. 24) (SP3006).

Further, if a negative result is obtained in this judgment, the service results acquisition and recording unit 1606 returns to step SP3004 and then repeats the processing of steps SP3004 to SP3006 while sequentially switching the task layer selected in step SP3004 to another unprocessed task layer.

If an affirmative result is obtained in step SP3006 as a result of already completing execution of the processing of steps SP3004 and SP3005 for all the task layers which pertain to the service selected in step SP3002 and which are registered in the service-task layer-task server mapping repository 1616 (FIG. 24), the service results acquisition and recording unit 1606 stores the value of the third internal variable at this time in the service operation day field 1615B corresponding to the service selected in step SP3003 among the service operation day fields 1615B of the operation results repository 1615 (SP3007).

For example, if the service selected in step SP3002 is ‘service A,’ the service results acquisition and recording unit 1606 stores the value of the third internal variable in the service operation day field 1615B known as ‘service A operation day’ in step SP3007.

The service results acquisition and recording unit 1606 then judges whether or not execution of the processing of steps SP3002 to SP3007 is complete for all the services displayed in the service list that was acquired in step SP3001 (SP3008).

Further, if a negative result is obtained in this judgment, the service results acquisition and recording unit 1606 returns to step SP3002 and then repeats the processing of steps SP3002 to SP3007 while sequentially switching the service selected in step SP3002 to another unprocessed service.

Further, if an affirmative result is obtained in step SP3008 as a result of already completing execution of the processing of steps SP3002 to SP3007 for all the services which are displayed in the service list acquired in step SP3001, the service results acquisition and recording unit 1606 ends the service results acquisition and recording processing.

(2-3-2-8) Processing Routine for Request Reception Processing

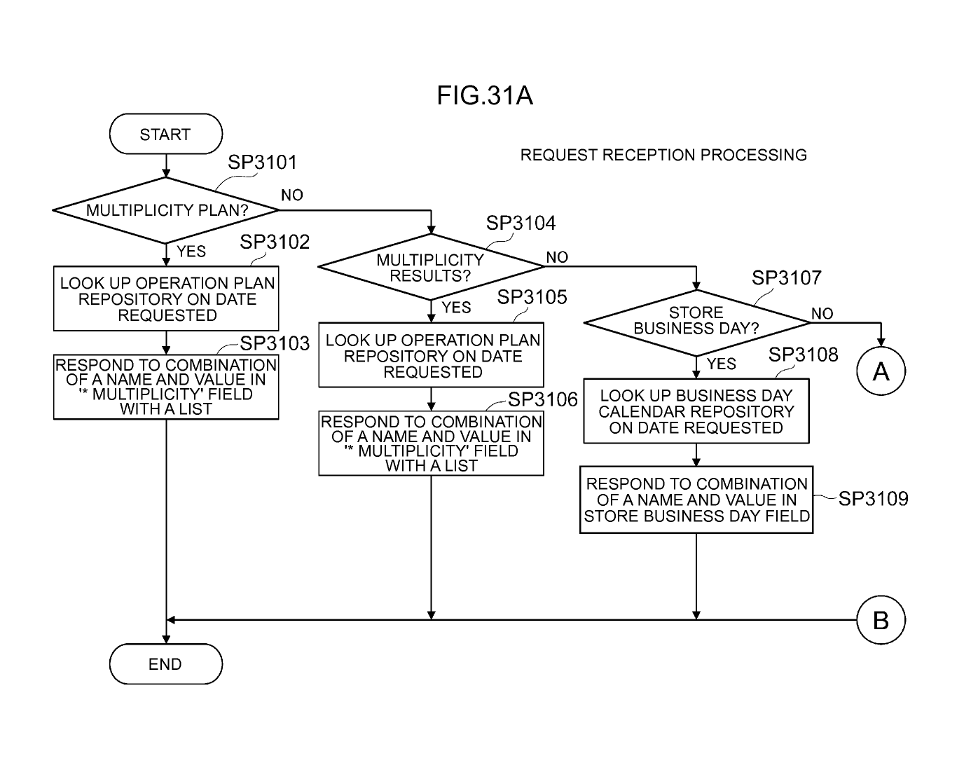

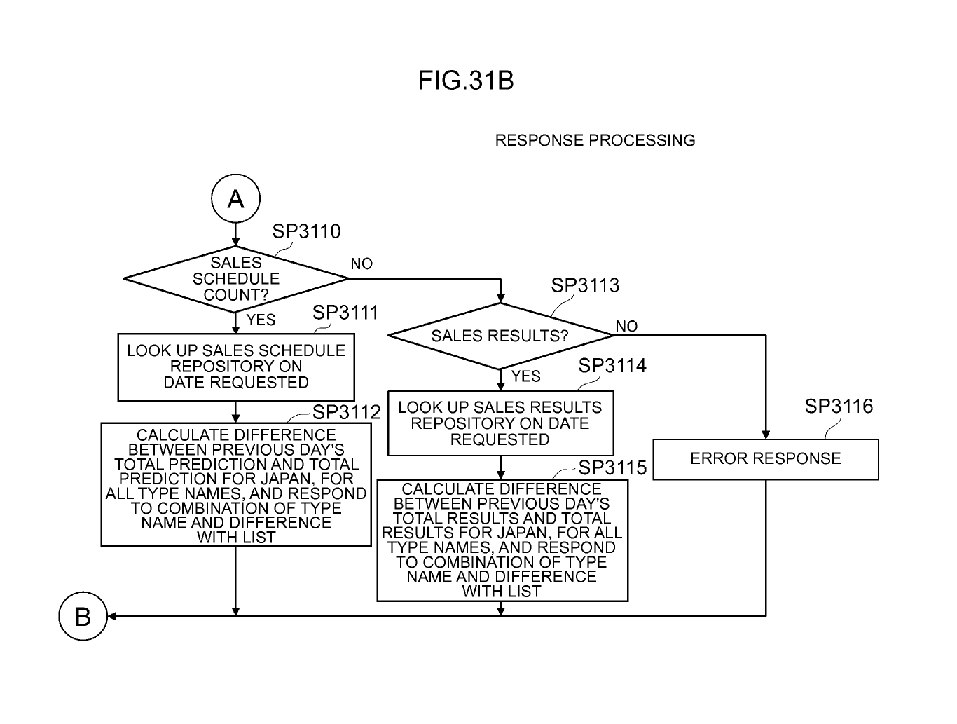

FIGS. 31A and 31B show a processing routine for request reception processing which is executed by the request processing unit 1621 (FIG. 18) which receives requests from the monitoring device 111. The request processing unit 1621 executes processing corresponding to this request according to the processing routine shown in FIGS. 31A and 31B and sends back a response corresponding to the executed processing to the monitoring device 111.

In reality, upon receiving a request from the monitoring device 111, the request processing unit 1621 starts this request reception processing and judges whether or not this request is a multiplicity plan inquiry (SP3101). Further, upon receiving an affirmative result in this judgment, in a case where the request from the monitoring device 111 is a multiplicity plan inquiry, the request processing unit 1621 looks up a row corresponding to the date of the inquiry target contained in the request among the rows of the operation plan repository 1614 (FIG. 22) (SP3102).

The request processing unit 1621 subsequently generates a list which displays combinations comprising values which are stored in each of the task layer multiplicity fields 1614D in the lookup row, and the names of the columns containing the task layer multiplicity fields 1614D (in the example of FIG. 22, ‘service A web layer multiplicity,’ service B web layer multiplicity,’ ‘service A application layer multiplicity,’ ‘service B application layer multiplicity,’ ‘service A database layer multiplicity’ or ‘service B database layer multiplicity’) and transmits the generated list to the monitoring device 111 which transmitted the request (SP3103). The request processing unit 1621 subsequently ends the request reception processing.

If, on the other hand, a negative result is obtained in the judgment of step SP3101, the request reception unit 1621 judges whether or not the request from the monitoring device 111 is a multiplicity results inquiry (SP3104). If an affirmative result is obtained in this judgment, the request processing unit 1621 looks up a row which corresponds to the date of the inquiry target contained in this request from among the rows of the operation results repository 1615 (FIG. 23) (SP3105).

The request processing unit 1621 then generates a list which displays a combination which includes the values stored in each of the task layer multiplicity fields 1615D in the looked up row and the names of the columns containing the task layer multiplicity fields 1615D (in the example in FIG. 23, ‘service A web layer multiplicity,’ ‘service B web layer multiplicity,’ ‘service A application layer multiplicity,′ service B application layer multiplicity,’ ‘service A database layer multiplicity’ or ‘service B database layer multiplicity’) and transmits the generated list to the monitoring device 111 which was the request transmission source (SP3106). The request processing unit 1621 subsequently ends the request reception processing.

If, on the other hand, a negative result is obtained in the judgment of step SP3104, the request processing unit 1621 judges whether or not the request from the monitoring device 111 is a store business day inquiry (SP3107). If an affirmative result is obtained in this judgment, the request processing unit 1621 looks up a row which corresponds to the date of the inquiry target contained in this request, among the rows of the business day calendar repository 1613 (FIG. 21) (SP3108).

The request processing unit 1621 then responds to the monitoring device 111 which transmitted the request by sending the values stored in the store business day field 1613B and the online store business day field 1613C in the looked up row respectively and the names of each column containing the store business day field 1613B and online store business day field 1613C (store business day′ or ‘online store business day’ in the example of FIG. 21) (SP3109). The request processing unit 1621 then ends the request reception processing.

If, on the other hand, a negative result is obtained in the judgment of step SP3107, the request processing unit 1621 judges whether or not the request from the monitoring device 111 is a sales prediction count inquiry (SP3110). Further, if an affirmative result is obtained in this judgment, the request processing unit 1621 looks up the row corresponding to the date of the inquiry target contained in the request among the rows in the sales prediction and results repository 1612 (FIG. 20) (SP3111).

The request processing unit 1621 then calculates the difference between the prediction value of the previous day's total sales prediction and the prediction value of the total sales prediction for Japan, for the products or services with all the type names registered in the sales prediction and results repository 1612 respectively and responds to the monitoring device 111 which transmitted the request by sending, in list format, a combination of the type names of the products or services and the respective differences (S3112P). The request processing unit 1621 then ends the request reception processing.

If, on the other hand, there is a negative result in the judgment of step SP3110, the request processing unit 1621 judges whether or not the request from the monitoring device 111 is a sales results inquiry (SP3113). Further, if an affirmative result is obtained in this judgment, the request processing unit 1621 looks up the row corresponding to the date of the inquiry target contained in the request among the rows in the sales prediction and results repository 1612 (FIG. 20) (SP3114).

The request processing unit 1621 then calculates the difference between the previous day's total sales results and total sales results for Japan, for the products or services with all the type names registered in the sales prediction and results repository 1612 respectively and responds to the monitoring device 111 which transmitted the request by sending, in list format, a combination of the respective differences and the type names of the products or services (SP3115). The request processing unit 1621 then ends the request reception processing.

If, on the other hand, there is a negative result in the judgment of step SP3113, the request processing unit 1621 issues an error response to the monitoring device 111 which transmitted the request (SP3116) and then ends the request reception processing.

### (3) Main Components of Monitoring Service Provider System

The configuration of the (FIG. 2) and portal server 115 (FIG. 2), which are the main components of the monitoring service provider system 302 (FIG. 2) will be described next.

(3-1) Configuration of Predictor Server

(3-1-1) Logical Configuration of Predictor Server

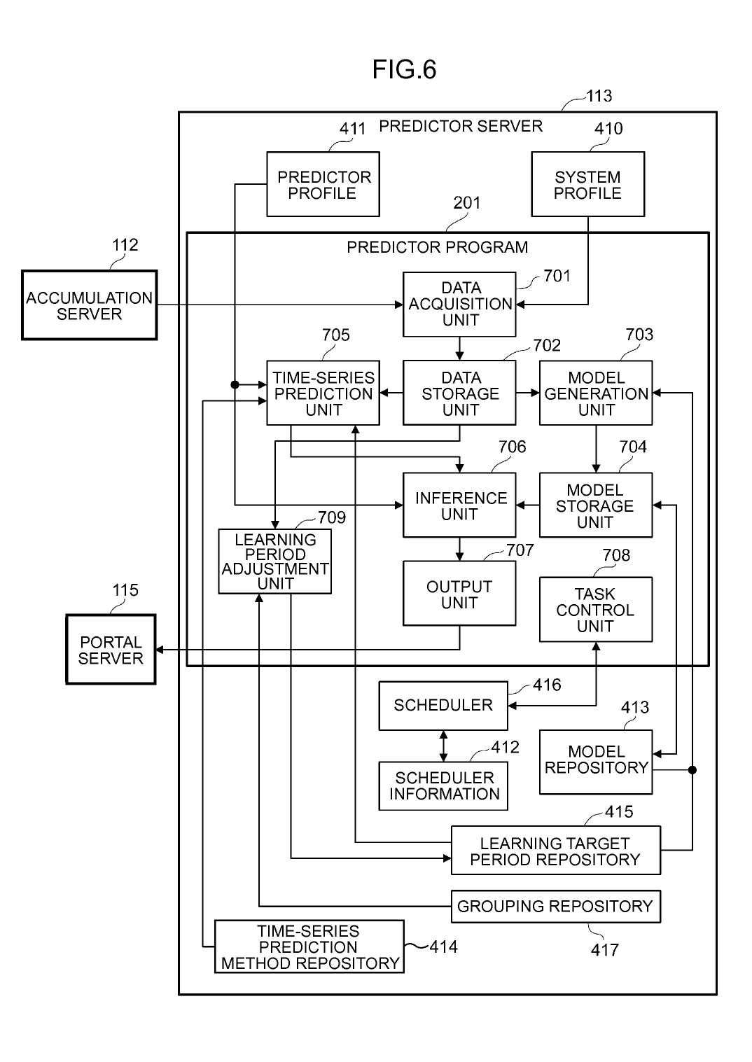

FIG. 6 shows an example of the logical configuration of the predictor server 113. Installed on the predictor server 113 is a predictor program 201 as the user process 200 (FIG. 1). The predictor program 201 is configured comprising a data acquisition unit 701, a data storage unit 702, a model generation unit 703, a model storage unit 704, a time-series prediction unit 705, an inference unit 706, an output unit 707, a task control unit 708 and a learning period adjustment unit 709.

Further, the predictor server 113 also has a scheduler 416 installed as the user process 200 and stores, as files in the storage 103 (FIG. 1), a system profile table 410, a prediction profile table 411, scheduler information 412, a model repository 413, a time-series prediction method repository 414, a learning target period repository 415 and a grouping repository 417. However, the system profile table 410 and so forth may also be stored in the memory 102 (FIG. 1) instead of the storage 103 and may be stored on another server and, if necessary, acquired by way of communication.

The data acquisition unit 701 of the predictor program 201 is an object which comprises a function for issuing a request to the accumulation server 112 to transmit measurement values 217 and for storing the measurement values 217 transmitted from the accumulation server 112 in the data storage unit 702 in response to this request. Further, the model generation unit 703 is an object which comprises a function for generating models based on the measurement values 217 stored in the data storage unit 702 (hereinafter suitably called ‘remodeling’) and for storing the generated model in the model storage unit 704.

The time-series prediction unit 705 is an object which comprises a function for executing the time-series prediction processing based on the measurement values 217 stored in the data storage unit 702, the prediction profiles stored in the prediction profile table 411, and the prediction models stored in the time-series prediction method repository 414, and for sending notification of the prediction values obtained to the inference unit 706. Further, the inference unit 706 is an object which comprises a function for executing probability inference processing based on the prediction values notified by the time-series prediction unit 705, the models stored in the model storage unit 704, and the prediction profiles stored in the prediction profile table 411. The foregoing processing, which is executed by the predictor server 113, is called ‘inference processing’ or ‘learning processing.’

The output unit 707 is an object comprising a function for transmitting the processing result of the foregoing inference or learning processing notified by the inference unit 706 to the portal server 115. In addition, the task control unit 708 is an object comprising a function for performing task execution and task interruption by receiving task messages from the scheduler 416 and controlling execution of the processing by each of the foregoing objects which the predictor program 201 comprises, according to the content of the task messages.

When the output unit 707 transmits the processing result of the inference or learning processing (inference value of the probability of a prediction event being generated) to the portal server 115, this transmission need not necessarily be made in sync with the inference or learning processing, rather, the inference value of the probability of a prediction event being generated (predictor detection result) notified by the inference unit 706 may be stored in the memory 102 (FIG. 1) or storage 103 (FIG. 1) and transmitted to the portal server 115 in response to an information presentation request.

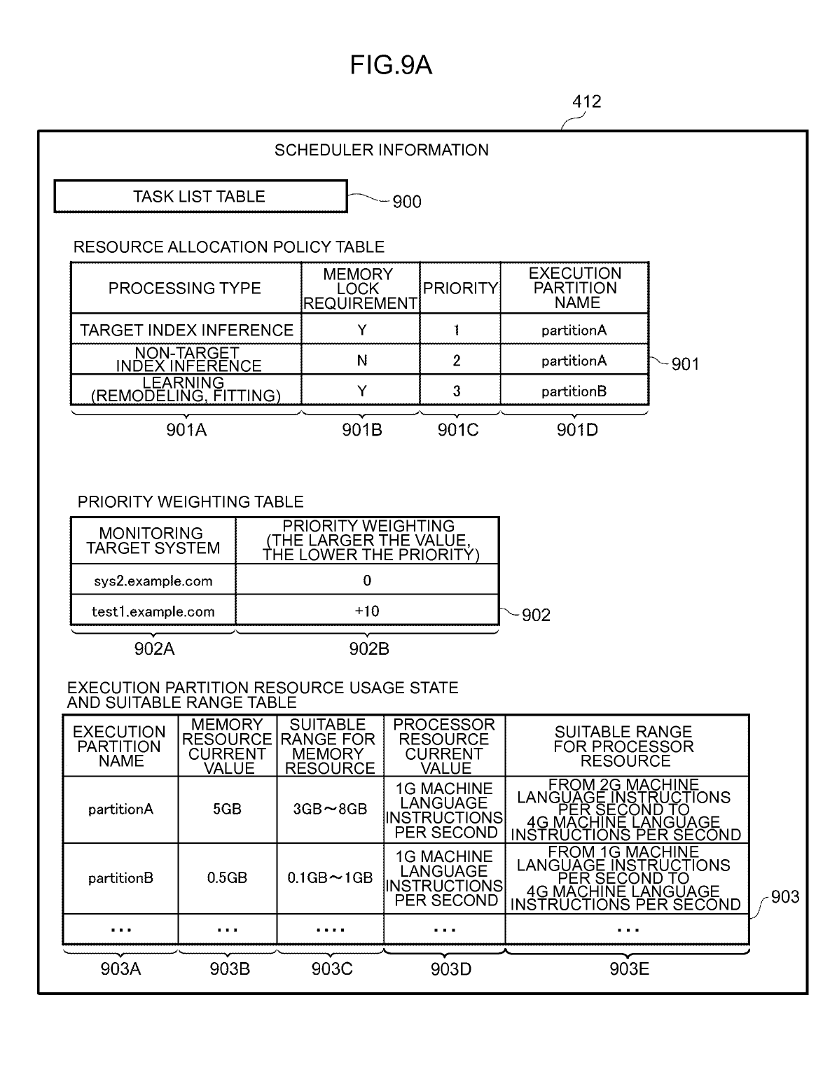

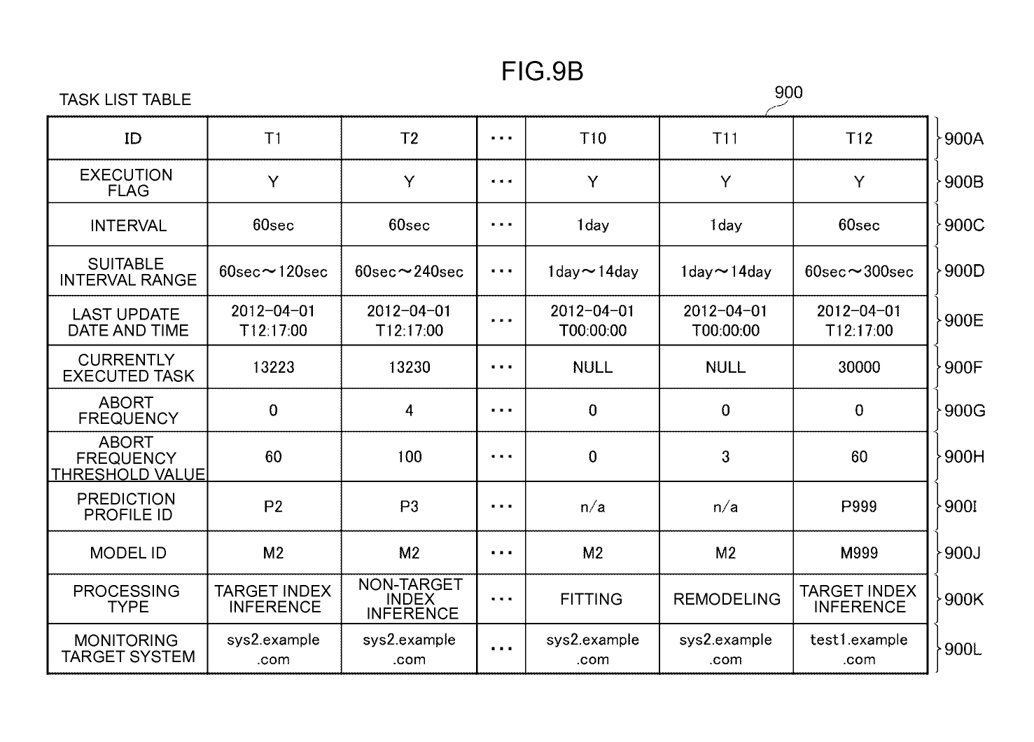

The scheduler 416 acquires a task list table 900 (FIG. 9B) for the inference or learning processing executed by the predictor program 201 (more specifically, any one of target index inference, non-target index inference, remodeling or fitting) from the scheduler information 412, performs transmission and reception of task messages to and from the predictor program 201, and updates the task list table 900 according to the execution status of the inference or learning processing tasks. The task list table 900, described subsequently, stores a list of inference or learning processing tasks (task list) which is executed by the predictor program 201.

(3-1-2) Configuration of System Profile Table and Prediction Profile Table

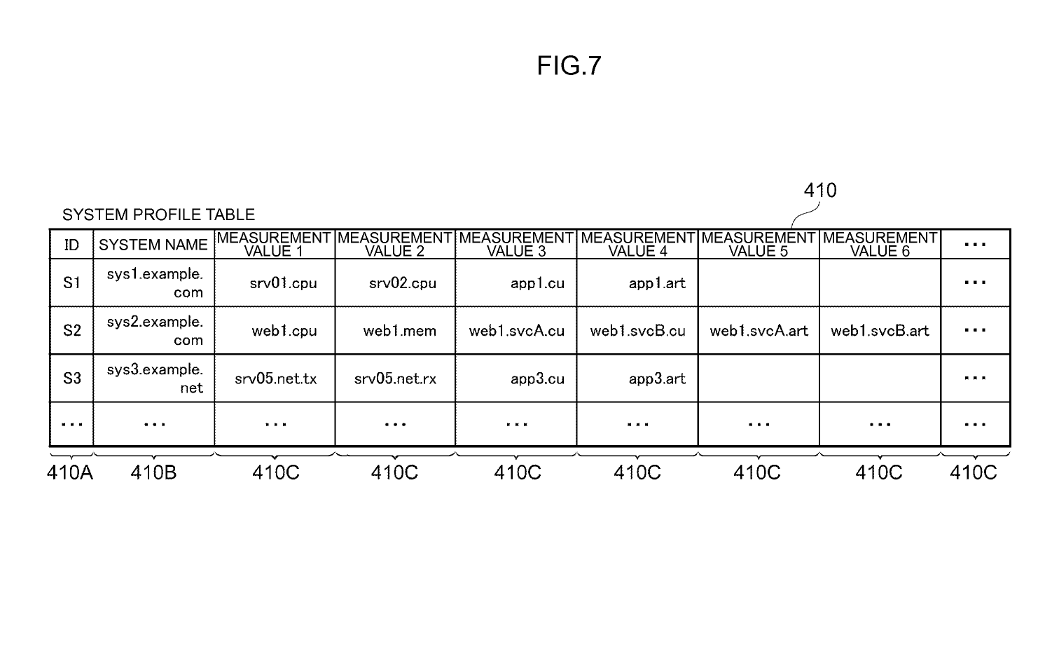

FIG. 7 shows a configuration example of a system profile table 410. In the information processing system 300 according to the present embodiment, the system profile table 410 is used for the predictor detection function of the system monitoring service. As shown in FIG. 7, the system profile table 410 is configured comprising a system ID field 410A and system name field 410B and an optional number of measurement value fields 410C. One row corresponds to one monitoring target system 311 (FIG. 2).

Further, the system ID field 410A stores the IDs (system IDs) assigned to the corresponding monitoring target systems 311 and the system name field 410B stores the names of the monitoring target systems 311 which are assigned to enable the system administrator to specify the corresponding monitoring target systems 311.

Furthermore, the measurement value fields 410C each store the respective measurement values 217 collected by the monitoring devices 111 from each of the devices which the monitoring target systems 311 comprise. The measurement values 217 are each assigned a name enabling each of these values to be distinguished. Accordingly, the number of measurement value fields 410C used by each of the monitoring target systems 311 differs for each monitoring target system 311. According to the present embodiment, the names of the measurement values 217 are generated and assigned based on the names of the task servers 110 and the types of measurement values 217 but value assignment is not limited to this method as long as the naming method is one which allows uniqueness to be secured so as not to inhibit smooth execution of each of the processes included in the present embodiment

Furthermore, in the system profile table 410, the monitoring target system 311 stores the input amounts and performance of the distributed application 310 (FIG. 3) pertaining to this execution in the measurement value field 410C. The performance indices are indices which are expressed by a numerical value, such as the number of users connected simultaneously per unit time and the average response time, and so on, in the case of a web application, for example. Names enabling discrimination between these performance indices are assigned thereto in the same way as the measurement values 217. Such names may also be generated based on the names of the services provided by the distributed application 310 and the index types, for example.

The system profile table 410 is typically stored in a file on the storage 103 (FIG. 1) of the predictor server 113 but is not limited thereto and may instead be stored in the memory 102 (FIG. 1) or may be stored on another server and acquired via communication if necessary. Furthermore, according to the present embodiment, a table format has been adopted as an information management system for performing management by means of the system profile table 410 for the sake of simplifying the description, but another data structure such as a key value format or document-oriented database or the like may also be adopted.

The information to be stored in each of the measurement value fields 410C of the system profile table 410 is configured by the system administrator of the customer system 301, for example.

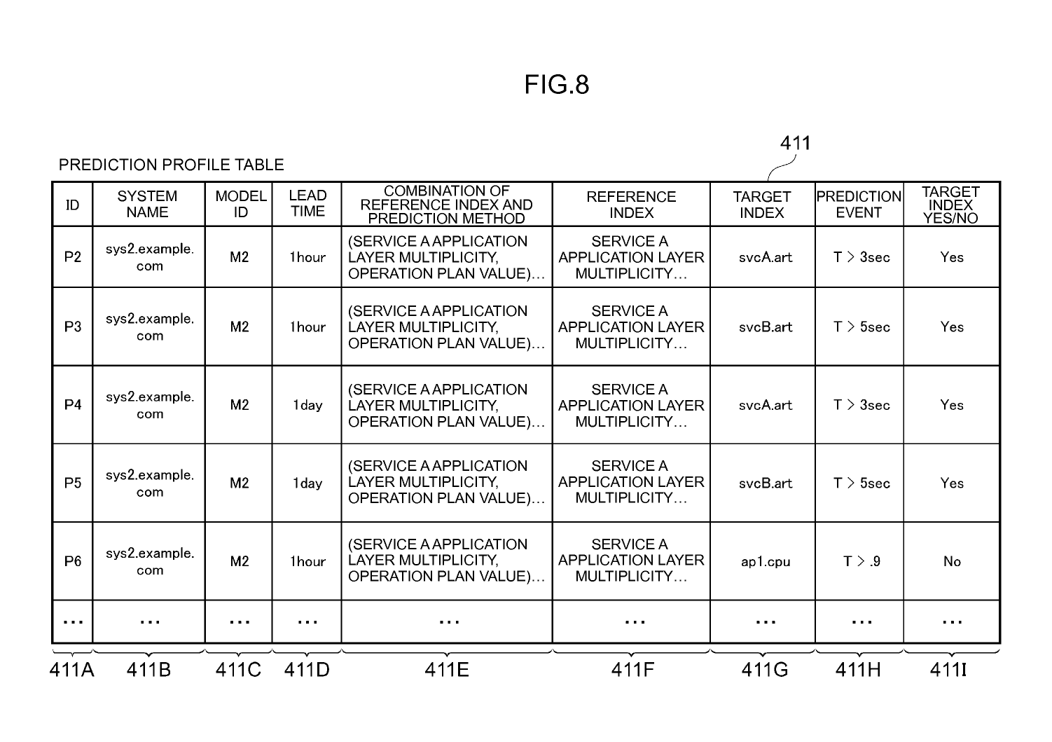

FIG. 8 shows a configuration example of the prediction profile table 411. The prediction profile table 411 is a table which is used to store definitions for inference of target indices and inference of non-target indices which are executed by the predictor program 201 (FIG. 6) (calculation of the probability that a target event will be generated or calculation of the probability that a target event pertaining to a non-target index will be generated). Each row of the prediction profile table 411 corresponds one for one to a single inference or learning processing instance.

This prediction profile table 411 is configured from an ID field 411A, a system name field 411B, a model ID field 411C, a lead time field 411D, a reference index and prediction method combination field 411E, a reference index field 411F, a target index field 411G, a prediction event field 411H and a target index yes/no field 411I.

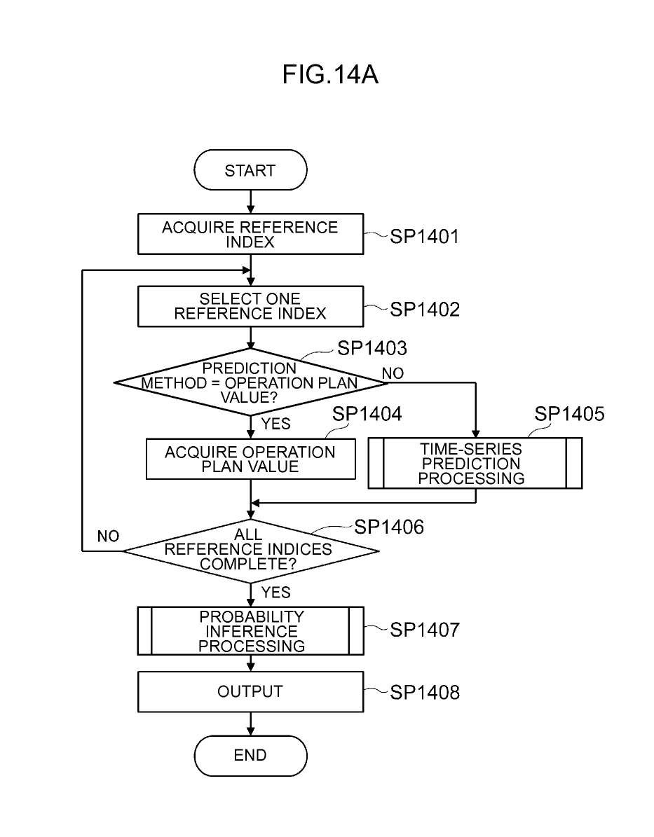

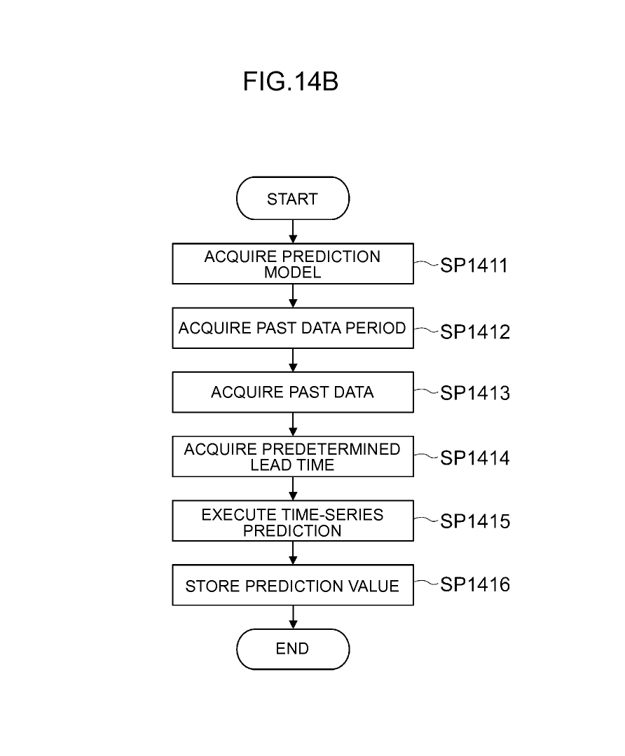

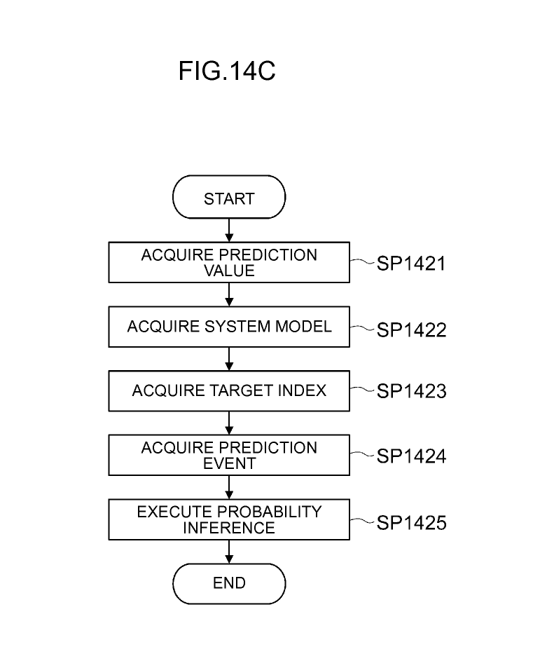

Further, the ID field 411A stores the IDs assigned to the prediction profiles (prediction profile IDs) of the corresponding inference or learning processing, and the system name field 411B stores the system names of the corresponding monitoring target systems 311 registered in the system profile table 410 (FIG. 7). Further, the model ID field 411C stores the IDs of the models (model IDs) used in probability inference processing (FIG. 14C), described subsequently, and the reference index field 411F, target index field 411G, and prediction event field 411H store the reference index, target index and prediction event of the corresponding probability inference processing respectively.

In addition, the reference index and prediction method combination field 411E stores a list in the format ‘(measurement value, prediction method), (measurement value, prediction method, . . . , (measurement value, prediction method).’ For example, (svcA.cu, F1) indicates that the reference index ‘svcA.cu (number of users simultaneously connected to service A)’ is to be predicted using the prediction method ‘F1’ Further, (service A application layer multiplicity, operation plan value) indicates that the reference index ‘service A application layer multiplicity’ is to use the ‘operation plan value.’

In addition, the lead time field 411D stores the lead time used by time-series prediction processing which will be described subsequently with reference to FIG. 14B and probability inference processing which will be described subsequently with reference to FIG. 14C. The lead time is a value indicating how many seconds a prediction value, obtained in time-series prediction processing and probability inference processing, is since the last time point of past data. Further, the target index yes/no field 411I stores information indicating whether the target of the corresponding probability inference processing is a target index (this is ‘Yes’ in the case of a target index and ‘No’ in the case of a non-target index.

The fields 411A to 411I of the prediction profile table 411 store values and the like which are configured by the system administrator of the customer system 301 (FIG. 2), for example.

(3-1-3) Configuration of Scheduler Information

FIGS. 9A and 9B show configuration examples of scheduler information 412. Whereas the prediction profile table 411 defines the processing content of the inference or learning processing, the scheduler information 412 is information defining the processing content of various tasks which the scheduler 416 (FIG. 6) causes the predictor program 201 (FIG. 6) to execute. As shown in FIG. 9A, the scheduler information 412 is configured from a task list table 900, a resource allocation policy table 901, a system priority weighting table 902, an execution partition resource usage state and suitable range table 903, which show respective processing execution states.

The monitoring target system 311 (FIG. 2) is only provided for the execution of the distributed application 310 (FIG. 3) and its internal state continues to change from one moment to the next; in addition to the changing risk of fault generation, inference or learning processing must also be continually performed and the task list table 900 is present in order to manage this processing. The inference or learning processing which is defined in the task list table 900 will sometimes be referred to as tasks hereinbelow.

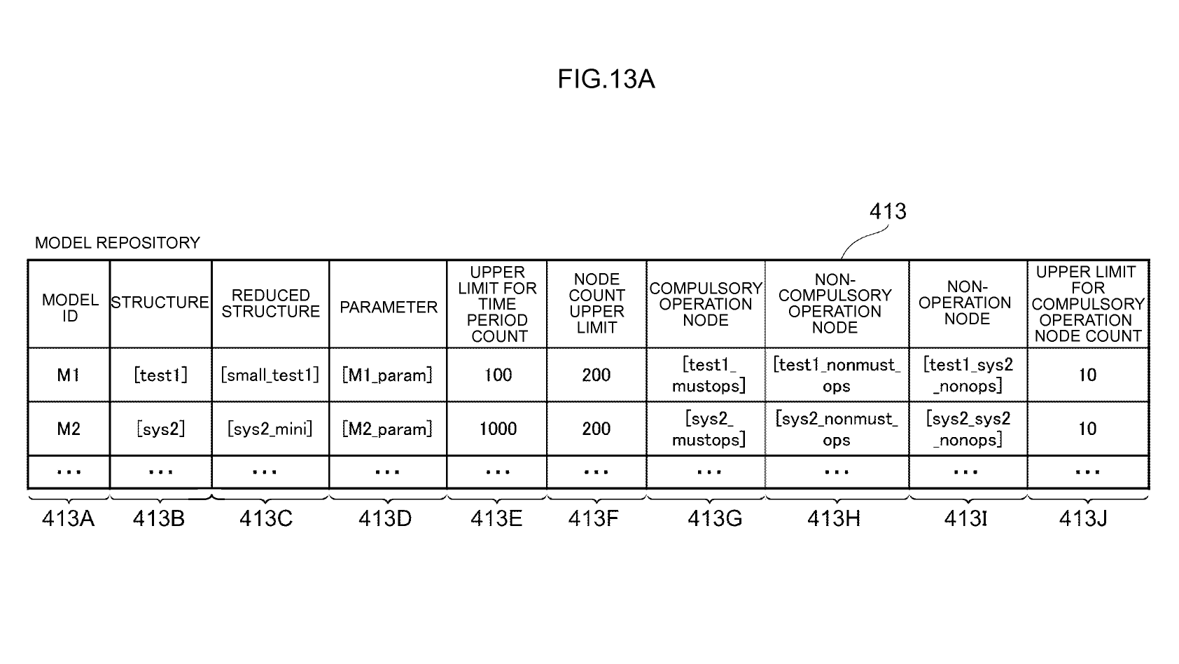

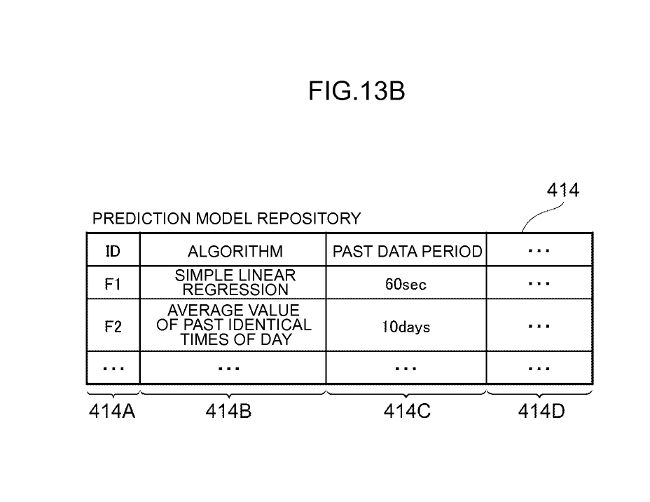

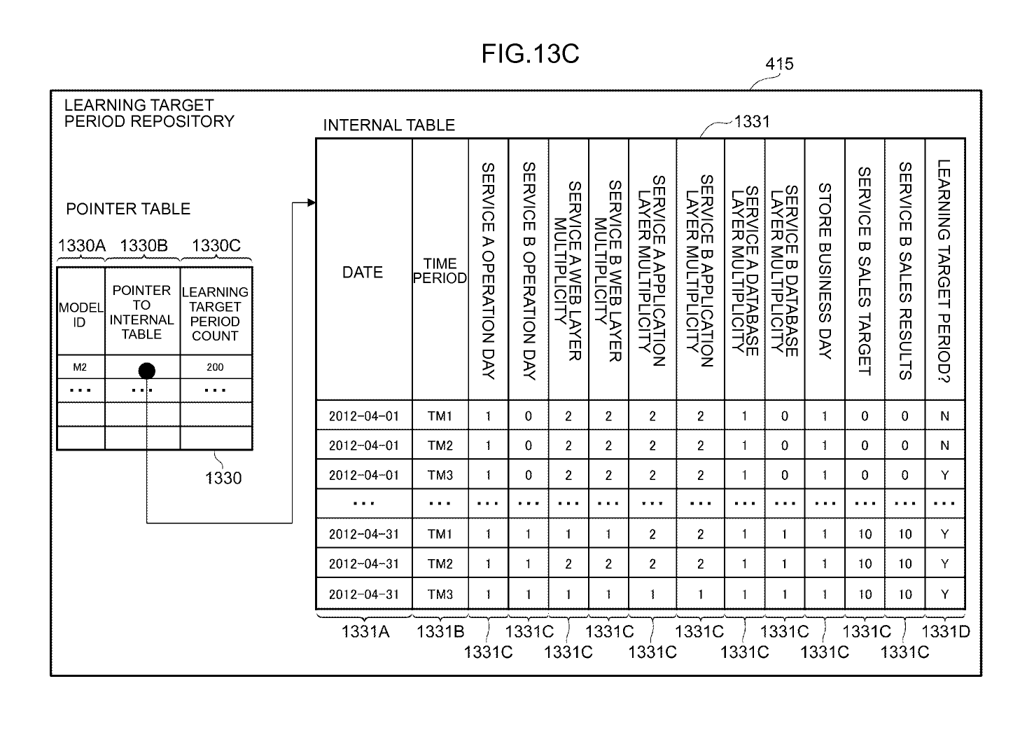

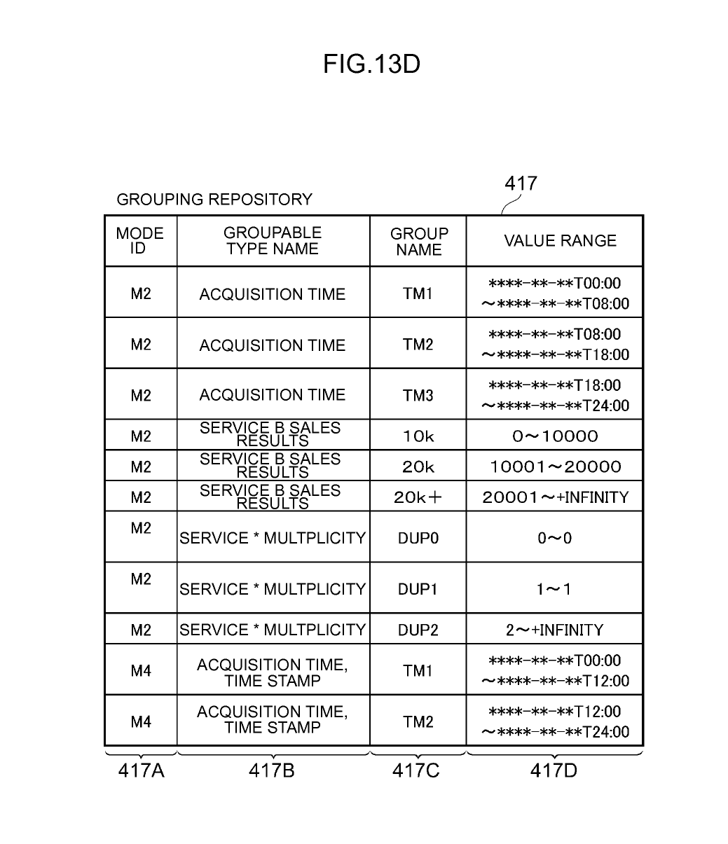

FIG. 9B shows a configuration example of the task list table 900. Each column of the task list table 900 corresponds to one task. If a task is inference processing, the monitoring target system 311 which is to serve as the target in the prediction profile table 411 (FIG. 8) is specified by a prediction profile ID. If a task is learning processing (remodeling or fitting), the modeling which is to serve as the target in the model repository 413, which will be described subsequently with reference to FIG. 13A, is specified from a model ID.

As shown in FIG. 9B, the task list table 900 is configured from a task ID field 900A, an execution flag field 900B, an interval field 900C, a suitable interval range field 900D, a last update date and time field 900E, a currently executed task field 900F, an abort frequency field 900G, an abort frequency threshold value field 900H, a prediction profile ID field 900I, a model ID field 900J, a processing type field 900K and a monitoring target system field 900L.

Furthermore, the task ID field 900A stores IDs which uniquely identify the corresponding tasks. In the case of the present embodiment, these IDs are expressed in a ‘Tx’ format (where x is a natural number). Further, the execution flag field 900B stores flags indicating whether the tasks corresponding to the columns are executed at regular intervals. If this flag is ‘Y,’ the corresponding task is to be executed at regular intervals and if the flag is ‘0,’ the corresponding task is not to be performed at regular intervals.

Further, the interval field 900C stores periods (60 seconds, one day, 10 days, and so forth) indicating the execution periods when the corresponding tasks are executed at regular intervals, and the suitable interval range field 900D stores suitable ranges for these intervals. In addition, the last update date and time field 900E stores the date and time when execution of the corresponding task was last started. The currently executed task field 900F stores an identifier (TID) of a task control thread of the task control unit 708 in the predictor program 201 executing a corresponding task if the task is currently being executed. ‘NULL’ is stored if the task is not being executed.

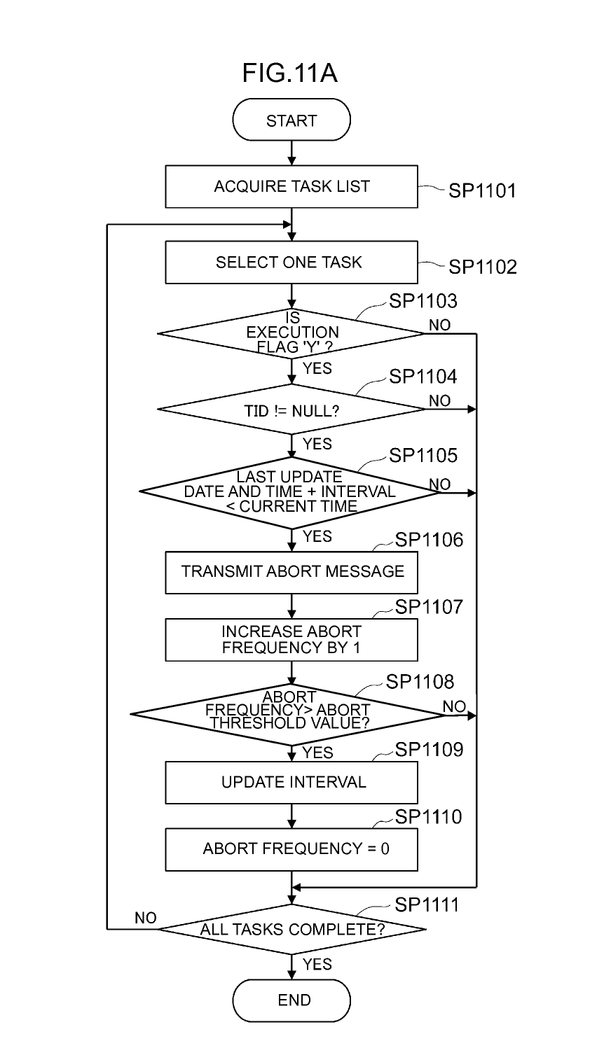

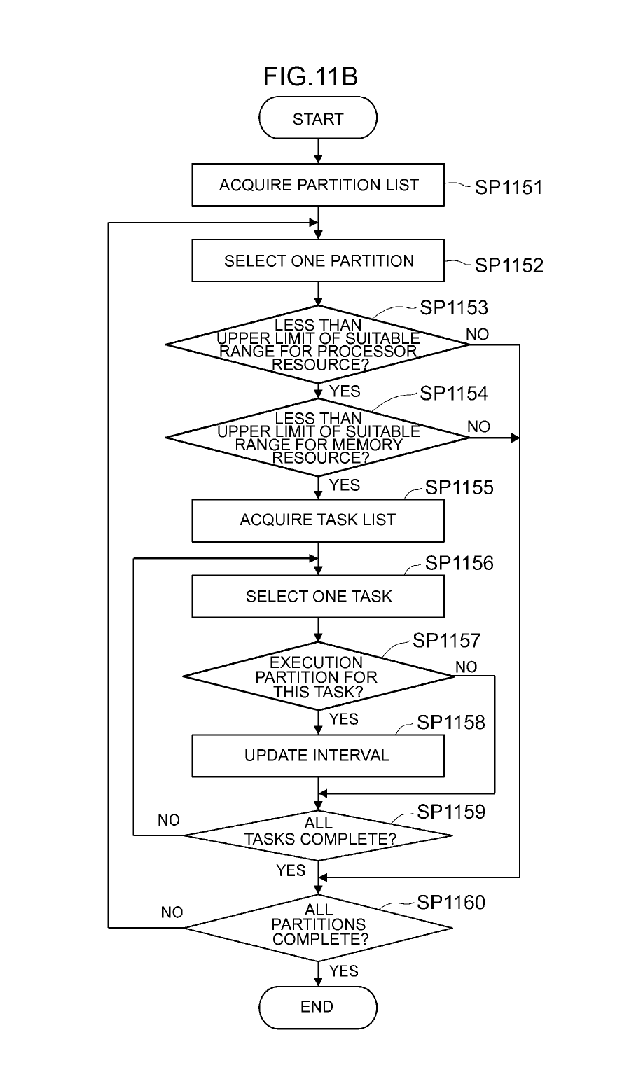

In addition, the abort frequency field 900G stores the frequency with which the corresponding task is interrupted and the abort frequency threshold value field 900H stores a threshold value for the abort frequency of the corresponding task which is used in the abort processing which will be described subsequently with reference to FIG. 11A. Further, the prediction profile ID field 900I stores prediction profile IDs of the monitoring target systems 311 serving as the targets in the prediction profile table 411 described hereinabove with reference to FIG. 8 if the corresponding task is inference processing, and stores ‘n/a,’ meaning that no target exists, if the corresponding task is learning processing.

In addition, the processing type field 900K stores the processing types of the corresponding tasks and the monitoring target system field 900L stores the system IDs of the monitoring target systems 311 which are to be the corresponding task targets.

Here, there are four types of column in the task list table 900.

(A) A column in which the processing type is ‘target index inference’

(B) A column in which the processing type is ‘non-target index prediction’

(C) A column in which the processing type is ‘remodeling’

(D) A column in which the processing type is ‘fitting’

Note that (C) and (D) are columns related to learning processing tasks and one of each of these columns is created for duplicate model IDs. For example, the model ID M2 appears four times but one of each of the columns ‘remodeling’ and ‘fitting’ are created.

The initial values of each column in the task list table 900 are configured as follows for each of the above processing types.

(A) In the case of ‘target index inference,’ the value of the ID field 900A is ‘Tx,’ the value of the execution flag field 900B is ‘Y,’ and the value of the interval field 900C is either the same or less than (half, for example) the lead time of the prediction profile table 411, the maximum value for the suitable interval range field 900D is the lead time of the prediction profile table 411 and the minimum value is less (half, for example). The last update date and time field 900E and currently executed task field 900F are void, the value of the abort frequency field 900G is ‘0’ and the value of the abort frequency threshold value field 900H is a large value compared with relearning for the sake of minimizing deterioration in response performance. In addition, the value of the monitoring target system field 900L is configured as the system name of the monitoring target system 311 which is uniquely specified from the model ID in the prediction profile table 411.

(B) The case of ‘prediction of a non-target index non-target index’ is basically the same as the target index inference case. However, the maximum value for the value of the suitable interval range field 900D is configured as a multiple of the lead time in the prediction profile table 411 (ten times the lead time, for example) so as not to obstruct target index inference.

(C) In the case of ‘remodeling,’ the value of the ID field 900A is ‘Tx,’ the value of the execution flag field 900B is ‘Y,’ the value of the interval field 900C is ‘7 days,’ for example, the value of the suitable interval range field 900D is, for example, ‘1 to 14 days,’ the last update date and time field 900E and currently executed task field 900F are void, the value of the abort frequency field 900G is ‘0,’ and the value of the abort frequency threshold value field 900H is a small value compared with inference processing for the sake of quickly reducing the execution frequency if further processing is obstructed. In addition, the value of the prediction profile ID field 900I is ‘n/a,’ and the value of the model ID field 900J is configured as the model ID of the corresponding model in the prediction profile table 411. Further, the value of the monitoring target system field 900L configures the system name of the monitoring target system 311 which is uniquely specified from the prediction profile ID.

(D) The ‘fitting’ case is basically the same as the remodeling case, but the value of the interval field 900C is shorter than for ‘remodeling’ and set at ‘1 day,’ for example.

The value of the interval field 900C in each column of the task list table 900, the value of the suitable interval range field 900D and the initial value of the value of the abort frequency threshold value field 900H are each determined by two perspectives, namely, the requirement for processing responsiveness and the consumption of computer resources.

More specifically, where the processing for which responsiveness is required, the initial value of the value of the interval field 900C and the minimum value for the value of the suitable interval range field 900D are configured so as to be small and the value of the abort frequency threshold value field 900H is configured small. Meanwhile, where the processing for which there is little need for a fast response is concerned, the initial value of the value of the interval field 900C and the maximum value of the value of the suitable interval range field 900D are configured so as to be large and the value of the abort frequency threshold value field 900H is configured so as to be large.

Further, in the case of learning processing with a high consumption of computer resources (remodeling or fitting), the initial value of the value of the interval field 900C and the minimum and maximum values for the values of the suitable interval range field 900D are configured so as to be large, the execution frequency is kept suitably low, and the value of the abort frequency threshold value field 900H is initially configured to be small, so as to not obstruct other processing, specifically the inference processing. As will be described subsequently, the interval is accordingly large when there is a strain on computer resources to enable computer resources to be diverted toward other processing.

Meanwhile, the resource allocation policy table 901 (FIG. 9A) is a table for managing the resource allocation policy for each processing type and, as shown in FIG. 9A, is configured from a processing type field 901A, a memory lock requirement field 901B, a priority field 901C and an execution partition name field 901D.

Further, the processing type field 901A stores the type names (‘target index inference,’ ‘non-target index inference,’ or ‘learning (remodeling or fitting)’) of the corresponding processing types (processing types in task list table 900), and the memory lock requirement field 901B stores information indicating whether memory lock is required for the corresponding processing type. More specifically, ‘Y’ is stored if memory lock is required and ‘N’ is stored if memory lock is not required.

In addition, the priority field 901C stores the priorities of the corresponding processing types (the smaller the number, the higher the priority is), and the execution partition name field 901D stores the partition name of the partition in which the corresponding processing type is to be executed. In the case of the present embodiment, ‘target index inference’ and ‘non-target index inference’ are executed in ‘Partition A’ and ‘learning (remodeling or fitting)’ is executed in ‘Partition B.’

For these partitions, a method can be adopted for designating a processor number and a number group (a list of processor core numbers) for the processor 101 (FIG. 1), a soft partition number (HP-UX pset), or a logical partition (LPAR), and the like. Further, if the processor core is a single virtual processor, a processor usage budget number which is provided via an operating system or hypervisor interface can also be adopted. With this method, the processor time and processor instruction cycle number (number of machine language instructions and GHz) which are available for a certain time can be designated for each budget number.

In learning processing (remodeling and fitting) and inference processing (target index inference and non-target index inference), by dividing up usable processor and memory resources into partitions and performing budget management, computer resources can be suitably allocated such that target index inference is unhampered and remodeling and fitting give up computer resources to other processing.

In addition, the system priority weighting table 902 (FIG. 9A) is a table for managing the priority weightings for each monitoring target system 311. The priority weightings indicate values for reducing priority. The numerical values for the priority are like UNIX (registered trademark) nice values: the smaller the value, the higher the priority.

As shown in FIG. 9A, the system priority weighting table 902 is configured from a monitoring target system field 902A and priority weighting field 902B. The monitoring target system field 902A stores each of the system names of the respective monitoring target systems 311 and the priority weighting field 902B stores numerical values which are to be added to the priorities of the corresponding monitoring target systems 311. For example, if ‘test1.example.com’ is a test system and the importance of ‘sys2.example.com’ is very low, the priority weighting of the former is ‘0’ and the priority weighting of the latter is ‘+10,’ thereby enabling the processing priority pertaining to the latter system to be reduced.

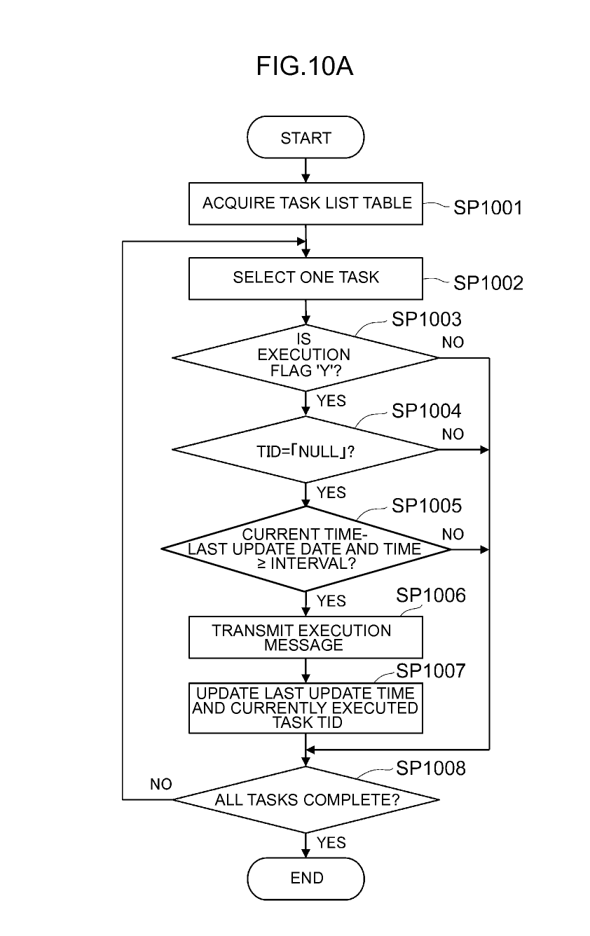

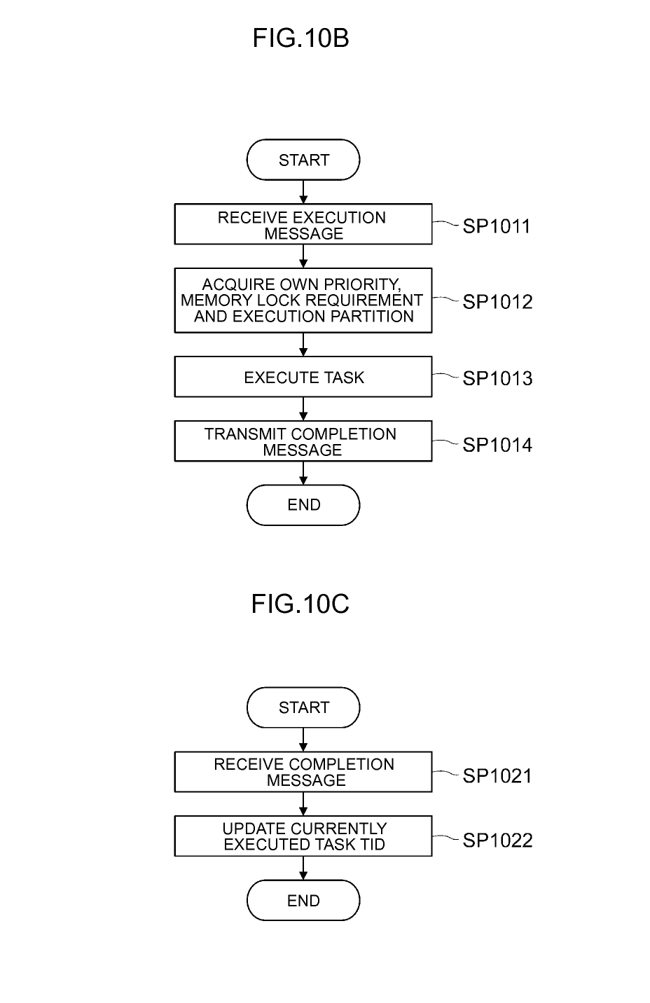

The resource allocation policy table 901 and system priority weighting table 902 are referenced by the task activation thread of the scheduler 416 (FIG. 6) in the task activation processing, which will be described subsequently with reference to FIG. 10A, in order to determine the priority, memory lock requirement and execution partition for the task whose execution is started.

Meanwhile, the execution partition resource usage state and suitable range table 903 is a table which is used to manage the current usage amount and suitable range of processor and memory resources for each execution partition and, as shown in FIG. 9A, is configured from an execution partition name field 903A, a memory resource current value field 903B, a memory resource suitable range field 903C, a processor resource current value field 903D and a processor resource suitable range field 903E.

Further, the execution partition name field 903A stores the partition name of the partition in which the current task is being executed and the memory resource current value field 903B and processor resource current value field 903D stores the usage states of the current memory resources and processor resources respectively. Further, the memory resource suitable range field 903C and processor resource suitable range field 903E store suitable usage ranges for the memory resources and processor resources respectively. This execution partition resource usage state and suitable range table 903 is referenced by the interval shortening trial thread of the scheduler 416 (FIG. 6) in the interval shortening trial processing which will be described subsequently with reference to FIG. 11B.

(3-1-4) Scheduler Processing

(3-1-4-1) Task Activation Processing

FIG. 10A shows a processing routine for task activation processing which is executed by a task activation thread (not shown) of the scheduler 416. This task activation thread causes the predictor program 201 to execute each task registered in the task list table 900 according to the processing routine shown in FIG. 10A. Note that, although a case is described below in which the scheduler 416 is configured to perform parallel processing using a thread mechanism, a multiprocessing configuration or another parallel processing mechanism or asynchronous processing mechanism can also be adopted.

First, the task activation thread acquires the task list table 900 (SP1001) and selects one task from among the tasks registered in the acquired task list table 900 (SP1002).

The task activation thread then sequentially judges, for the task selected in step SP1002, whether ‘Y’ is stored in the corresponding execution flag field 900B in the task list table 900 (FIG. 9B) (that is, whether this task is to be executed), whether ‘NULL’ is stored in the corresponding currently executed task field 900F (that is, whether this task is not being executed), and whether the time since the last update date and time until the current time is equal to or more than the value (interval) stored in the corresponding interval field 900C in the task list table 900 (SP1003 to SP1005).

Here, when a negative result is obtained in any one of steps SP1003 to SP1005, this means that the corresponding task should not be executed at present. The task activation thread thus advances to step SP1008.

If, on the other hand, an affirmative result is obtained in all of the steps SP1003 to SP1005, this means that the corresponding task can be executed and that the corresponding interval since the previous execution time has been exceeded and the task is in a non-execution state. The task activation thread therefore then transmits an execution message which is a message to the effect that this task is to be executed to the task control unit 708 (FIG. 6) of the predictor program 201 (FIG. 6) (SP1006).

The task activation thread then updates the last update date and time stored in the last update date and time field 900E which corresponds to this task in the task list table 900 to the current time and updates the value stored in the corresponding currently executed task field 900F in the task list table 900 to the identifier of the task control thread, described subsequently, in the task control unit 708 (FIG. 6) which is activated by the task activation thread (SP1007).

The task activation thread then judges whether or not execution of the processing of steps SP1003 to SP1007 is complete for all the tasks registered in the task list table 900 (SP1008). If a negative result is obtained in this judgment, the task activation thread returns to step SP1002 and then repeats the processing of steps SP1002 to SP1008 while sequentially switching the task selected in step SP1002 to another unprocessed task.

Further, if an affirmative result is obtained in step SP1008 as a result of completing execution of the processing of steps SP1003 to SP1007 for all the tasks which are registered in the task list table 900, the task activation thread ends the task activation processing.

The task activation thread causes the predictor program 201 to execute the task continuously by executing the task activation processing above at regular intervals.

(3-1-4-2) Task Execution Control Processing

Meanwhile, FIG. 10B shows a processing routine for task execution control processing which is executed by a task execution control thread (not shown) of the task control unit 708 (FIG. 6) of the predictor program 201 (FIG. 6) which is related to the inference or learning processing (task). The task execution control thread causes the predictor program 201 to execute the task which is designated in the execution message transmitted from the foregoing task activation thread according to the processing routine shown in FIG. 10B.

In reality, the task execution control thread is normally in a state of awaiting reception of the foregoing execution message. Further, upon receiving the execution message from the scheduler 416 (SP1011), the task execution control thread first references the task list table 900 (FIG. 9B) and resource allocation policy table 901 (FIG. 9A) for each processing type to acquire respective information relating to the process priority, whether there is a memory lock requirement and the partition in which the task is to be executed (SP1012).

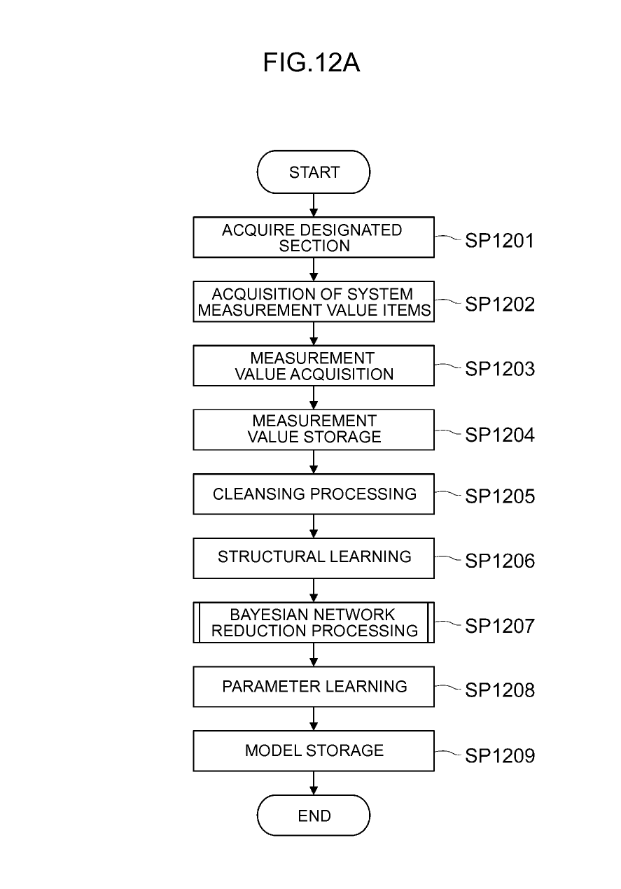

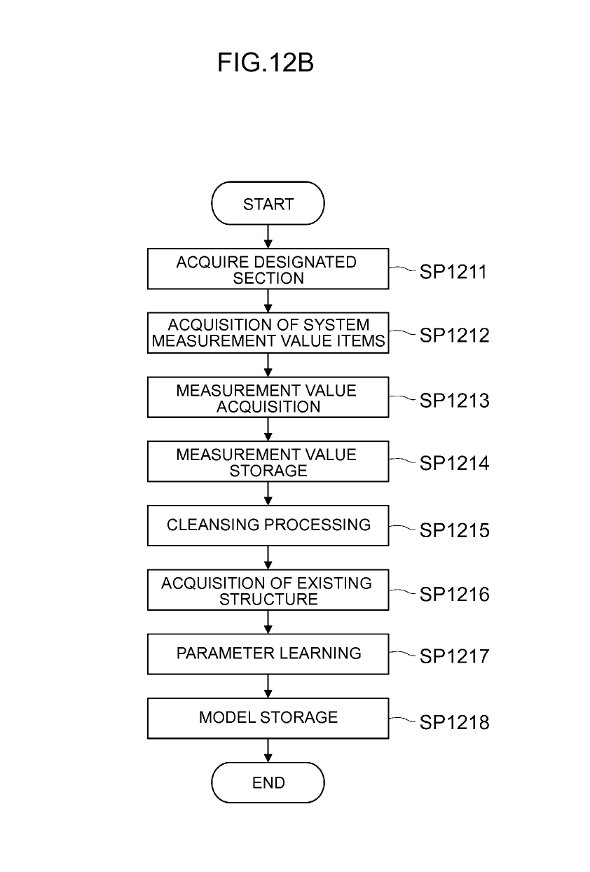

Thereafter, the task execution control thread causes the predictor program 201 to execute the task designated in the execution message by designating required processing to the corresponding object in the predictor program 201 such as the model generation unit 703, the time-series prediction unit 705 and/or the inference unit 706 which were described hereinabove with reference to FIG. 6 (SP1013). The processing executed in step SP1013 is the foregoing ‘learning processing (remodeling, fitting)’ or ‘inference processing (target index inference or non-target index inference).’ The specific processing content will be described subsequently with reference to FIGS. 12 to 14.

Further, in step SP1013, the task execution control thread executes the task with the priority (process priority, for example) designated in the partition designated by the execution message and issues an instruction to the required object to perform the memory lock if the memory for use by the task has been designated. Note that the process priority is, for example, a UNIX (registered trademark) process priority and if a memory lock is required, a UNIX (registered trademark) mlock (1m) can be used, for example.

Furthermore, when execution of this task by the predictor program 201 is complete, the task execution control thread transmits a completion message to the scheduler 416 (SP1014) and then ends the task execution control processing and returns to an execution message reception standby state to await reception of the next execution message.

(3-1-4-3) Task Completion Recovery Processing

Meanwhile, FIG. 100 shows a processing routine for task completion recovery processing which is executed by the task completion recovery thread (not shown) of the scheduler 416 which is related to the inference or learning processing (task). The task completion recovery thread recovers the completion message transmitted from the task execution control thread of the task control unit 708 in the predictor program 201 as described hereinabove, according to the processing routine shown in FIG. 100.

First of all, the task completion recovery thread is always in a state of awaiting reception of the completion message. Further, upon receiving the foregoing completion message which was transmitted from the task control unit 708 in the predictor program 201 (SP1021), the task completion recovery thread updates the value stored in the currently executed task field corresponding to the task in the task list table 900 to ‘NULL’ (SP1022).

Further, the task completion recovery thread then ends the task completion recovery processing and returns to a completion message standby state to await reception of the next completion message.

Note that, for the message exchange between the scheduler 416 and the task control unit 708 of the predictor program 201 described hereinabove, it is possible to use an optional inter-process communication system such as HTTP (Hyper Text Transfer Protocol), RPC (Remote Procedure Call) or message queuing.

(3-1-4-4) Abort Processing

FIG. 11A shows a processing routine for abort processing which is executed by the abort processing thread (not shown) in the scheduler 416 and related to inference or learning processing.

There is a possibility that the inference or learning processing (task) executed by the predictor program 201 will continue to be executed for some reason even when the interval prescribed for the task since the execution start time point is exceeded. Since time is lost even when the results of such task processing are output normally, for example, it is desirable to interrupt processing to prevent computer resources from being wasted. Therefore, according to the present embodiment, this abort processing thread interrupts any such task, which is still being executed even though the interval since the execution start time point has been exceeded, by executing the abort processing shown in FIG. 11A at regular intervals.

In reality, when starting this abort processing, the abort processing thread first acquires the task list table 900 (S1101). Further, the abort processing thread selects one unprocessed task from among the tasks which are registered in the acquired task list table 900 (FIG. 9B) (SP1102).

The abort processing thread then sequentially judges, for the task selected in step SP1102, whether the ‘Y’ is stored in the corresponding execution flag field 900B in the task list table 900 (that is, whether the task is to be executed), whether ‘NULL’ is stored in the corresponding currently executed task field 900F (that is, whether the task is being executed), whether the sum of the last update date and time of the task which is stored in the corresponding last update date and time field 900E and the interval for the task which is stored in the corresponding interval field 900C is smaller than the current time (SP1103 to SP1105).

Here, when a negative result is obtained in any one of these steps SP1103 to SP1105, this means that the corresponding task is not being executed. Therefore, the abort processing thread then advances to step SP1111.

If, on the other hand, an affirmative result is obtained in all of the steps SP1103 to SP1105, this means that the corresponding task is currently being executed and that the time elapsed since the task was started exceeds the interval determined for the task. The abort processing thread therefore then transmits an abort message to the task control unit 708 (FIG. 6) of the predictor program 201 (FIG. 6) (SP1106). The abort processing thread then also increments by one the numerical value (abort frequency) which is stored in the abort frequency field 900G corresponding to the task in the task list table 900 (SP1107).

The abort processing thread subsequently references the corresponding abort frequency threshold value field 900H in the task list table 900 and judges whether or not the abort frequency of this task exceeds the abort frequency threshold value which has been prescribed for this task (SP11108). If a negative result is obtained in this judgment, this abort processing thread then advances to step SP1111.

If, on the other hand, an affirmative result is obtained in the judgment of step SP1108, the abort processing thread changes the interval stored in the interval field 900C corresponding to this task in the task list table 900 to the smaller of two values including a value two times the current value and the upper limit value for the suitable interval range which is stored in the suitable interval range field 900D (SP1109). Further, the abort processing thread resets (updates to ‘0’) the abort frequency which is stored in the abort frequency field 900G corresponding to the task in the task list table 900 (SP1110).

The abort processing thread then judges whether or not execution of the processing of steps SP1102 to SP1110 is complete for all the tasks which are registered in the task list table 900 (SP1111). Further, if a negative result is obtained in this judgment, the abort processing thread returns to step SP1102 and then repeats the processing of steps SP1102 to SP1111 while sequentially switching the task selected in step SP1102 to another unprocessed task.

Further, when an affirmative result is obtained in step SP1111 as a result of already completing execution of the processing of steps SP1102 to SP1110 for all the tasks which are registered in the task list table 900, the abort processing thread ends the abort processing.

The abort processing thread prevents wastage of computer resources by the predictor program 201 by executing the foregoing abort processing at regular intervals. The abort frequency threshold value may be set at a sufficiently large value or an infinity value (in a case where the format defined by IEEE Standard 754 is used, for example) for those tasks for which an interval increase is undesirable.

(3-1-4-5) Interval Shortening Trial Processing

Meanwhile, FIG. 11B shows a processing routine for interval shortening trial processing which is executed by an interval shortening trial thread (not shown) of the scheduler 416 and related to inference or learning processing. The interval shortening trial thread shortens the interval for inference or learning processing (task) which can be shortened if required, according to the processing routine shown in FIG. 11B. Note that, as a prerequisite for when a task interval is shortened, the condition is that there be a surplus of computer resources. A surplus of computer resources arises, for example, as a result of increasing the interval of any of the tasks in the foregoing abort processing.

When starting this interval shortening trial processing, this interval shortening trial thread first references the execution partition resource usage state and suitable range table 903 (FIG. 9A) to acquire a list in which all the partitions for executing the current task are registered (hereinafter called a partition list) (SP1151). Further, the interval shortening trial thread selects one partition from the partitions registered in the partition list acquired in step SP1151 (SP1152).

The interval shortening trial thread subsequently references the partition resource usage state and suitable range table 903 and judges whether or not the processor resource current value for the partition selected in step SP1152 is below the upper limit for the processor resource suitable range prescribed for the partition (SP1153).

In addition, when a negative result is obtained in this judgment, the interval shortening trial thread advances to step SP1160, and when an affirmative result is obtained, the interval shortening trial thread judges whether or not the memory resource current value for this partition is below the upper limit for the memory resource suitable range prescribed for this partition (SP1154). If a negative result is obtained in the judgment of step SP1154, the interval shortening trial thread advances to step SP1160, and when an affirmative result is obtained, the interval shortening trial thread acquires the task list table 900 (SP1155) and selects one task from among the tasks registered in the acquired task list table 900 (SP1156).

The interval shortening trial thread then references the resource allocation policy table 901 (FIG. 9A) and the execution partition resource usage state and suitable range table 903 (FIG. 9B) to judge whether or not the partition where the task selected in step SP1156 is being executed is the partition selected in step SP1152 (SP1157). Further, if a negative result is obtained in this judgment, the interval shortening trial thread advances to step SP1159.

If, on the other hand, an affirmative result is obtained in the judgment of step SP1157, the interval shortening trial thread updates the interval value stored in the interval field 900C corresponding to the task selected in step SP1156 in the task list table 900 to the larger of two values including 0.9 times the current interval value and the upper limit value for the suitable interval range prescribed for the task (SP1158).

The interval shortening trial thread then judges whether or not execution of the processing of steps SP1156 to SP1158 is complete for all the tasks which are registered in the task list table 900 acquired in step SP1155 (SP1159). If a negative result is obtained in this judgment, the interval shortening trial thread then returns to step SP1156 and then repeats the processing of steps SP1156 to SP1159 while sequentially switching the task selected in step SP1156 to another unprocessed task.

When an affirmative result is obtained in step SP1159 as a result of already completing execution of the processing of steps SP1156 to SP1158 for all the tasks which are registered in the task list table 900, the interval shortening trial thread judges whether or not execution of the processing of steps SP1152 to SP1159 is complete for all the partitions registered in the partition list acquired in step SP1151 (SP1160).

Further, if a negative result is obtained in this judgment, the interval shortening trial thread returns to step SP1152 and then repeats the processing of steps SP1152 to SP1159 while sequentially switching the partition selected in step SP1152 to another unprocessed partition.

Further, when an affirmative result is obtained in step SP1160 as a result of already completing execution of the processing of steps SP1152 to SP1159 for all the partitions which are registered in the partition list acquired in step SP1151, the interval shortening trial thread ends the interval shortening trial processing.

(3-1-5) Predictor Program Processing

(3-1-5-1) Learning Processing (Remodeling Processing and Fitting Processing)

FIGS. 12A and 12B shows processing routines for learning processing which is executed by the predictor program 201 under the control of the task execution control thread of the task control unit 708 in the predictor program 201 (FIG. 6) in step SP1013 of FIG. 10B. FIG. 12A shows a processing routine for remodeling processing which generates a model for the monitoring target system 311 (FIG. 3) in this learning processing. FIG. 12B shows a processing routine for fitting processing which updates the parameters of an already existing model to the latest values.

The inference or learning processing requires a model of the monitoring target system 311. This model is a statistical model which describes the mutual relationships between measurement values or performance indices, based on the data of basic numerical values as per the measurement value and performance index combination table 404 shown in FIG. 5B, for measurement values and performance indices pertaining to the monitoring target systems 311 registered in the system profile table 410. Such a model adopts a Bayesian network according to the present embodiment.

A Bayesian network is a probability model which is configured from a non-circular directed graph in which a plurality of probability variables are taken as nodes, and a conditional probability table or conditional probability density function for each variable based on the dependency between the nodes expressed by the graph and the model can be constructed using statistical learning. More particularly, the act of determining the structure of a non-circular directed graph by using measurement data of variables is known as ‘structural learning’ and the act of generating the parameters for a conditional probability table or conditional probability density function for each node in the graph is known as ‘parameter learning.’

Furthermore, the ‘structure’ of the model repository 413, described subsequently with reference to FIG. 13A, refers to the configuration of the corresponding Bayesian network which comprises nodes and directed edges or arcs between nodes. Further, the ‘parameters’ of the model repository 413 refer to a conditional probability table or conditional probability density function for each node contained in the ‘structure.’

According to the present embodiment, the model generation unit 703 (FIG. 6) in the predictor program 201 (FIG. 6) performs remodeling processing and fitting. The remodeling processing and fitting processing is executed by the model generation unit 703 in response to the task control unit 708 (FIG. 6) in the predictor program 201 receiving an execution message from the scheduler 416 (FIG. 6) to the effect that remodeling processing or fitting processing is to be executed and the task execution control thread of the foregoing task control unit 708 issues an instruction to the model generation unit 703 to execute remodeling processing or fitting processing.

In reality, when the remodeling processing execution instruction is supplied from the task control unit 708, the model generation unit 703 starts the remodeling processing shown in FIG. 12A and first obtains, as a designated section, a time period which is to serve as the learning target (hereinafter suitably called the ‘learning target period’) from the learning target period repository 415, described subsequently with reference to FIG. 13C (SP1201).

The model generation unit 703 subsequently acquires measurement value items of the monitoring target system 311 then serving as the target which are recorded in the system profile table 410 (FIG. 7) (SP1202) and acquires all the measurement values in the designated section of each of these items from the data storage unit 702 (SP1203). Further, the model generation unit 703 stores the acquired measurement values in the memory 102 (FIG. 1) (SP1204) and performs cleansing processing on these measurement values (SP1205). Cleansing processing employs methods which are generally known as statistical processing in which observation data is taken as the target, such as the removal of outlying values, missing value complementation or normalization, or a combination thereof.

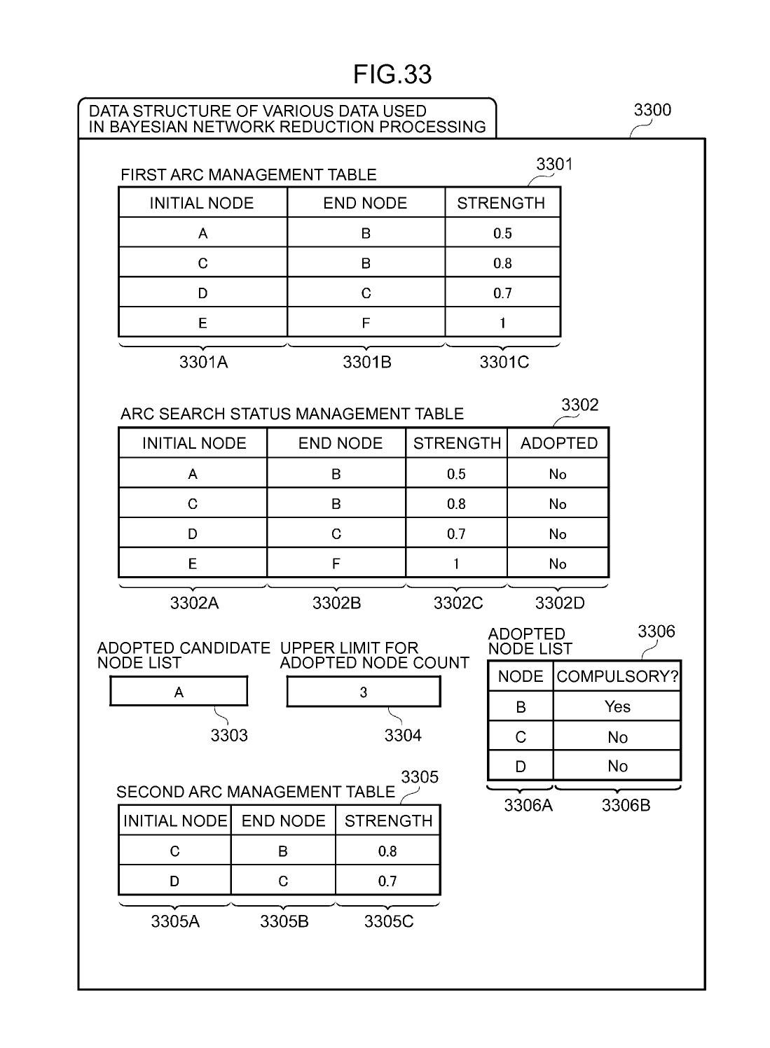

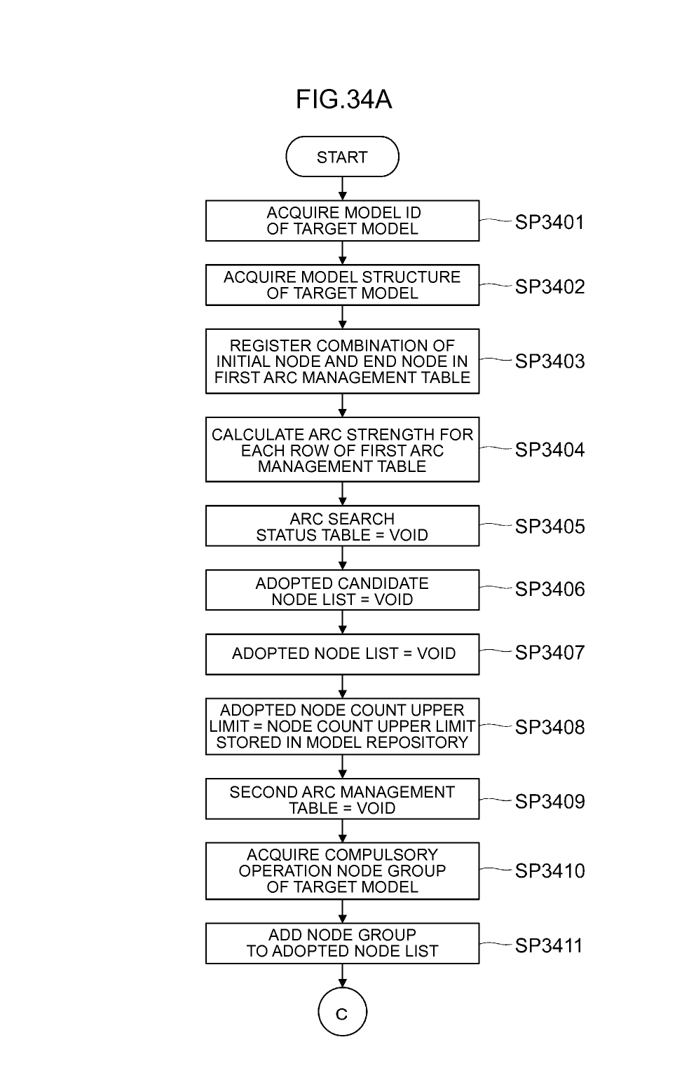

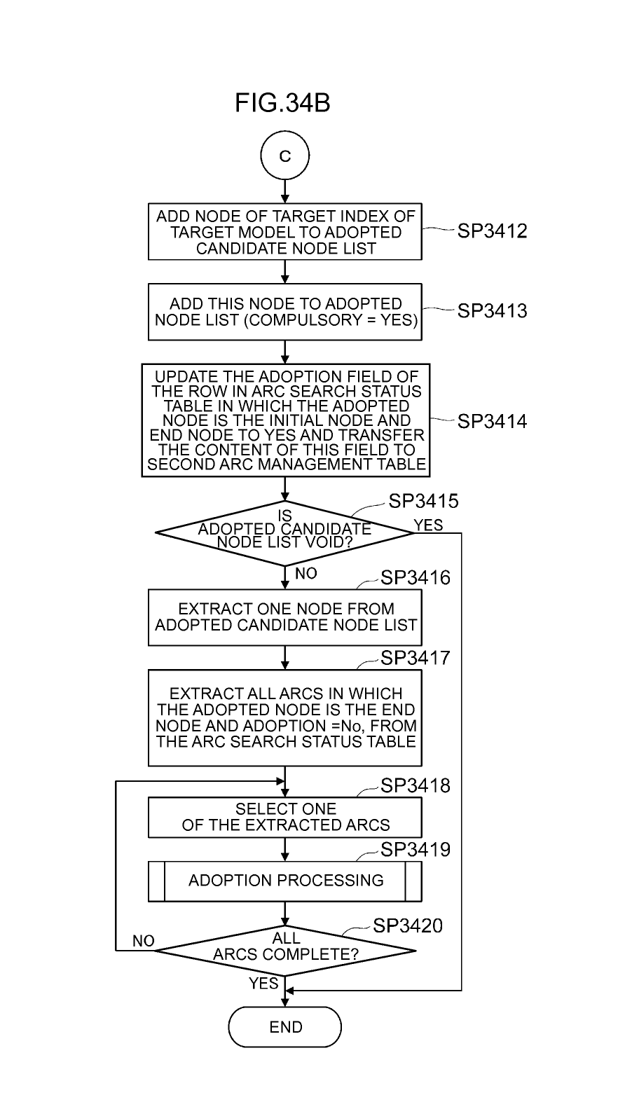

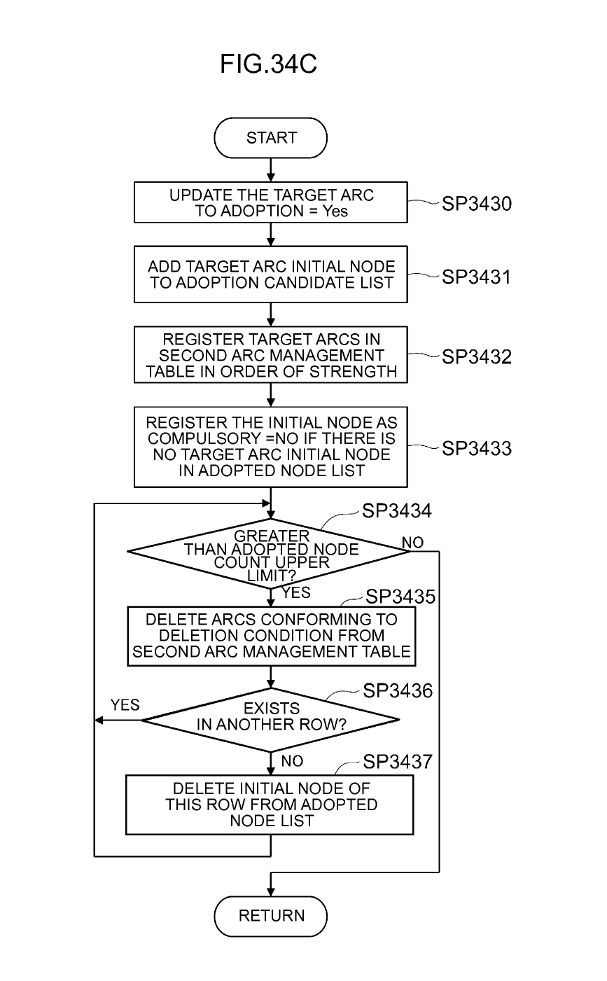

The model generation unit 703 subsequently executes structural learning by taking the measurement values which have undergone cleansing processing as learning data and thus creates a Bayesian network (SP1206). Further, the model generation unit 703 executes Bayesian network reduction processing to remove a portion of the basic indices from the Bayesian network thus created (SP1207) and then executes parameter learning in which the measurement values are taken as learning data for the reduced Bayesian network (hereinafter called a ‘reduced Bayesian network’) (SP1208). The Bayesian network reduction processing will be described subsequently with reference to FIGS. 33 and 34 (FIGS. 33 and 34).

Note that Hill-climbing is used as an algorithm for structural learning and a suitable algorithm and method can be used as the algorithm and score calculation method during structural learning, i.e. the Bayesian Information Criterion or the like can be used for the score calculation. Bayesian estimation is used as the algorithm for parameter learning.

The model generation unit 703 subsequently stores the structural data of the Bayesian network prior to reduction which was obtained in step SP1206 in a corresponding structure field 413B (FIG. 13A) in the model repository 413, stores the structural data of the post-reduction Bayesian network (reduced Bayesian network) in a corresponding reduced structure field 413C (FIG. 13A) in the model repository 413 and stores the learnt parameters in the corresponding parameter field 413D (FIG. 12A) in the model repository 413 (SP1209). Further, the model generation unit 703 then ends the remodeling processing.

Meanwhile, when a fitting processing execution instruction is supplied from the task control unit 708, the model generation unit 703 starts the fitting processing shown in FIG. 12B and first processes the processing of steps SP1211 to SP1215 in the same way as steps SP1201 to SP1205 of the remodeling processing described hereinabove with reference to FIG. 12A.

The model generation unit 703 subsequently issues a request to the model storage unit 704 (FIG. 6) to transfer the structural data of the reduced structure of the model already generated for the monitoring target system 311 then serving as the target. The model storage unit 704 supplied with this request acquires the structural data of the corresponding model (reduced Bayesian network) which is stored in the corresponding reduced structure field 413C in the model repository 413 (FIG. 13A), and hands over the acquired structural data to the model generation unit 703. The model generation unit 703 thus acquires the structural data of the reduced Bayesian network for this model (SP1216).

The model generation unit 703 subsequently takes the measurement values which have undergone cleansing processing as learning data and performs parameter learning (SP1217). Further, the model generation unit 703 passes the reduced structural data of the model (Bayesian network) thus updated to the model storage unit 704. The model storage unit 704 thus stores the structural data of the updated model (reduced Bayesian network structural data) in the model repository 413 (SP1218). Further, the model generation unit 703 then ends the fitting processing.

(3-1-5-2) Inference Processing

Inference processing, which is for inferring the probability of a target-index and non-target index prediction event being generated and which is executed by the predictor program 201 under the control of the task execution control thread of the task control unit 708 in the predictor program 201 (FIG. 6) in step SP1013 of FIG. 10B will be described next. Here, the configuration of the model repository 413 (FIG. 6), time-series prediction method repository 414 (FIG. 6), grouping repository 417 (FIG. 6) and learning target period repository 415 (FIG. 6) will be described first.

(3-1-5-2-1) Configuration of Each Repository

FIGS. 13A to 13D show configuration examples of the model repository 413, time-series prediction method repository 414, learning target period repository 415 and grouping repository 417 respectively.

The model repository 413 is a repository for managing the models which are generated as a result of the predictor program 201 (FIG. 6) performing remodeling processing and stores limits for when the predictor program 201 performs remodeling processing, that is, an upper limit on the number of nodes contained in the reduced Bayesian network, the names of compulsory nodes which must be contained in the reduced structure, an upper limit on the number of compulsory nodes, and an upper limit on the time period count which is a learning target in generating a required model.

Furthermore, as mentioned earlier, a model is configured from a structure generated by structural learning (Bayesian network), a reduced structure generated by reduction processing (reduced Bayesian network) and a parameter group generated by parameter learning. Hence, the model repository 413 also stores structures and reduced structures which are generated by this learning processing and Bayesian network reduction processing, and parameters for the conditional probability table or conditional probability density function which are generated by parameter learning.

However, sometimes these structures and parameters exist in the memory in a form that is not suited to direct storage in the table. In this case, pointers to the structures and parameters may also be stored in the table. In the present embodiment, a table format has been adopted as the data structure of the model repository 413 for the sake of facilitating the description but another data structure may also be adopted such as an object database or graph database as the data structure of the model repository 413. In addition, functions for a content repository and structural management tool, and the like, which are provided separately, may be used and simply stored in a file system. The configuration is desirably such that model structures can be acquired independently of the parameters irrespective of the form these structures take.

Here, more specifically, the model repository 413 of the present embodiment has a table structure comprising, as shown in FIG. 13A, a model field 413A, a structure field 413B, a reduced structure field 413C, a parameter field 413D, a time period count upper limit field 413E, a node count upper limit field 413F, a compulsory operation node field 413G, a non-compulsory operation node field 413H, a non-operation node field 413I and a compulsory operation node count upper limit field 413J.

Further, the model ID field 413A stores the IDs (system IDs) which are assigned to the models generated by the remodeling processing respectively. In addition, the structure field 413B, reduced structure field 413C and parameter field 413D store the foregoing Bayesian network structural data, reduced Bayesian network structural data and parameter groups respectively.

In addition, the time period count upper limit field 413E stores an upper limit for the number of time periods to serve as learning targets when generating the corresponding model, and the node count upper limit field 413F stores an upper limit for the number of nodes in this model. The time period count upper limit and node count upper limit are each configured by the system administrator of the monitoring service provider system 302 according to the available computer resources of the predictor server 113.

The compulsory operation node field 413G stores all the node names of the nodes (hereinafter suitably called ‘compulsory operation nodes’) to serve as a monitored item ‘required’ for usage in the inference processing of the predictor program 201 among the monitored items related to system operations or task operations. Initially, the compulsory operation nodes are minimized and may be added at a later time (the method will be described subsequently). Further, the non-compulsory operation node field 413H stores all the node names of the nodes which are to serve as monitored items (hereinafter suitably called ‘non-compulsory operation nodes’) related to system operations or task operations which are not compulsory operation nodes.

In addition, the compulsory operation node count upper limit field 413J stores an upper limit value for the number of compulsory operation nodes. This upper limit value is preconfigured by the system administrator of the monitoring service provider system 302 according to the computer resources of the available predictor server 113 and the complexity of the monitoring target system 311 (for example, the number of monitored items related to system operations or task operations and the number of task servers 110 included in the monitoring target system 311). The non-operation node field 413I stores a list of each of the nodes for which each of the measurement values described with reference to FIG. 6B and the column names in the performance index combination table 404 serve as node names.

The time-series prediction method repository 414 is a repository which is used to manage the time-series prediction models used by the time-series prediction unit 705 (FIG. 6) in time-series prediction processing which will be described subsequently (FIG. 14B or FIGS. 43 and 44) and, as shown in FIG. 13B, possesses a table structure comprising an ID field 414A, an algorithm field 414B, and a past data period field 414C, and the like.

Further, the ID field 414A stores IDs which are unique to the time-series prediction models and which are assigned to the corresponding time-series prediction models and the algorithm field 414B stores algorithms which are used in the construction of the corresponding time-series prediction models. Additionally, the past data period field 414C stores a temporal range for past data which is used in the time-series prediction processing. Note that the time-series prediction method repository 414 can also store parameters which are required for the construction of time-series prediction models.

The learning target period repository 415 is a repository which is used to manage learning target periods for each model and, as shown in FIG. 13C, is configured comprising a pointer management table 1330 and a plurality of internal tables 1331 which are provided in association with each of these models.

The pointer management table 1330 is configured from a model ID field 1330A, a pointer field 1330B and a learning target period count field 1330C. Further, the model ID field 1330A stores the model IDs of each of the models and the pointer field 1330B stores pointers to the internal table 1331 of the corresponding model. The learning target period count field 1330C stores the number of learning target periods until present of the corresponding model.

In addition, the internal table 1331 is a table which is used to store an indication of whether the date and period which are stored in the date field 1331A and time period field 1331B respectively, described subsequently, are learning targets, and is configured from a date field 1331A, a time period field 1331B, a plurality of operation results fields 1331C and a learning target period yes/no field 1331D.

Further, the date field 1331A stores dates and the time period field 1331B stores identifiers indicating the corresponding time period among the days of the corresponding dates. Note that, ‘time periods’ refers to individual time zones obtained by dividing a single day into a plurality of time zones. As will be described subsequently with reference to FIG. 13D, according to the present embodiment, a single day is divided into three time periods (time zones), namely, ‘00:00 until 08:00,’ ‘08:00 until 18:00,’ and ‘18:00 until 24:00’ and the identifiers (group names) ‘TM1,’ ‘TM2’ and ‘TM3’ are assigned to these time periods respectively.

Further, the operation results fields 1331C each store corresponding operation results among the task operation results and system operation results pertaining to the monitoring target system 311 for which the corresponding model is the target. For example, in the case of FIG. 13C, operation results fields 1331C which are associated with each of the task operation results ‘service A operation day,’ ‘service B operation day,’ ‘store business day,’ ‘service B sales target’ and ‘service B sales results’ are provided and ‘1’ is stored when operation results exist and ‘0’ is stored when no operation results exist, in the operation results fields 1331C associated with ‘service A operation day,’ ‘service B operation day’ and ‘store business day’ respectively, and the operation results fields 1331C associated with ‘service B sales target’ and ‘service B sales results’ store the sales target and sales results for service B on the corresponding date and in the corresponding time period respectively.

Furthermore, in the case of FIG. 13C, operation results fields 1331C which are associated with system operation results, namely, ‘service A web layer multiplicity,’ ‘service B web layer multiplicity,’ ‘service A application layer multiplicity,’ service B application layer multiplicity,’ ‘service A database layer multiplicity’ and ‘service B database layer multiplicity,’ are provided, and these operation results fields 1331C store the number of task servers 110 which execute the processing of the corresponding layers (web layer, application layer and database layer) of the corresponding services (service A or service B) (see FIG. 3).

Furthermore, the learning target period yes/no field 1331D stores information indicating whether or not the corresponding time period on the corresponding date is a learning target period for the corresponding model. More specifically, ‘Y’ is stored when the corresponding time period on the corresponding date is a learning target period for the corresponding model and ‘N’ is stored when the corresponding time period on the corresponding date is not a learning target period for the corresponding model.

The grouping repository 417 is a repository which is used to manage definitions for each of the groups created for each of the groupable items in the processing corresponding to individual models (models defined in the model repository 413). Groupable columns in the present embodiment include columns of the monitored items (403 and 404), the operation plan repository 1614, the operation results repository 1615, the sales prediction and results repository 1612, and the business day calendar repository 1613. If the column values of groupable column names fall within the range designated in the value range column, the values in this column are judged to be the group names designated in the group name column. One or more column names can be held for the groupable column names. Further, a wild card (*) which matches an optional character string of one or more characters can be used.

(3-1-5-2-2) Processing Routine for Inference Processing

FIGS. 14A to 14C show specific processing routines for inference processing which is executed by the predictor program 201 under the control of the task execution control thread of the task control unit 708 in the predictor program 201 (FIG. 6) in step SP1013 of FIG. 10B.

According to the present embodiment, the foregoing models are expressed by a Bayesian network-based probability model, as described hereinabove. With a Bayesian network, it is possible to seek the probability (conditional probability) that another node value (measurement value) will lie within a prescribed value range in a case where some of the node values (measurement values) are already defined. Such processing is called ‘probability inference.’

Each node constituting the Bayesian network according to the present embodiment is a measurement value collected from a task server 110 or the like which the monitoring target system 311 comprises, a performance index of a distributed application, and the operation plan value and results value of a task and system. Accordingly, if a certain measurement value, performance index or task and system operation plan value is obtained, it is possible to use probability inference to seek the probability of another measurement value or performance index having a certain value.

When this feature is applied to inference processing for inferring the probability of a target index and non-target index prediction event being generated, this is combined with time-series prediction according to the present embodiment. Generally, time-series prediction is a technique for constructing a model from data which is obtained by observing temporal changes in a certain variable (time-series data) and predicting future values of the variable based on this model.

As a model construction method which is applied to such technology, linear regression or the average value of past identical times within the day, or the like, can be used, for example. Past identical times within the day is intended to mean a plurality of times which do not share the same date but whose 24-hour clock times match, such as ‘2012-12-30 T12:00:00’ and ‘2012-12-31 T12:00:00.’

Inference processing according to the present embodiment is, in summary, processing in which future values of a portion of the measurement values (such measurement values are called ‘reference indices’) are first found by acquiring operation plan values or by time-series prediction and then Bayesian network-based probability inference is performed with these values as inputs.

FIG. 14A shows an example of a processing routine for inference processing according to the present embodiment. This inference processing is executed by the inference unit 706 (FIG. 6) except for part of the processing. This inference processing is started in response to the task control unit 708 (FIG. 6) receiving an execution message from the scheduler 416 (FIG. 6) to the effect that the inference processing is to be executed and the task control unit 708 activating the inference unit 706 according to this execution message.

First, upon starting this inference processing, the inference unit 706 first acquires the names of the reference indices stored in the prediction profile table 411 (FIG. 8) from the data storage unit 702 (FIG. 6) (SP1401) and selects one reference index from among the reference indices whose names were acquired (SP1402).

The inference unit 706 then refers to the reference index and prediction method combination field 411E (FIG. 8) in the prediction profile table 411 and judges whether or not an ‘operation plan value’ has been configured as the prediction method for the reference index selected in step SP1402 (SP1403).

If an affirmative result is obtained in the judgment of step SP1403, the inference unit 706 then acquires an operation plan by way of the lead time (SP1404). If, on the other hand, a negative result is obtained in the judgment of step SP1403, the inference unit 706 asks the time-series prediction unit 705 (FIG. 6) to execute time-series prediction processing (SP1405).

The inference unit 706 subsequently judges whether or not execution of the processing of step SP1402 to SP1405 is complete for all the reference indices whose names were acquired in step SP1401 (SP1406). Further, if a negative result is obtained in this judgment, the inference unit 706 returns to step SP1402 and then repeats the processing of steps SP1402 to SP1406 while sequentially switching the reference index selected in step SP1402 to another unprocessed reference index.

Further, if an affirmative result is obtained in step SP1406 as a result of already completing execution of the processing of steps SP1402 to SP1405 for all the reference indices whose names were acquired in step SP1401, the inference unit 706 takes the respective values of each of the reference indices obtained by means of the above processing as prediction values and performs probability inference according to these prediction values and the models, target indices and prediction events which are stored in the prediction profile table 411 (SP1407).

Further, the inference unit 706 outputs the probability obtained by means of this probability inference to the output unit 707 (SP1408) and then ends the inference processing.

FIG. 14B shows a processing routine for time-series prediction processing which is executed by the time-series prediction unit 705 which receives the request from the inference unit 706 in step SP1405 of this predictor detection processing.

When a request to execute time-series prediction processing is supplied from the inference unit 706, the time-series prediction unit 705 starts the processing in FIG. 14B and first acquires the prediction profile IDs which are recorded in the prediction profile table 411 and acquires the corresponding algorithm and the parameters required for time-series prediction processing from the time-series prediction method repository 414 (FIG. 13B) according to the acquired prediction profile ID (SP1411).

The time-series prediction unit 705 subsequently acquires past data periods from the time-series prediction method repository 414 (SP1412) and acquires the measurement values of the reference indices for the acquired past data periods from the data storage unit 702 (SP1413). In addition, the time-series prediction unit 705 acquires the lead time from the prediction profile table 411 (SP1414). The lead time is a value indicating how many seconds the prediction value obtained in time-series prediction processing is since the last time point of past data.

The time-series prediction unit 705 then executes the time-series prediction processing by using the time-series prediction algorithm, parameters, measurement values and lead time which were obtained in the processing of steps SP1411 to SP1414 above (SP1415). For example, in a case where time-series prediction is performed by taking the lead time to be ‘one hour at ‘10:00’ and the algorithm to be ‘an average value model of past identical times,’ the average value of the measurement values at ‘11:00’ on past dates is then calculated.

Further, the time-series prediction unit 705 stores the prediction values obtained as a result of this processing in the memory 102 (FIG. 1) (SP1416) and then ends the time-series prediction processing.

Furthermore, FIG. 14C shows a specific processing routine for probability inference processing which is executed by the inference unit 706 in step SP1407 of the inference processing described hereinabove with reference to FIG. 14A.

Upon advancing to step SP1407 of the inference processing, the inference unit 706 starts the probability inference processing shown in FIG. 14C and first acquires the prediction values stored in the memory 102 as described hereinabove (SP1421). The inference unit 706 subsequently acquires the model ID recorded in the prediction profile table 411 and acquires the model from the model repository 413 (FIG. 13A) according to the acquired model ID (SP1422).

The inference unit 706 then acquires the target indices and the prediction events respectively from the prediction profile table 411 (SP1423 and SP1424). Target indices and non-target indices correspond, in Bayesian network probability inference, to nodes serving as the targets for seeking probability, and a prediction event is information, when seeking probability, which describes a condition for the target index assuming a particular value or having a value in a particular range; typically, the condition is that the value should exceed a value which is a threshold value. For example, if the target index is the average response time of a distributed application, an event where the target index exceeds 3 seconds is expressed by a prediction event ‘T>3 sec.’

The inference unit 706 subsequently executes probability inference which employs prediction values, models, target indices and prediction events, which are obtained by the processing of the above steps SP1421 to SP1424 (SP1425). The inference unit 706 then ends the probability inference processing when this probability inference is complete.

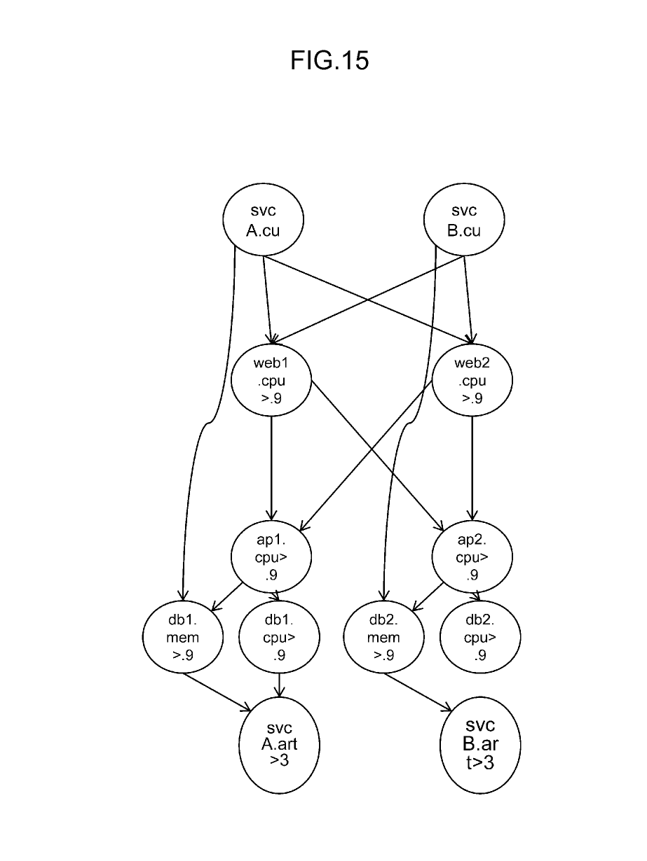

FIG. 15 shows a configuration example of a model (Bayesian network) which is obtained as a result of learning system performance information on the monitoring target system 311 shown in FIG. 3 and monitored items only of service inputs and performance and, more specifically, processor usage (‘*.cpu,’ where ‘*’ is the server name) and memory usage (‘*.mem’), the number of simultaneous connections to a service (‘svcA.cu,’ ‘svcB.cu’) and the service average response time (‘svcB.art,’ ‘svcB.art’). It can be seen from FIG. 15 that ‘svcA.cu’ has a causal relationship with ‘web1.cpu>0.9’ and ‘web2.cpu>0.9,’ that the nodes having a causal relationship with ‘ap1.cpu>0.9’ (the arc initial node) are ‘web1.cpu>0.9’ and ‘web2.cpu>0.9,’ and that the nodes having a causal relationship with ‘svcA.art>3’ which is one of the target events are ‘db1.mem>0.9’ and ‘db1.cpu>0.9.’

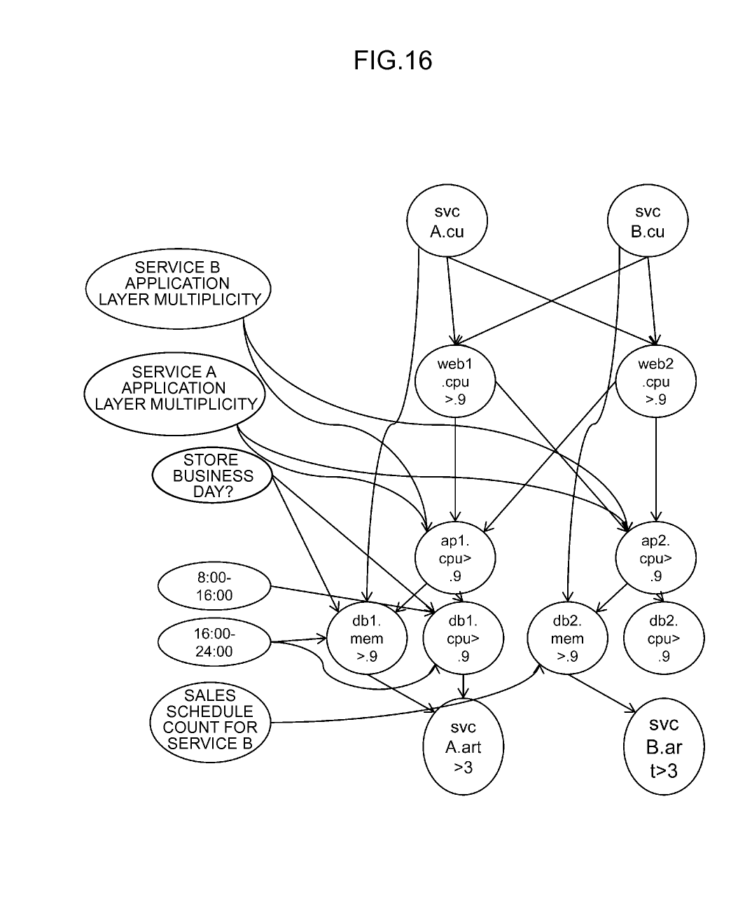

FIG. 16 shows a configuration example of a Bayesian network which is created in a case where, in addition to the foregoing monitored items, task operation plans, such as the multiplicity of each task layer for each service due to the system operation plans and results such as plan stoppages and the like (an application layer has been added in FIG. 16), whether or not a day is a store business day, the sales schedule count for service B, and which time zone (this is given by a time stamp group name which can be defined by the grouping repository 417 (FIG. 13D)) are added to the monitored items. It can be seen from FIG. 16 that, for example, a monitored item which is a time zone ‘08:00 to 16:00’ has a causal relationship with ‘db1.cpu>0.9’ and has an influence on ‘svcA.art>3,’ that the sales schedule count for service B has a causal relationship with ‘db2.mem>0.9,’ and that the probability propagates so as to have an influence on ‘svcB.art>3.’

If there is an increase in plan information (scheduled and planned information, that is, reference indices) such as the subsystem multiplicity and sales prediction amount or other system operation plans, and task operation plans, results which are predicted using a Bayesian network are more accurate. Meanwhile, the Bayesian network learning time increases exponentially as the number of nodes increases and therefore monitored items cannot be endlessly added to the Bayesian network (learning is not finished within a practical time, is aborted by the scheduler 416, and the learning interval is long). The content of the processing (Bayesian network reduction processing) for limiting the number of nodes in the Bayesian network to a fixed number will be described subsequently.

(3-1-5-3) Learning Period Adjustment Processing

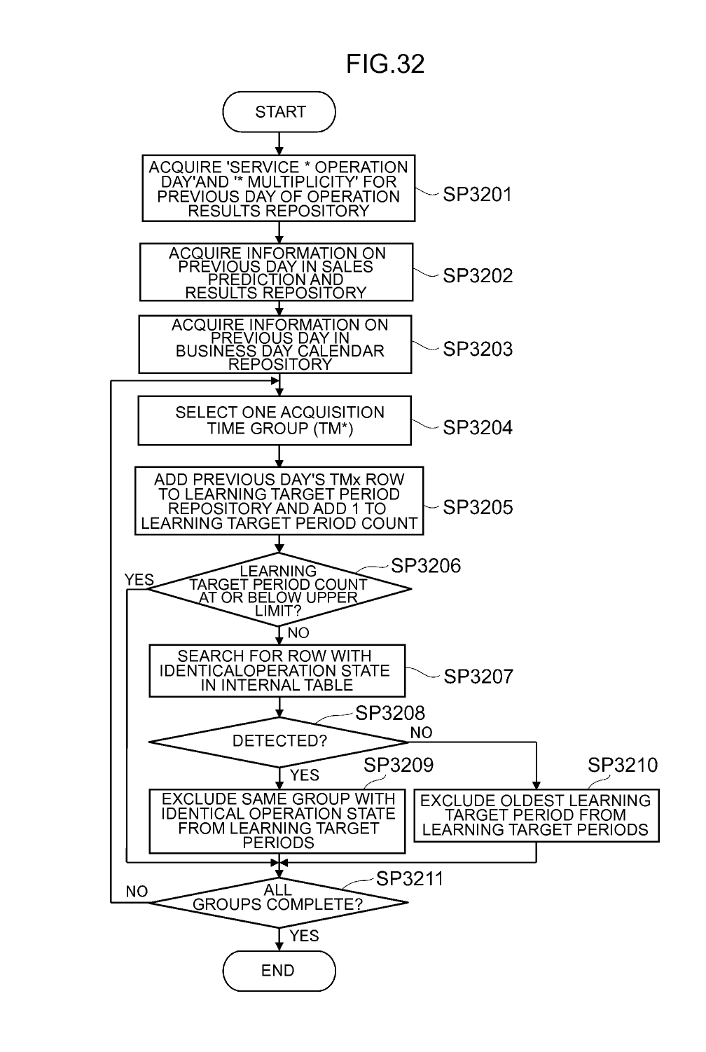

FIG. 32 shows a processing routine for learning period adjustment processing which is executed at regular intervals (at midnight every value, for example) by the learning period adjustment unit 709 (FIG. 6) of the predictor server 113. The learning period adjustment unit 709 adds the data of the previous day to the learning target period which is used in the remodeling processing by the model generation unit 703 (FIG. 6) while following the upper limit of the learning target period according to the processing routine shown in FIG. 32.

In reality, upon starting the learning period adjustment processing, the learning period adjustment unit 709 first acquires the values of the flags which are stored in each service operation day field 1615B and each task layer multiplicity field 1615D of the row corresponding to the previous day's date in the operation results repository 1615 (FIG. 18), from the monitoring device 111. The learning period adjustment unit 709 accordingly acquires the services provided by the monitoring target system 311 on the previous day and the multiplicity of the task server 110 in each task layer on the previous day in the monitoring target system 311 (SP3201).

The learning period adjustment unit 709 subsequently acquires the sales prediction and sales results on the previous day for each product or service (type name) which are stored in the sales prediction and results repository 1612 from the monitoring device 111 (SP3202). Further, the learning period adjustment unit 709 acquires the store business day information for the previous day which is stored in the business day calendar repository 1613 (FIG. 21) from the monitoring device 111 (SP3203).

Thereafter, the learning period adjustment unit 709 references the grouping repository 417 in FIG. 13D and selects one group from among the respective groups with the acquired times prescribed for the corresponding model (SP3204) and, as shown in FIG. 13D, in the case of models whose model IDs are ‘M2’, for example, the acquisition times are grouped into three groups ‘TM1,’ ‘TM2’ and ‘TM3,’ and hence the learning period adjustment unit 709 selects one group from among these three groups in step SP3204.

Thereafter, the learning period adjustment unit 709 newly registers the group selected in step SP3204 in the corresponding internal table 1331 of the learning target period repository 415 described hereinabove with reference to FIG. 13D. Here, the learning period adjustment unit 709 stores the corresponding information among the information which was acquired in steps SP3201 to SP3203 respectively in each operation results field 1331C of the row corresponding to this newly registered group and stores ‘Y’ in the learning target period yes/no field 1331D. Further, the learning period adjustment unit 709 increments by one the learning target period count which is stored in the learning target period count field 1330C of the corresponding row in the pointer management table 1330 (SP3205).

The learning period adjustment unit 709 subsequently acquires the time period count upper limit of the model then serving as the target from the model repository 413 (FIG. 13A) and judges whether or not the foregoing learning target period count which was incremented by one in step SP3205 is equal to or below the time period count upper limit (SP3206). If an affirmative result is obtained in this judgment, the learning period adjustment unit 709 advances to step SP3211.

If, on the other hand, a negative result is obtained in the judgment of step SP3206, the learning period adjustment unit 709 searches for a row in the same operation state as the group, among the corresponding rows starting with the oldest and working toward the previous day in the internal table 1331 in which the group selected in step SP3204 was newly registered (SP3207). More specifically, the learning period adjustment unit 709 searches, among the corresponding rows starting with the oldest and working toward the previous day in the internal table 1331, for the row in which the group ID of the group selected in step SP3204 is stored in the time period field 1331B and in which the respective values stored in each operation results field 1331C completely match the values stored in each of the operation results fields 1331C of the group newly registered in the internal table 1331 in step SP3205.

Thereafter, the learning period adjustment unit 709 judges whether or not it has been possible to search for such a row by means of the search of step SP3207 (SP3208), and if an affirmative result is obtained, the learning period adjustment unit 709 updates the value stored in the learning target period yes/no field 1331D of the row (the row detected in the search of step SP3207) to ‘N’ and reduces by one the learning target periods stored in the learning target period count field 1330C of the corresponding row in the pointer management table 1330 (FIG. 13C) (SP3209). The learning period adjustment unit 709 then advances to step SP3211.

If, on the other hand, a negative result is obtained in the judgment of step SP3209, the learning period adjustment unit 709 updates the value which is stored in the learning target period yes/no field 1331D of the row with the oldest date in the internal table 1331 in which the group selected in step SP3204 was newly registered to ‘N’ and reduces by one the learning target period stored in the learning target period count field 1330C of the corresponding row in the pointer management table 1330 (SP3210). The learning period adjustment unit 709 subsequently advances to step SP3211.

Thereafter, the learning period adjustment unit 709 judges whether or not execution of the processing of steps SP3204 to SP3210 is complete for all the groups with the acquisition times specified for the corresponding models in the grouping repository 417 (FIG. 13D) (SP3211).

Further, if a negative result is obtained in this judgment, the learning period adjustment unit 709 returns to step SP3204 and subsequently repeats the processing of steps SP3204 to SP3211 while sequentially switching the group selected in step SP3204 to another unprocessed group.

Furthermore, if an affirmative result is obtained in step SP3211 as a result of already completing execution of the processing of steps SP3204 to SP3210 for all the groups of acquisition times specified for the corresponding model, the learning period adjustment unit 709 ends the learning period adjustment processing.

(3-1-5-4) Bayesian Network Reduction Processing

FIG. 33 shows a data structure 3300 of various data which is used in Bayesian network reduction processing. This data structure 3300 comprises a first arc management table 3301, an arc search status table 3302, a search candidate node list 3303, adopted node count upper limit information 3304, a second arc management table 3305 and an adopted node list 3306.

The first arc management table 3301 has a table structure comprising an initial node field 3301A, an end node field 3301B and a strength field 3301C, wherein the initial node field 3301A stores the node names of the respective initial nodes in the Bayesian network and the end node field 3301B stores the node names of the end nodes for the corresponding initial nodes. Further, the strength field 3301C stores the strengths of the arcs connecting the corresponding initial nodes and end nodes.

Further, the arc search status table 3302 possesses a table structure comprising an initial node field 3302A, an end node field 3302B, a strength field 3302C and an adoption field 3302D and has a table structure obtained by adding the adoption field 3302D to the first arc management table 3301. The adoption field 3302D stores ‘No’ as the initial value.

The adoption candidate node list 3303 is a list of unadopted nodes among the nodes adjacent to an adopted node. The values stored in the adoption candidate node list 3303 change dynamically during Bayesian network reduction processing. The initial value is zero.

The adopted node count upper limit information 3304 indicates an upper limit value for the number of nodes that may be included in a reduced Bayesian network created as a result of Bayesian network reduction processing. This adopted node count upper limit information 3304 is acquired from the corresponding node count upper limit field 413F (FIG. 13A) in the model repository 413 (FIG. 13A).

The second arc management table 3305 shows the arcs in the Bayesian network, as well as their respective strengths, while reduction calculation is in progress and as a result of a reduction calculation in the Bayesian network reduction processing. The reduction calculation is performed such that the maximum number of nodes present in this data structure is indicated by the adopted node count upper limit information 3304.

The adopted node list 3306 is a list for managing nodes which are adopted nodes and have not been canceled, and is configured from a node field 3306A and a compulsory field 3306B. Further, the node field 3306A stores node names of the nodes which have not been canceled since adoption and the compulsory field 3306B stores information indicating whether the corresponding node is a compulsory adopted node as described hereinabove with reference to FIG. 13A (‘Yes’ if compulsory and ‘No’ if not compulsory).

The data structure 3300 which is used in the Bayesian network reduction processing is user data which is used by the model generation unit 703 of the predictor program 201 installed on the predictor server 113.

FIGS. 34A to 34C show a processing routine for Bayesian network reduction processing which is executed by the model generation unit 703 in step SP1207 of FIG. 12A. The model generation unit 703 creates a Bayesian network with a reduced number of nodes (a reduced Bayesian network) for the Bayesian network designated by the model ID according to the processing routine shown in FIGS. 34A to 34C.

In reality, upon advancing to step SP1207 of the remodeling processing in FIG. 12A, the model generation unit 703 starts the Bayesian network reduction processing shown in FIGS. 34A to 34C and first acquires the target model ID as a calling argument (SP3401).

The model generation unit 703 subsequently acquires the graph structure of the corresponding Bayesian network which is stored in the structure field 413B (FIG. 13A) of the row for which the model ID of the target model is stored in the model ID field 413A (FIG. 13A) from the model repository 413 (FIG. 13A) (SP3402).

Thereafter, the model generation unit 703 registers combinations of all the initial nodes and end nodes in the graph structure acquired in step SP3402 in the first arc management table 3301 (FIG. 33) (SP3403). More specifically, for the combinations of each initial node and end node, the model generation unit 703 stores the node names of the initial nodes in the initial node field 3301A of the first arc management table 3301 and stores the node names of the end nodes in the end node field 3301B in the same row as the initial node field 3301A of the first arc management table 3301.

Thereafter, for each row in the first arc management table 3301, the model generation unit 703 calculates the respective strengths of the arcs connecting the corresponding initial nodes and end nodes and stores the calculated arc strengths in the strength fields 3301C of the same row (SP3404). These strengths are the gain and loss of the model score in a case where an arc is deleted.

The model generation unit 703 subsequently voids the arc search status table 3302, adoption candidate node list 3303 and adopted node list 3306 respectively (SP3405 to SP3407). Further, the model generation unit 703 configures the values stored in the node count upper limit field 413F (FIG. 13A) of the row for which the model ID acquired in step SP3401 was stored in the model ID field 413A (FIG. 13A) among each of the rows of the model repository 413 (FIG. 13A), as the adopted node count upper limit information 3304 (SP3408), and then voids the second arc management table 3305 (SP3409).

Initialization of the data structure 3300 which is used in the Bayesian network reduction processing is completed by the foregoing processing.

The model generation unit 703 subsequently acquires the node names of all the compulsory operation nodes stored in the compulsory operation node field 413G (FIG. 13A) of the corresponding row (the row for which the model ID of the target model was stored in the model ID field 413A) in the model repository 413 (FIG. 13A) (SP3410). Further, the model generation unit 703 stores the node names of each of the acquired compulsory operation nodes in the node fields 3306A of the adopted node list 3306 and stores ‘Yes’ in the respective compulsory fields 3306B of the same row (SP3411).

The model generation unit 703 subsequently registers the node of the target index of the target model in the adoption candidate node list 3303 (SP3412). More specifically, the model generation unit 703 looks up the prediction profile table 411 (FIG. 8) using the model ID of the target model and adds the node name stored in the target index field 411G (FIG. 8) of the corresponding row in the adoption candidate node list 3303.

The model generation unit 703 then stores the node name of the node of this target index in the node field 3306A of the adopted node list 3306 and stores ‘Yes’ in the compulsory field 3306B of the same row (SP3413).

In addition, the model generation unit 703 updates the respective values of the adoption fields 3302D in each row in which the nodes registered in the adopted node list 3306 are an initial node and an end node to ‘Yes’ in the arc search status table 3302 and transfers the content of these rows to the second arc management table 3305 (SP3414).

Thereafter, the model generation unit 703 judges whether or not the adoption candidate node list 3303 is void (SP3415). If an affirmative result is obtained in this judgment, the model generation unit 703 ends the Bayesian network reduction processing.

If, on the other hand, a negative result is obtained in the judgment of step SP3415, the model generation unit 703 extracts one node from among the nodes registered in the adoption candidate node list 3303 (SP3416). The model generation unit 703 also extracts all the arcs for which the nodes extracted in step SP3416 are end nodes and for which ‘No’ was registered in the adoption field 3302D, from the arcs registered in the arc search status table 3302. Thereupon, the model generation unit 703 deletes the nodes extracted from the adoption candidate node list 3303 in step SP3416 from the adoption candidate node list (SP3417).

The model generation unit 703 subsequently selects one arc from among the arcs extracted from the arc search status table 3302 in step SP3417 (SP3418) and executes adoption processing to adopt the selected arc as a node of the reduced Bayesian network while observing the node count upper limit prescribed for the target model (SP3419).

The model generation unit 703 subsequently judges whether or not execution of the adoption processing of step SP3419 is complete for all the arcs extracted in step SP3417 (SP3402). If a negative result is obtained in this judgment, the model generation unit 703 returns to step SP3418 and then repeats the processing of steps SP3418 to SP3420 while sequentially switching the arc selected in step SP3418 to another unprocessed arc.

If an affirmative result is obtained in step SP3420 as a result of already completing execution of the adoption processing of step SP3419 for all the arcs extracted in step SP3417, the model generation unit 703 then ends the Bayesian network reduction processing.

Note that specific processing content of the adoption processing which is executed in step SP3419 of the Bayesian network reduction processing is shown in FIG. 34C.

Upon advancing to step SP3419 of the Bayesian network reduction processing, the model generation unit 703 starts the adoption processing and first updates the value in the adoption field 3302D in the row corresponding to the arc then serving as the target in the arc search status table 3302 (the arc selected in step SP3418 of the Bayesian network reduction processing) to ‘Yes’ (SP3430).

The model generation unit 703 subsequently adds and registers the initial node stored in the initial node field 3302A of the row corresponding to the arc then serving as the target in the arc search status table 3302 to/in the adoption candidate node list 3303 (SP3431). The model generation unit 703 also registers the arc then serving as the target such that the arcs registered in the second arc management table 3305 are arranged in order of strength (SP3432).

The model generation unit 703 then judges whether the initial node of the arc then serving as the target has been registered in the adopted node list 3306, and registers the initial node in the adopted node list 3306 if same has not been registered. Here, the model generation unit 703 stores ‘No’ in the compulsory field 3306B corresponding to the initial node in the adopted node list 3306 (SP3433).

The model generation unit 703 then judges whether or not the number of nodes registered in the adopted node list 3306 is greater than the adopted node count upper limit configured in the adopted node count upper limit information 3304 (SP3434). If a negative result is obtained in this judgment, the model generation unit 703 then ends this adoption processing and returns to the Bayesian network reduction processing (FIGS. 34A and 34B).

If, on the other hand, an affirmative result is obtained in the judgment of step SP3434, the model generation unit 703 selects the arc which has the weakest strength among the arcs registered in the second arc management table 3305 and for which the value of the compulsory field 3306B of the end node in the adopted node list 3306 is ‘No,’ and deletes the row corresponding to this arc from the second arc management table 3305 (SP3435).

The model generation unit 703 subsequently judges whether or not the initial node of the arc corresponding to the row deleted in step SP3435 exists in another row of the second arc management table 3305 (SP3436). If a negative result is obtained in this judgment, the model generation unit 703 returns to step SP3434 and then executes the processing up to and including step SP3434 in the same way.

If, on the other hand, an affirmative result is obtained in the judgment of step SP3436, the model generation unit 703 deletes the initial node stored in the initial node field 3305A of this row from the adopted node list 3306 (SP3437) and then returns to step SP3434.

Further, if an affirmative result is already obtained in the judgment of step SP3434, the model generation unit 703 ends the adoption processing and returns to the Bayesian network reduction processing (FIGS. 34A and 34B).

(3-1-5-5) Reduced Bayesian Network Compulsory Operation Node Addition Processing

In the case of the present embodiment, compulsory operation nodes can also be subsequently added to the reduced Bayesian network. This function can be used, for example, in a case where there is the desire to add a perspective of a task operation plan (monitored item) where, in the past, a product or service has only been sold online but has now also been sold in a real store, or the like, or in a case where there is a need to add a perspective of a system operation plan (monitored item) by duplexing a task layer which has not been duplexed, and so forth.

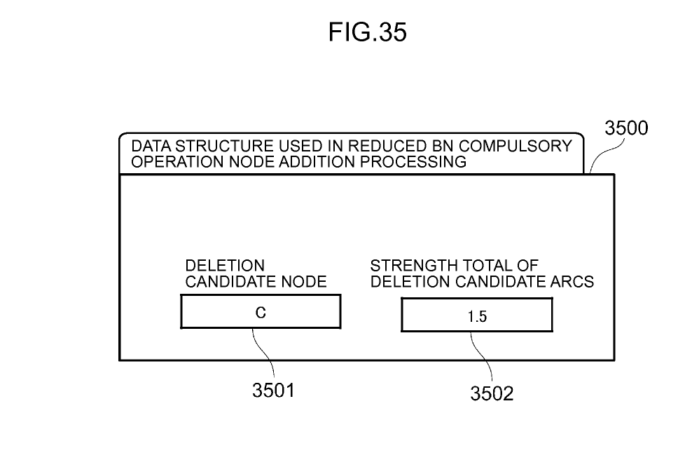

FIG. 35 shows a data structure 3500 of data which is used in such processing to add a compulsory operation node to a reduced Bayesian network (hereinafter called ‘reduced Bayesian network compulsory operation node addition processing’). This data structure 3500 comprises deletion candidate node information 3501 which indicates nodes which are candidates for deletion and deletion candidate arc strength total information 3502 which indicates the total of the deletion candidate arc strengths. This data structure is user data which is used by the model generation unit 703 (FIG. 6).

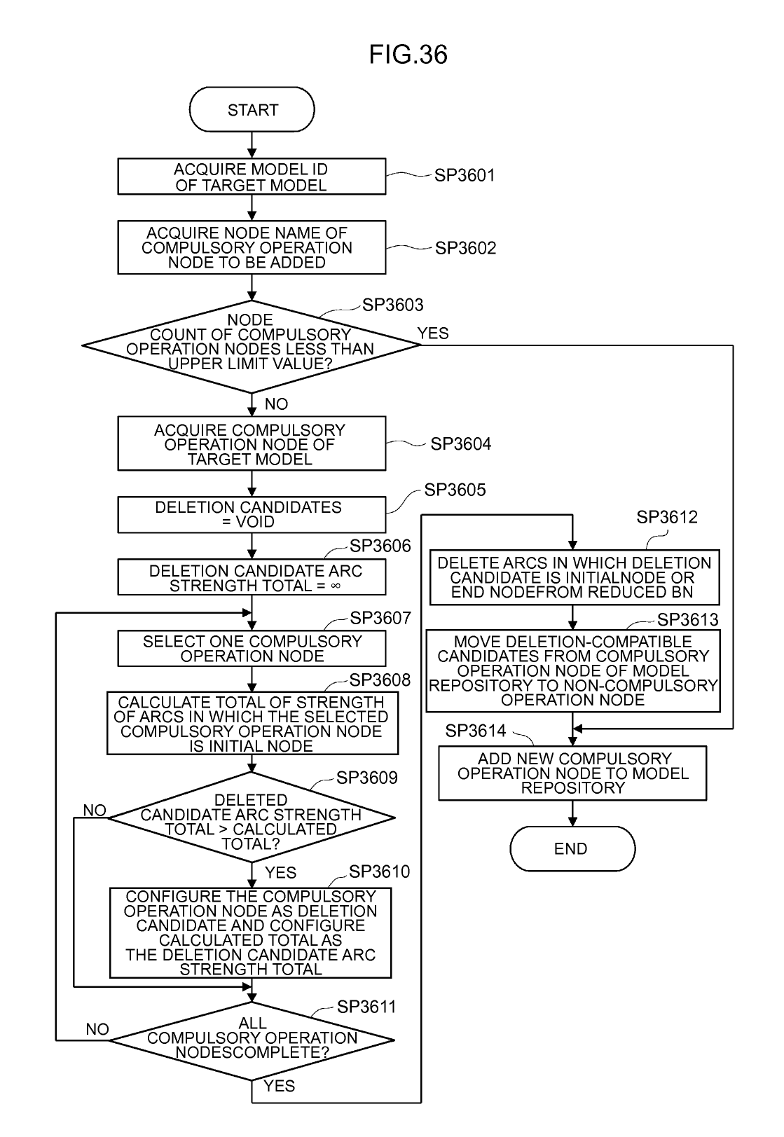

FIG. 36 shows a processing routine for reduced Bayesian network compulsory operation node addition processing which is executed by the model generation unit 703. The reduced Bayesian network compulsory operation node addition processing is executed in response to the predictor server 113 receiving a message ‘add compulsory operation node to model.’ Although not shown, this message can be supplied to the predictor server 113 as a result of the system administrator of the predictor server 113 inputting the message via the console 105 (FIG. 1). The message includes the model ID of the target model (may be a system name) and the node name of the compulsory operation node to be added.

Upon receiving this message, the model generation unit 703 starts the reduced Bayesian network compulsory operation node addition processing and acquires the model ID of the target model and the node name of the compulsory operation node to be added which are contained in the message (SP3601, SP3602).

The model generation unit 703 then acquires the compulsory operation node count upper limit value for the target model from the model repository 413 (FIG. 13A) and judges whether or not the number of nodes of the compulsory operation nodes when the compulsory operation node to be added has been added will be below the compulsory operation node count upper limit (SP3603).

If an affirmative result is obtained in this judgment, the model generation unit 703 advances to step SP3614. If, on the other hand, a negative result is obtained in the judgment of step SP3603, the model generation unit 703 acquires the compulsory operation nodes of the target model from the model repository 413 (FIG. 13A) (SP3604) and then resets (eliminates) the values of the deletion candidate node information 3501 described earlier with reference to FIG. 35 (SP3605) and configures the value of the deletion candidate arc strength total information 3502 as infinity (SP3606).

The model generation unit 703 then selects one compulsory operation node from among the compulsory operation nodes acquired in step SP3604 (SP3607), and calculates the total of the strengths of each of the arcs for which the selected compulsory operation node is the initial node (SP3608).

Further, the model generation unit 703 judges whether or not the strength total of each of the arcs calculated in step SP3608 is less than the strength total of the deletion candidate arcs configured as the deletion candidate arc strength total information 3502 (SP3609). Further, if a negative result is obtained in this judgment, the model generation unit 703 advances to step SP3611. If, on the other hand, an affirmative result is obtained in the judgment of step SP3609, the model generation unit 703 configures the compulsory operation node selected in step SP3607 as a deletion candidate node (configures the value of the deletion candidate node information 3501 as the compulsory operation node), and configures the total calculated in step SP3608 as the deletion target arc strength total information 3502 (SP3610).

The model generation unit 703 subsequently judges whether or not execution of the processing of steps SP3607 to SP3610 is complete for all the compulsory operation nodes acquired in step SP3604 (SP3611). Further, if a negative result is obtained in this judgment, the model generation unit 703 returns to step SP3607 and then repeats the processing of steps SP3607 to SP3611 while sequentially switching the compulsory operation node selected in step SP3607 to another unprocessed compulsory operation node.

If an affirmative result is obtained in step SP3611 as a result of already completing execution of the processing of steps SP3607 to SP3610 for all the compulsory operation nodes acquired in step SP3604, the model generation unit 703 updates the structure which is stored in the corresponding structure field 413B in the model repository 413 to delete the arcs, for which the compulsory operation node is then configured as the deletion candidate node (the value of the deletion candidate node information 3501) is the initial node or the end node, from the reduced Bayesian network (SP3612).

Thereafter, the model generation unit 703 moves the compulsory operation node configured as the deletion candidate node from the corresponding compulsory operation node field 413G (FIG. 13A) in the model repository 413 to the corresponding non-compulsory operation node field 413H (FIG. 13A) (SP3613), adds the newly added compulsory operation node to the corresponding compulsory operation node field 413G in the model repository 413 (SP3614) and then ends the reduced Bayesian network compulsory operation node addition processing.

Note that, in the foregoing reduced Bayesian network compulsory operation node addition processing, although the total of the strengths of each of the arcs for which the compulsory operation node is the initial node is calculated in step SP3608 and used to determine the deletion-candidate compulsory operation node, instead, the total of the strengths of each of the arcs for which the compulsory operation node is the end node may be calculated and used to determine the deletion-candidate compulsory operation node, for example, or the total of the strengths of the arcs for which the compulsory operation node is the initial node or the end node may be calculated and used to determine the deletion-candidate compulsory operation node.

It should be noted that a recalculation of parameters is not performed in this reduced Bayesian network compulsory operation node addition processing, rather, the parameters are relearned in fitting processing.

(3-1-5-6) Second Time-Series Prediction Processing

As a method for calculating the average value of measurement values at past identical times (hereinafter referred to as the ‘past identical time average value method’), which represents one time-series prediction method, a method of finding the average value of measurement values at identical times on a number of most recent consecutive days was described. With this method, although no distinction is made of task operation plans in particular among the task operation plans and system operation plans, there are value groups for task system input amounts which differ according to the task operation plan (in the present embodiment, the task operation plans are sales prediction count for service B and whether a day is a store business day).

In such a case, an average value calculation method which seeks the average value of the measurement values of past identical times only from days when there is a match between task plan and system plan patterns (that is, days seen as having an identical operation state) is effective. The patterns mentioned here refer to patterns which have been narrowed down using Bayesian network learning processing by including only those nodes contained in the reduced structure. By applying such a method of calculating the average value of past identical times, it is possible to perform more accurate time-series prediction of the reference indices.

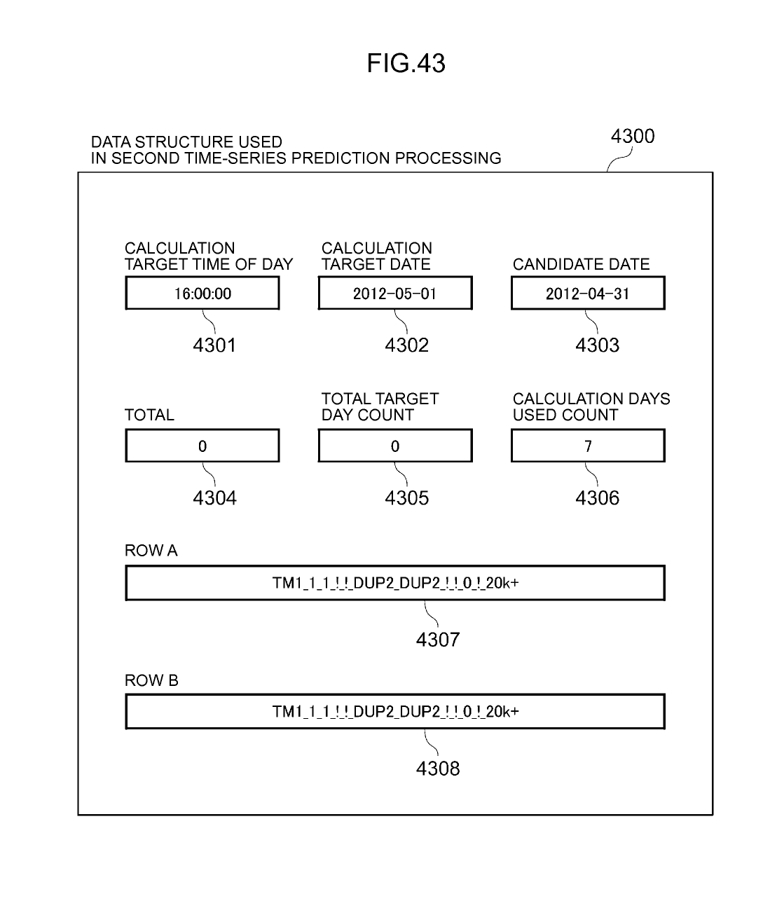

FIG. 43 shows a data structure 4300 of various data which is used in time-series prediction processing (hereinafter called ‘second time-series prediction processing’) which utilizes such a past identical time average value calculation method. This data structure 4300 comprises calculation target time of day information 4301, calculation target date information 4302, candidate date information 4303, total information 4304, total target day count information 4305, calculation days used count information 4306, row A information 4307 and row B information 4308.

The calculation target time of day information 4301 is information indicating the foregoing past identical time (hereinafter called ‘calculation target time of day’) and the calculation target date information 4302 is information indicating the date when the target event is to be predicted (hereinafter called ‘calculation target date’). The calculation target time of day information 4301 and calculation target date information 4302 are designated by the task control unit 708 (FIG. 6). Further, the candidate date information 4303 is information indicating the date then serving as the target (hereinafter called the ‘candidate date’) when the past identical time average value calculation is performed working backwards one day at a time, as will be described subsequently, in the second time-series prediction processing.

In addition, the total information 4304 is information indicating the total of the measurement values up to that point when the past identical time average value calculation is performed working backwards one day at a time, and total target day count information 4305 is information indicating the total number of candidate dates up to that point (hereinafter called ‘total target day count’). Further, the calculation days used count 4306 is the past data period 414C of the prediction model repository 414.

In addition, the row A information 4307 is information which uses a group name to represent information which is stored in the time period field 1331B and each operation results field 1331C respectively of the row corresponding to the calculation target time of day on the calculation target date among each of the rows in the internal table 1331 (FIG. 13C) constituting the learning target period repository 415 (FIG. 13C) (that is, information on the task operation results and system operation results at the calculation target time of day on the calculation target date). In this row A information 4307, items which are not contained in the reduced Bayesian network are represented by T

Therefore, in the case of the example of FIG. 43, if we refer to FIGS. 13C and 13D, it can be seen that, in the case of the calculation target time of day on the calculation target date, ‘service A web layer multiplicity,’ ‘service B web layer multiplicity,’ ‘service A database layer multiplicity,’ ‘service B database layer multiplicity,’ and ‘service B sales target’ are items which are not contained in the reduced Bayesian network, that ‘service A’ and ‘service B’ are scheduled for operation, that the values of ‘service A application layer multiplicity’ and ‘service B application layer multiplicity’ are prediction to be 2 or more, that it is not a ‘store business day,’ and that ‘more than 20000’ sales are planned as the ‘service B sales results.’

Further, row B information 4308 is information which uses group names to represent information which is stored in the time period field 1331B and each operation results field 1331C respectively of the row corresponding to the calculation target time of day on the current candidate date among each of the rows in the internal table 1331 (FIG. 13C) constituting the learning target period repository 415. Like the row A information 4307, in the row B information 4308, items which are not contained in the reduced Bayesian network are represented by ‘!’

Hence, in the case of the example of FIG. 43, if we refer to FIGS. 13C and 13D, it can be seen that, in the case of the calculation target time of day on the candidate date, ‘service A web layer multiplicity,’ ‘service B web layer multiplicity,’ ‘service A database layer multiplicity,’ ‘service B database layer multiplicity,’ and ‘service B sales target’ are items which are not contained in the reduced Bayesian network, that ‘service A’ and ‘service B’ are being operated, that the values of ‘service A application layer multiplicity’ and ‘service B application layer multiplicity’ are prediction to be 2 or more, that it is not a ‘store business day,’ and that ‘more than 20000’ sales are planned as the ‘service B sales results.’

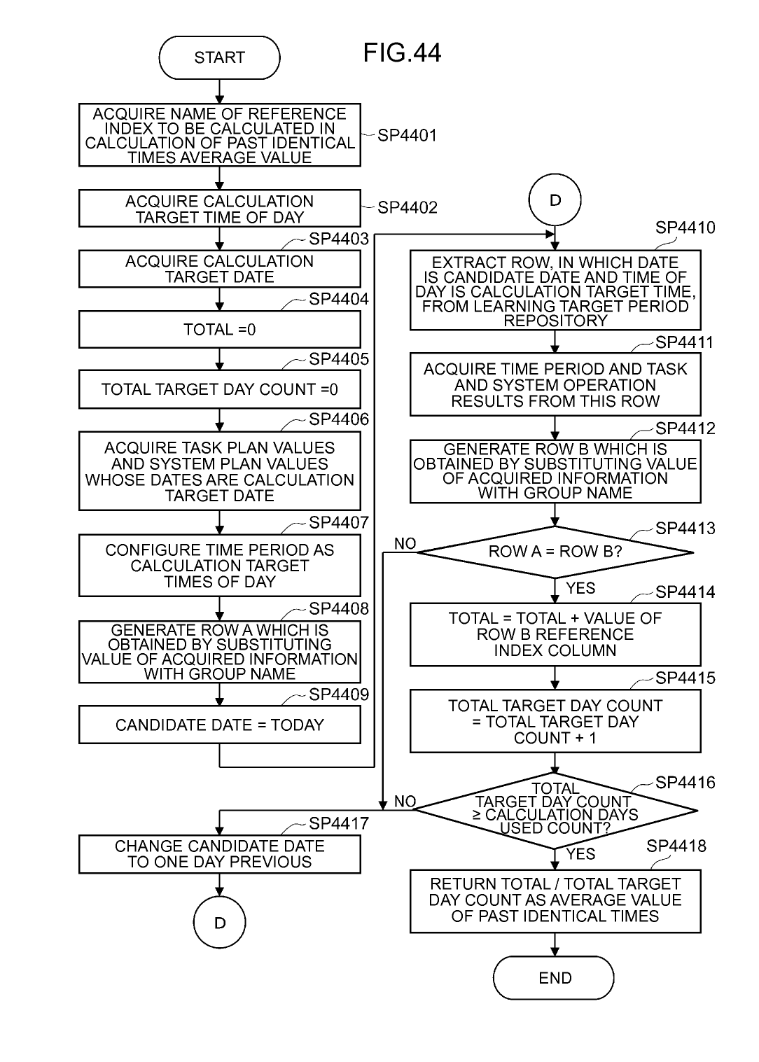

FIG. 44 shows a processing routine for second time-series prediction processing which is executed by the time-series prediction unit 705 (FIG. 6) while utilizing the data of this data structure 4300.

In a case where the foregoing past identical time average value method is used in time-series prediction as the past identical time average value method, the time-series prediction unit 705 executes the second time-series prediction processing shown in FIG. 44 instead of the time-series prediction processing described hereinabove with reference to FIG. 14B when an instruction to execute time-series prediction processing is supplied from the task control unit 708 in step SP1405 of the inference processing described hereinabove with reference to FIG. 14A.

Upon starting the second time-series prediction processing, the time-series prediction unit 705 first acquires the name of the reference index for which the average value is to be calculated in the past identical time average value calculation, and the calculation target time of day and calculation target date respectively (SP4401 to SP4403).

Thereafter, upon resetting the total information and total target day count (configuring the values as ‘0’) (SP4404, SP4405), the time-series prediction unit 705 acquires the task plan values and system plan values whose dates are the calculation target date from the operation plan repository 1614 (SP4406). The time-series prediction unit 705 also configures the time period as the calculation target time of day (SP4407).

The time-series prediction unit 705 subsequently references the grouping repository 417 (FIG. 13D) and generates the foregoing row A information 4307 which was obtained by converting the value of the information obtained in step SP4407 to the group name of the corresponding group (SP4307).

The time-series prediction unit 705 then configures the candidate date as today's date (SP4409). The time-series prediction unit 705 also extracts the row of the group, in which the date is the candidate date and the time is the calculation target time of day, from the corresponding internal table 1331 in the learning target period repository 415 (SP4410).

The time-series prediction unit 705 then acquires the group name of the group of the corresponding time period which is stored in the time period field 1331B (FIG. 13C) and information on the task operation results and system operation results which is stored in the respective operation results fields 1331C (FIG. 13C) respectively, from the row extracted in step SP4410 (SP4411).

The time-series prediction unit 705 subsequently references the grouping repository 417 (FIG. 13D) and generates the foregoing row B information 4308 which was obtained by converting the value of the information acquired in step SP4411 to the group name of the corresponding group (SP4312).

The time-series prediction unit 705 then judges whether or not there is an exact match between the value of the row A information 4307 generated in step SP4408 and the value of row B information 4308 which was generated in step SP4411 (SP4413).

Here, obtaining a negative result in this judgment means that the task operation results and system operation results patterns on the calculation target date do not match the task operation results and system operation results on the candidate date and that the calculation target date and candidate date are not in the same operation state. The time-series prediction unit 705 accordingly advances to step SP4417.

If, on the other hand, an affirmative result is obtained in the judgment of step SP4413, this means that the task operation results and system operation results patterns on the calculation target date match the task operation results and system operation results of the candidate date and that the calculation target date and candidate date are in the same operation state. The time-series prediction unit 705 accordingly adds together the value of each reference index of the current total information 4304 and the value of the corresponding reference index in the row B information 4308 and configures the addition result as the value of the new total information 4304 (SP4414).

The time-series prediction unit 705 then updates the value of the total target day count information 4305 to a value which is obtained by increasing the current value by 1 (SP4415) and subsequently judges whether or not the value of the current total target day count information 4305 is equal to or more than the value of the calculation days used count information 4306 (SP4416).

If a negative result is obtained in this judgment, the time-series prediction unit 705 updates the value of the candidate date information 4303 to a date one day earlier than the current date (SP4417). The time-series prediction unit 705 then returns to step SP4410 and subsequently repeats the processing of steps SP4410 to SP4417 until an affirmative result is obtained in step SP4416.

If an affirmative result is obtained in step SP4416 because the value of the total target day count information 4305 is already equal to or more than the value of the calculation days used count information 4306, the time-series prediction unit 705 calculates the average value of the reference indices by dividing the value of each of the reference indices in the current total information 4304 by the value of the total target day count information 4305, and after outputting this calculated average value of the reference indices to the inference unit 706, ends the second time-series prediction processing.

(3-2) Portal Server Configuration

(3-2-1) Web Server Logical Configuration

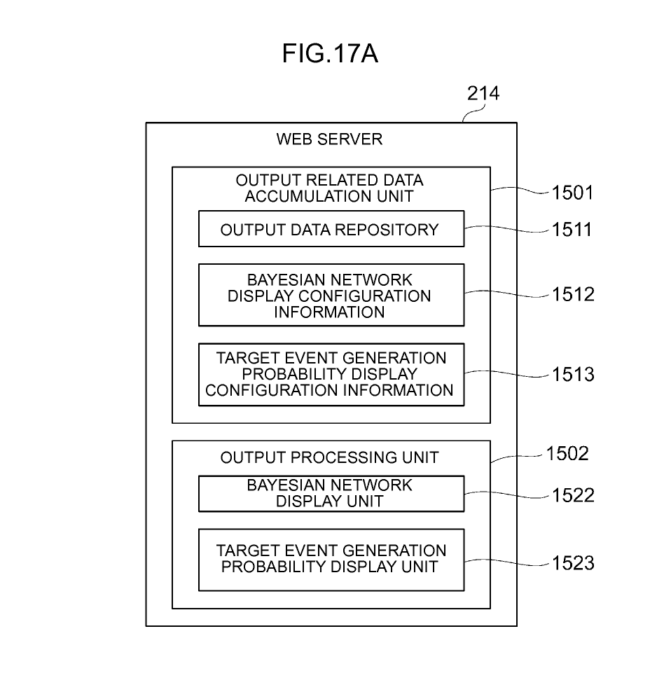

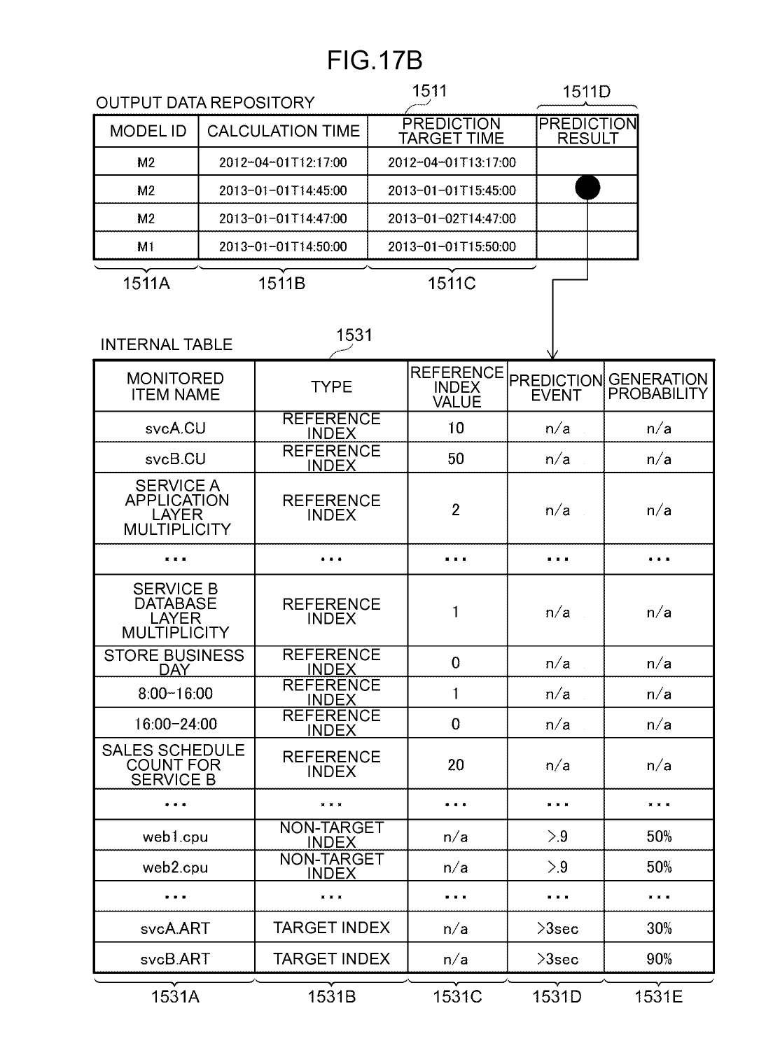

FIGS. 17A and 17B show a logical configuration of the web server 214 which is installed on the portal server 115 (FIG. 2). The web server 214 is configured comprising an output related data accumulation unit 1501 and an output processing unit 1502. The output related data accumulation unit 1501 comprises an output data repository 1511 and control information pertaining to display configuration. In the present embodiment, as the control information pertaining to display configuration, an example is shown which includes configuration information for a Bayesian network display (hereinafter called ‘Bayesian network display configuration information’) 1512 and configuration information for displaying target events (hereinafter called ‘target event display configuration information’) 1513.

Furthermore, the output processing unit 1502 comprises a Bayesian network display unit 1522 and a target event generation probability display unit 1523. Control information and programs for displaying other screens such as a login screen are not shown but may be added if required. The web server 214 communicates with the web browser 212 (FIG. 2) of the monitoring client 116 (FIG. 2) which the customer system 301 (FIG. 2) comprises by means of the HTTP protocol or HTTPS protocol or the like. The web server 214 transmits a drawing output to the web browser 212 using HTML5 or the like.

The output data repository 1511 accumulates data of prediction results (operation plan values, time-series prediction results, inference results). This data is created by the time-series prediction unit 705 (FIG. 6) and inference unit 706 (FIG. 6) in the predictor program 201 (FIG. 6) as described hereinabove and is referenced by the output processing unit 1502.

As shown in FIG. 17B, the output data repository 1511 possesses a table structure which is configured from a model ID field 1511A, a calculation time field 1511B, a prediction target time field 1511C and a prediction result field 1511D. Further, the model ID field 1511A stores model IDs which are assigned to each of the models registered in the model repository 413 (FIG. 13A) and the calculation time field 1511B stores the times the prediction calculation was performed for the corresponding model.

Further, the prediction target time field 1511C stores the times of the prediction targets (hereinafter called ‘prediction target times’) and the prediction result field 1511D stores pointers which point to the corresponding internal table 1531. For example, for the task ‘T1’ in the task list table 900 (FIG. 9B), the last update date and time of task ‘T1’ is ‘2012-04-01-T12:17:00’ and the lead time for which the prediction profile ID in the prediction profile table 411 (FIG. 8) is ‘P2’ is ‘1 hour,’ and therefore, as shown in FIG. 17B, a row in which the model ID is ‘M2,’ the calculation time is ‘2012-04-01-T12:17:00,’ and the prediction target time is ‘2012-04-01-T13:17:00’ is created in the output data repository 1511.

The internal table 1531 is configured from a monitored item name field 1531A, a type field 1531B, a reference index value field 1531C, a prediction event field 1531D and a generation probability field 1531E. Further, the monitored item name field 1531A stores the names (monitored item names) of each of the monitoring target items in the corresponding models. Furthermore, the type field 1531B stores the types of the corresponding monitoring target items (reference index values, target indices or non-target indices).

Further, if the type of the monitoring target item is a reference index value, the result of the time-series prediction and creation results of the various repositories are transferred as is to the corresponding reference index value fields 1531C and the prediction event field 1531D and generation probability field 1531E store ‘n/a (not available)’ means that such fields are invalid.

In addition, in a case where the type of the monitoring target item is a target index or non-target index value, the prediction event which is stored in the corresponding prediction event field 411H (FIG. 8) of the prediction profile table 411 (FIG. 8) is transferred as is to the prediction event field 1531D, the generation probability calculated with reference to the prediction profile table 411 is stored in the generation probability field 1531E, and the aforementioned ‘n/a’ is configured in the reference index value field 1531C.

(3-2-2) Bayesian Network Display Screen Configuration and Display Processing Thereof

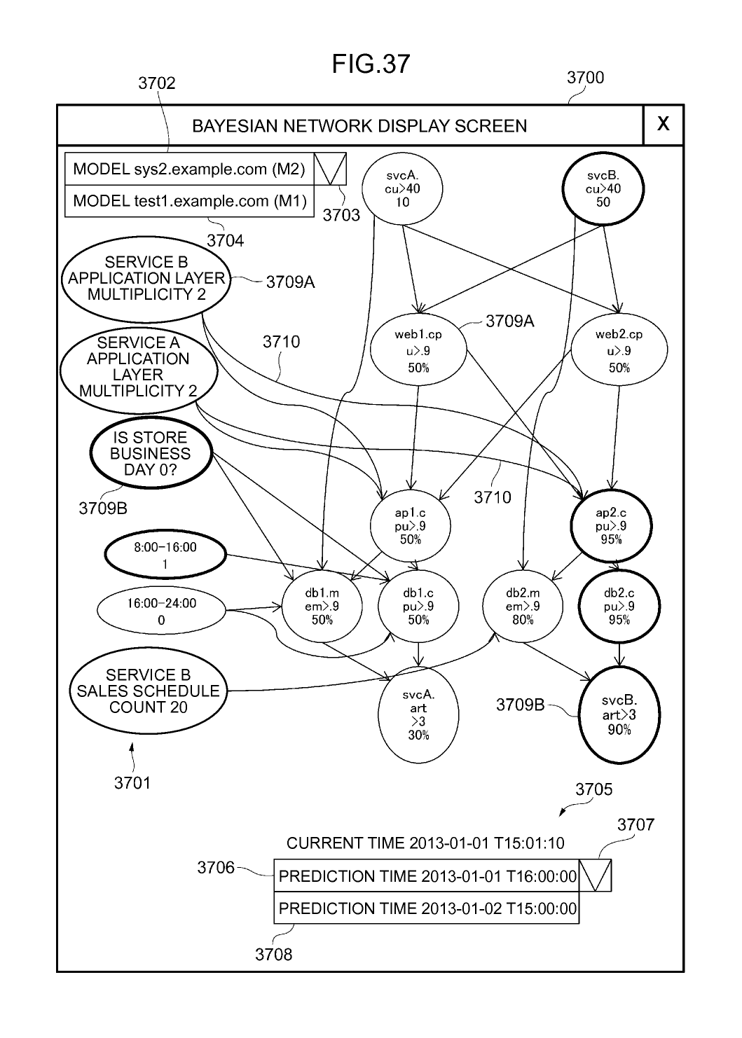

FIG. 37 shows a Bayesian network display screen 3700 which is one of the screens which the portal server 115 (FIG. 2) provides to the monitoring client 116 (FIG. 2). The Bayesian network display screen 3700 is a screen for displaying a graph structure 3701 of a Bayesian network at the designated prediction time of the designated model.

In reality, a model designation field 3702 and a pulldown menu button 3703 are displayed in the top right of the Bayesian network display screen 3700. Further, on the Bayesian network display screen 3700, a pulldown menu (hereinafter called a ‘model selection pulldown menu’) 3704 displaying the model names of all the models for which the Bayesian network graph structure 3701 can be displayed can be displayed by clicking the pulldown menu button 3703, and by clicking one desired model name from among the model names displayed in the model selection pulldown menu 3704, the model with this model name can be designated as the model for which the Bayesian network graph structure 3701 is to be displayed. In this case, the model name is displayed in the model designation field 3702.

In addition, the current time 3705 is displayed at the bottom of the Bayesian network display screen 3700 and a prediction time designation field 3706 and a pulldown menu button 3707 are displayed below the current time 3705. Further, on the Bayesian network display screen 3700, a pulldown menu (hereinafter called the ‘prediction time selection pulldown menu’) 3708, which displays all the prediction times of the displayable Bayesian network, can be displayed by clicking the pulldown menu button 3707, and by clicking one desired prediction time from among the prediction times displayed in the prediction time selection pulldown menu 3708, this prediction time can be designated as the prediction time of the Bayesian network to be displayed on the Bayesian network display screen 3700. In this case, the prediction time is displayed in the prediction time designation field 3706.

Further, the Bayesian network graph structure 3701 at the prediction time of this model is displayed on the Bayesian network display screen 3700 if the model and prediction time are designated as mentioned earlier.

Note that, in FIG. 37, while a lot of nodes 3709A are displayed with lines of normal thickness, a few nodes 3709B are represented by thick lines.

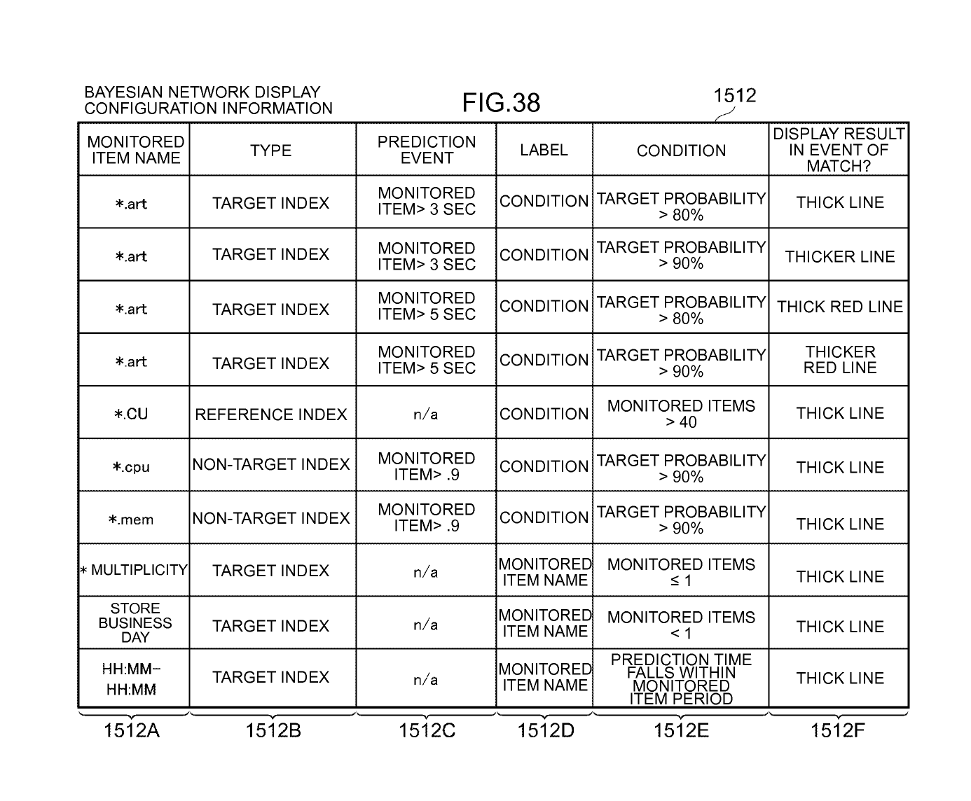

FIG. 38 shows a data structure of Bayesian network display configuration information 1512 which is referenced when creating the screen data of the Bayesian network display screen 3700. This Bayesian network display configuration information 1512 is preconfigured by the system administrator of the monitoring service provider system 302 (FIG. 2) and held by the portal server 115 (see FIG. 17A). The configuration of the Bayesian network display configuration information 1512 in the portal server 115 is carried out via the console 105 (FIG. 1) of the portal server 115.

As can also be seen from FIG. 38, the Bayesian network display configuration information 1512 has a table structure comprising a monitored item name field 1512A, a type field 1512B, a prediction event field 1512C, a label field 1512D, a condition field 1512E and a display effect in event of match field 1512F.

Further, the monitored item name field 1512A stores the names of the monitored items containing a wild card (‘*’) and the type field 1512B stores the types of the corresponding monitored items (target index, non-target index or reference index). In addition, the prediction target field 1512C stores the prediction event when the type of the corresponding monitored item is a target index or non-target index and stores ‘n/a’ to indicate that there is no information when the type of the corresponding monitored item is reference index.

Furthermore, the label field 1512D stores the labels of the corresponding monitored items and the condition field 1512E stores the conditions for applying the display effects in the event of a match. In addition, the display effect in event of match field 1512F stores the display effect applied to oval plotting when conditions are met.

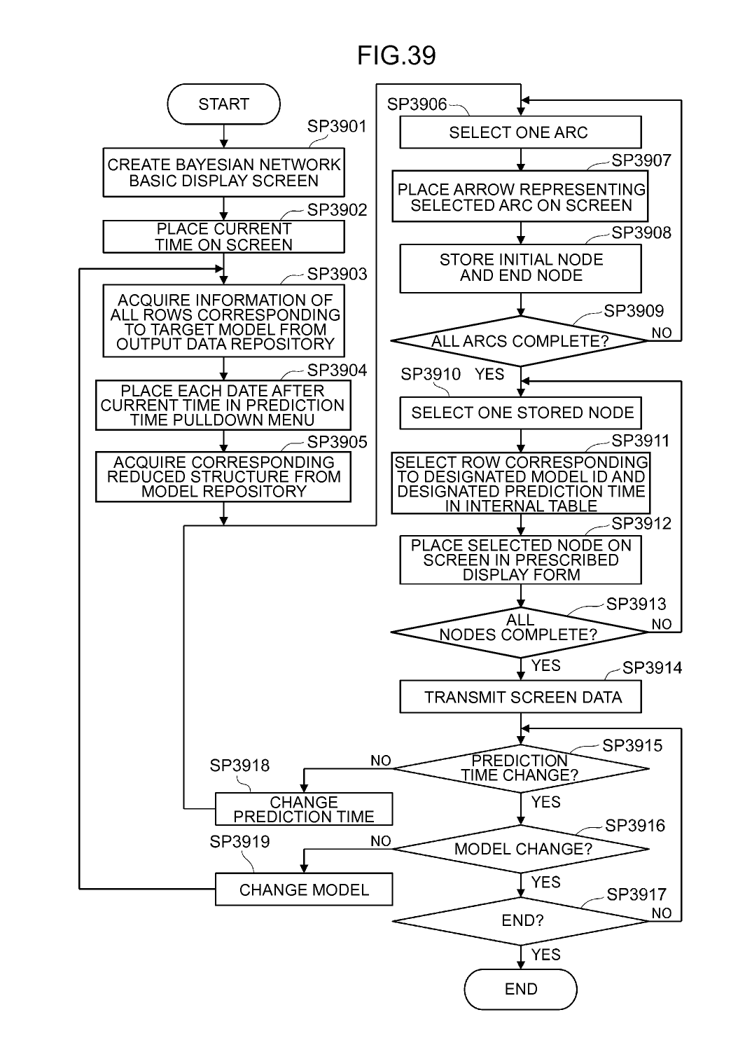

FIG. 39 shows a processing routine for Bayesian network display screen display processing which is executed by the web server 214 (strictly speaking, the Bayesian network display unit 1522 of the output processing unit 1502 described hereinabove with reference to FIG. 17A) of the portal server 115 based on this Bayesian network display configuration information 1512. The web server 214 generates the screen data of the Bayesian network display screen 3700 which displays the Bayesian network graph structure at the designated prediction time of the designated model, according to the processing routine shown in FIG. 39, and transmits the screen data to the monitoring client 116 (FIG. 2).

In reality, when the monitoring client 116 (FIG. 2) is operated by the system administrator of the customer system 301 (FIG. 2) and a request to display the Bayesian network display screen 3700 is received from the monitoring client 116, the web server 214 starts the Bayesian network display screen display processing shown in FIG. 39 and first creates a screen which forms the basis of the Bayesian network display screen 3700 (this is not a screen on which the Bayesian network and so forth is drawn and will be called a ‘Bayesian network basic display screen’ hereinbelow) (SP3901).

The web server 214 then places the current time in a predetermined position on the Bayesian network basic display screen (SP3902) and subsequently acquires information of all the rows corresponding to the model serving as the Bayesian network display target (the model which is initially registered in the very first row of the output data repository 1511) from the output data repository 1511 (FIG. 17B) (SP3903).

Thereafter, the web server 214 places the prediction event times after the current time among the prediction target times stored in the prediction event time field 1511C (FIG. 17B) of each row contained in the information acquired in step SP3903, in the prediction time selection pulldown menu 3708 (FIG. 37) (SP3904) and then acquires the structural data of the reduced Bayesian network from the corresponding reduced structure field 413C in the model repository 413 (FIG. 13A) (SP3905).

In addition, the web server 214 selects one arc constituting the reduced Bayesian network based on the structural data acquired in step SP3905 (SP3906) and places an arrow representing this arc on the Bayesian network basic display screen (SP3907). Further, the web server 214 stores the initial node and end node of the arc (SP3908). However, the web server 214 does not store the initial node or end node when the initial node or end node of this arc matches the initial node or end node of another arc that has already been stored, in order to avoid overlap between nodes.

The web server 214 then judges whether or not execution of the processing of steps SP3906 to SP3908 is complete for all the arcs constituting the reduced Bayesian network based on the structural data acquired in step SP3905 (SP3909). Further, if a negative result is obtained in this judgment, the web server 214 returns to step SP3906 and then repeats the processing of steps SP3906 to SP3909.

Furthermore, if an affirmative result is obtained in step SP3909 as a result of already completing execution of the processing of steps SP3906 to SP3908 for all the arcs constituting the reduced Bayesian network based on the structural data acquired in step SP3905, the web server 214 selects one node from among the nodes (initial node and end node) which were stored in step SP3908 (SP3910).

Thereafter, the web server 214 selects a row which corresponds to the node (the node selected in step SP3910) then serving as the target from the internal table 1531 (FIG. 17B) and which corresponds to the model ID of the model then serving as the target (initially the first model, and if any of the models has been selected via the model selection pulldown menu 3704, then the selected model) and to the prediction time then serving as the target (the prediction time selected via the prediction time selection pulldown menu 3708) (SP3911).

Further, the web server 214 places the node then serving as the target on the Bayesian network basic display screen based on the information contained in the row selected in step SP3911 and on the Bayesian network display configuration information 1512 described earlier with reference to FIG. 38 (SP3912). More specifically, the web server 214 places this node on the Bayesian network basic display screen in the form of a mark with an oval shape inside which is displayed the character string stored in the corresponding label field 1512D of the Bayesian network display configuration information 1512, and if this node conforms with the condition stored in the corresponding condition field 1512E of the Bayesian network display configuration information 1512, this mark exhibits the display effect stored in the corresponding display effect in event of match field 1512F of the Bayesian network display configuration information 1512.

The web server 214 also judges whether or not execution of the processing of steps SP3910 to SP3912 is complete for all the nodes stored in step SP3908 up to that point (SP3913). Further, if a negative result is obtained in this judgment, the web server 214 then returns to step SP3910 and subsequently repeats the processing of steps SP3910 to SP3913 while sequentially switching the node selected in step SP3910 to another unprocessed node.

If an affirmative result is obtained in step SP3913 as a result of already completing execution of the processing of steps SP3910 to SP3912 for all the nodes stored in step SP3908 up to that point, the web server 214 transmits the screen data of the Bayesian network display screen 3700 created as described hereinabove to the monitoring client 116 of the customer system 301 (SP3914). The Bayesian network display screen 3700 described hereinabove with reference to FIG. 37 is thus displayed on the console 105 (FIG. 1) of the monitoring client 116 based on the screen data.

Thereafter, the web server 214 awaits the transmission, from the monitoring client 116, of a notification to the effect that another prediction time has been selected from the prediction time selection pulldown menu 3708 of the Bayesian network display screen 3700, that another model has been selected from the model selection pulldown menu 3704 of the Bayesian network display screen 3700, or that the Bayesian network display screen 3700 has been closed (SP3915 to SP1917).

Further, when notification is received from the monitoring client 116 that another prediction time has been selected from the prediction time selection pulldown menu 3708 of the Bayesian network display screen 3700 together with the prediction time selected at the time, the web server 214 switches the prediction time serving as the target to the prediction time then notified (SP3918). Further, the web server 214 subsequently returns to step SP3906 and processes the processing of step S3906 and subsequent steps as described hereinabove.

Furthermore, when notification is received from the monitoring client 116 that another model has been selected from the model selection pulldown menu 3704 of the Bayesian network display screen 3700 together with the model ID of the model selected at the time, the web server 214 switches the model serving as the target to the model with the model ID then notified (SP3919). Further, the web server 214 subsequently returns to step SP3903 and processes the processing of step S3903 and subsequent steps as described hereinabove.

If, however, notification to the effect that the Bayesian network display screen 3700 has been closed is transmitted from the monitoring client 116, the web server 214 ends the Bayesian network display screen display processing.

(3-2-3) Configuration of Target Event Generation Probability Display Screen and Display Processing Thereof

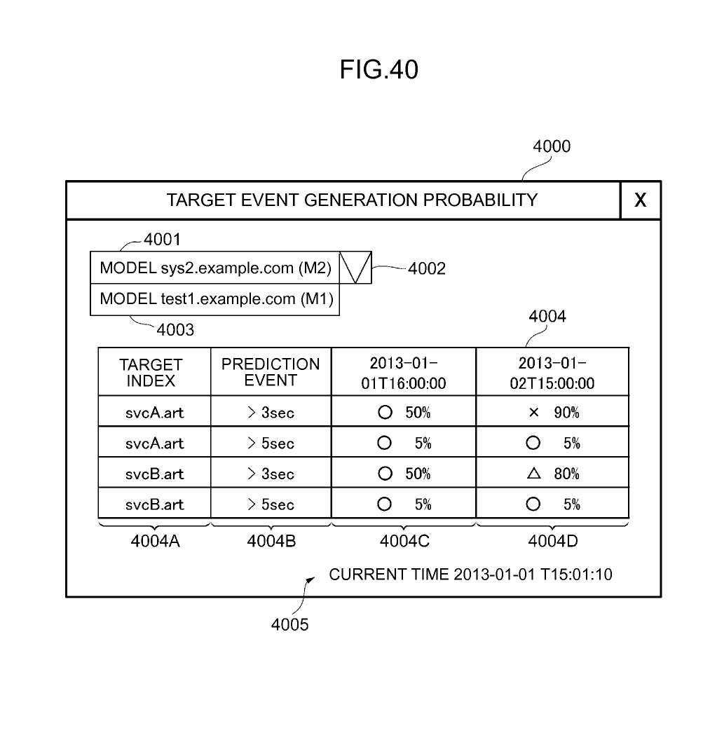

FIG. 40 shows a target event generation probability display screen 4000 which is one of the screens provided by the portal server 115 to the monitoring client 116. This target event generation probability display screen 4000 is a screen for displaying the probability that a target event will be generated.

In reality, a model designation field 4001 and a pulldown menu button 4002 are displayed in the top right of the target event generation probability display screen 4000. Further, it is possible to display a model selection pulldown menu 4003 which displays the model names of all the models for which the target event generation probability can be displayed on the target event generation probability display screen 4000 by clicking the pulldown menu button 4002, and by clicking one desired model name from among the model names displayed in the model selection pulldown menu 4003, the model with that model name can be designated as the model for which the Bayesian network graph structure is to be displayed. In this case, the model name is displayed in the model designation field 4001.

In addition, a target event generation probability list 4004 is displayed in the middle of the target event generation probability display screen 4000. This target event generation probability list 4004 is configured from a target index field 4004A and prediction event field 4004B, and one or more target event generation probability fields 4004C. Further, the target index field 4004A stores the target index in the corresponding model and the prediction event field 4004B stores the prediction event for the corresponding target index. Furthermore, the target event generation probability field(s) 4004C store(s) the probability of the corresponding target event being generated at the prediction time displayed in the uppermost field of the target event generation probability field 4004C (hereinafter called the ‘header field’) in the target event generation probability list 4004.

Thus, in the case of FIG. 40, it can be seen that, for a model known as ‘model sys2.example.com(M2),’ for example, the probability of the target event ‘svA.art3>3 sec’ being generated is ‘50%’ at ‘2013-01-01: T16:00:00’ and ‘90%’ at ‘2013-01-01: T15:00:00.’ Note that a metaphor (graphic) ‘[empty circle],’ ‘[empty triangle],’ or ‘x’ is displayed to the left of numerical characters indicating the corresponding target event generation probability in the target event generation probability field 4004C. As will be described subsequently, these metaphors are displayed in association with the corresponding target event generation probability values; ‘x’ is displayed when the target event generation probability is greater than 80%, ‘[empty triangle]’ is displayed when this same generation probability is greater than 70% and equal to or less than 80%, and ‘[empty circle]’ is displayed when this generation probability is equal to or less than 70%.

Furthermore, the current time 4005 is displayed at the bottom of the target event generation probability display screen 4000.

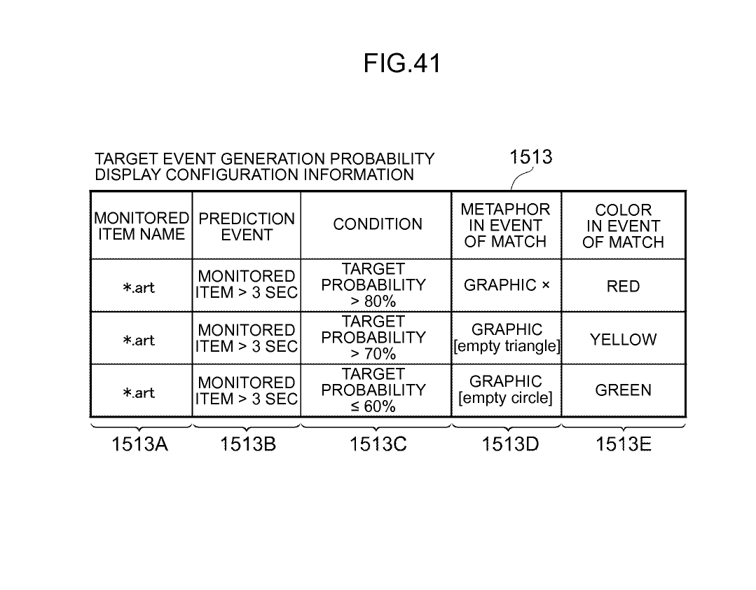

FIG. 41 shows target event generation probability display configuration information 1513 which is referenced when creating the target event generation probability display screen 4000. This target event generation probability display configuration 4100 is held by the portal server 115 which is preconfigured by the system administrator of the monitoring service provider system 302 (FIG. 2) (see FIG. 17A). Configuration of the target event generation probability display configuration information 1513 on the portal server 115 is performed via the console 105 (FIG. 1) of the portal server 115.

This target event generation probability display configuration information 1513 has a table structure which is configured from a monitored item name field 1513A, a prediction event field 1513B, a condition field 1513C, a metaphor in event of match field 1513D and a color in event of match field 1513E.

Further, the monitored item name field 1513A stores the item names containing a monitored item wild card (‘*’) and the prediction event field 1513B stores the prediction events of the corresponding monitored items. Furthermore, the condition field 1513C stores the conditions for the corresponding prediction events and the metaphor in event of match field 1513D stores, in cases where the respective corresponding prediction events fulfill the condition stored in the corresponding condition field, a metaphor (‘[empty circle],’ ‘[empty triangle]’ or ‘x’) which is to be displayed in the corresponding target event generation probability field 4004C (FIG. 40) in the target event generation probability list 4004 (FIG. 40) in the target event generation probability display screen 4000 of FIG. 40. Further, the color in event of match field 1513E stores a character string and metaphor display color which represent the generation probability when the corresponding condition is fulfilled.

According to the present embodiment, the target event generation probabilities are thus displayed together for a plurality of prediction target times on the target event generation probability display screen 4000, however, because character strings representing the generation probabilities are displayed using colors corresponding to the size of the generation probabilities and metaphors corresponding to the generation probabilities are displayed, these generation probabilities are easily discriminated. As a result, with the target event generation probability display screen 4000 according to the present embodiment, the system administrator or person responsible for the task of the customer system 301 viewing the target event generation probability display screen 4000 via the monitoring client 116 of the customer system 301 is able to easily understand the service performance predictions provided by the monitoring target system 311.

Once a display that is different from normal is generated in the performance prediction, when the user of the monitoring client 116 of the customer system 301 (that is, the person receiving provision of the monitoring service) is viewing the Bayesian network display screen 3700, it is helpful to pay more attention to ovals that are drawn with a thick red line than to the ovals of the reference indices, non-target indices and target indices which are drawn with lines of a normal color (black, for example) and normal thickness, in order to narrow down the causes of performance prediction results which are different from normal (judge and examine where to check, that is, use Root cause analysis).

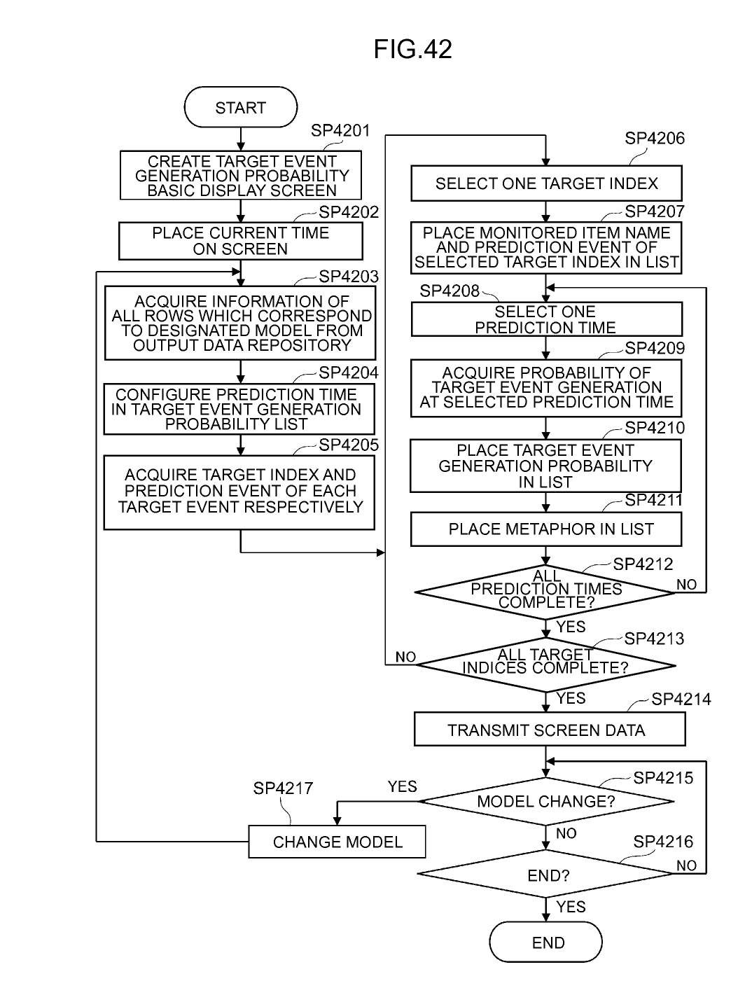

FIG. 42 shows a processing routine for target event generation probability display processing which is executed by the web server 214 of the portal server 115 (more precisely, the target event generation probability display unit 1523 of the output processing unit 1502 described hereinabove with reference to FIG. 17A), based on the target event generation probability display configuration 4100. The web server 214 generates the screen data of the target event generation probability display screen 4000, which displays the probability of the target event being generated at each prediction time of the designated model, according to the processing routine shown in FIG. 42, and transmits this screen data to the monitoring client 116 (FIG. 2).

In reality, when the monitoring client 116 is operated by the system administrator of the customer system 301 and a request to display the target event generation probability display screen 4000 is supplied from the monitoring client 116, the web server 214 starts the target event generation probability display processing shown in FIG. 42 and first creates a screen which forms the basis of the target event generation probability display screen 4000 (this is a screen in which the target event generation probability list 4004 (FIG. 40) and the model selection pulldown menu 4003 (FIG. 40) are in a void state and will be called the ‘target event generation probability basic display screen’ hereinbelow) (SP4201).

The web server 214 then places the current time in a predetermined position on the target event generation probability basic display screen (SP4202). The web server 214 also acquires information of all the rows corresponding to the target model for displaying the target event generation probability from the output data repository 1511 (FIG. 17B) (the model which is initially registered in the very first row of the output data repository 1511) from the output data repository 1511 (FIG. 17B) and places a character string representing the model name of the target model in the model designation field 4001 of the target event generation probability display screen 4000 (FIG. 40) (SP4203).

The web server 214 then creates the respective columns of the target event generation probability field 4004C (FIG. 40) in the target event generation probability list 4004 (FIG. 40) in association with the prediction target times after the current time among the prediction target times which are stored in the prediction target time fields 1511C (FIG. 17B) of each of the rows in the output data repository 1511 and which are contained in the information acquired in step SP4203, and configures the respective prediction target times corresponding to the uppermost level (index field) of these columns (SP4204).

The web server 214 subsequently references the corresponding internal table 1531 based on the information of each row of the output data repository 1511 acquired in step SP4203, and acquires the monitoring item names of the respective monitored items which are to serve as target indices for the corresponding model, as well as the prediction events of these monitored items (SP4205).

The web server 214 then selects one monitored item from among the monitored items which are to serve as target indices and which were acquired in step SP4205 (SP4206), places a character string indicating the monitored items in the target index field 4004A (FIG. 40) of the target event generation probability list 4004 (FIG. 40) and places a character string representing the prediction event in the corresponding prediction event field 4004B (FIG. 40) of the target event generation probability list 4004.

The web server 214 subsequently selects one prediction time from among the prediction times configured in the target event generation probability list 4004 in step SP4204 (SP4208). Further, the web server 214 acquires the generation probability at the prediction time selected in step SP4208 of the monitored item which is to serve as the target index and which was selected in step SP4206, from the corresponding internal table 1531 (SP4209), and places the character string representing the acquired generation probability in the corresponding target event generation probability field 4004C of the target event generation probability list 4004 (SP4210).

In addition, the web server 214 references the target event generation probability display configuration information 1513 (FIG. 41) and determines the metaphor corresponding to the prediction event based on the prediction event generation probability of the target index acquired in step SP4209, and places the determined metaphor in the corresponding target event generation probability field 4004C of the target event generation probability list 4004 (SP4211). Note that, in so doing, the web server 214 references the target event generation probability display configuration information 1513 (FIG. 41) and also determines the metaphor and the display color of the generation probability character string which are displayed in the corresponding target event generation probability field 4004C in the target event generation probability list 4004.

The web server 214 then judges whether or not execution of the processing of steps SP4208 to SP4211 is complete for all the prediction times which were configured in the target event generation probability list 4004 in step SP4204 (SP4212). Further, if a negative result is obtained in this judgment, the web server 214 returns to step SP4208 and subsequently repeats the processing of steps SP4208 to SP4211 while sequentially switching the prediction time selected in step SP4208 to another unprocessed prediction time.

If an affirmative result is obtained in step SP4212 as a result of already completing execution of the processing of steps SP4208 to SP4211 for all the prediction times configured for the target event generation probability list 4004, the web server 214 judges whether or not execution of the processing of steps SP4206 to SP4212 is complete for all the target indices acquired in step SP4205. Further, if a negative result is obtained in this judgment, the web server 214 returns to step SP4206 and then repeats the processing of steps SP4206 to SP4213 while sequentially switching the target index selected in step SP4206 to another unprocessed target index.

Furthermore, if an affirmative result is obtained in step SP4213 as a result of already completing execution of the processing of steps SP4206 to SP4212 for all the target indices acquired in step SP4205, the web server 214 transmits the screen data of the target event generation probability display screen 4000 created as described hereinabove to the monitoring client 116 of the customer system 301 (SP4214). The target event generation probability display screen 4000, which was described hereinabove with reference to FIG. 40, is thus displayed on the console 105 (FIG. 1) of the monitoring client 116 based on this screen data.

Thereafter, the web server 214 awaits the transmission, from the monitoring client 116, of a notification to the effect that another model has been selected from the model selection pulldown menu 4003 of the target event generation probability display screen 4000, or that the target event generation probability display screen 4000 has been closed (SP4215, SP4216).

Further, when notification is received from the monitoring client 116 that another model has been selected from the model selection pulldown menu 4003 together with the model ID of the model then selected, the web server 214 switches the model serving as the target to the model with the model ID then notified (SP4217). Further, the web server 214 subsequently returns to step SP4203 and processes the processing of step S4203 and subsequent steps as described hereinabove.

If, however, notification to the effect that the target event generation probability display screen 4000 has been closed is transmitted from the monitoring client 116, the web server 214 ends the processing routine of the target event generation probability display processing.

### (4) Advantageous Effects of Embodiment

As described earlier, with the information processing system 300 according to the present embodiment, a model (Bayesian network) of the monitoring target system 311 is generated by using task- and system operation plans and task operation results, and fault generation prediction is performed based on the generated model, and therefore prediction can be performed by considering the behavior of the monitoring target system 311 according to the task and system operation plans at prediction target times. Therefore, with this information processing system 300, more accurate performance prediction can be performed than when performance prediction is carried out by using only measurement values related to the inherent performance of the monitoring target system 311.

Moreover, with this information processing system 300, because an upper limit (period count upper limit) is provided for the learning target period count in the model learning processing (remodeling processing or fitting processing) of the monitoring target system 311 and since model learning processing is devised to always be performed based only on new measurement values (including task operation plan values and task operation plan results), it is also possible to prevent erroneous prediction, due to the passage of time and learning processing that uses unsuitable past measurement values, from being performed while preventing a huge learning time.

### (5) Further Embodiments

Note that, although, in the foregoing embodiment, a case was described in which the monitoring target system 311 is configured from two web layers, two application layers and two database layers configured from two web servers, two application servers and two database servers, the present invention is not limited to such a configuration, rather, configurations of a variety of other types can be widely applied as the configuration of the monitoring target system 311.

Furthermore, although a case was described in the foregoing embodiment in which, in the calculation of the average value of past identical times, the average value is found at times from ‘00:00:00 to 23:59:59’ which match, excluding the date, the present invention is not limited to such an average value calculation, rather, in the calculation of the average value of past identical times, the average value could also be calculated at times for which the ‘00:00 to 59:59’ parts match excluding the date and hour, for example. Just in case, it should be clarified that the present invention is not limited to a variable part in the time which is a date (YYYY-MM-DD) and a fixed part which is the time of day (HH:MM:SS), rather, methods in which the fixed part and variable part in the time are changed fall within the scope of the present invention.

Furthermore, although a case was described in the foregoing embodiment in which grouping of time periods involved dividing the day up into three equal parts of eight hours each, namely, ‘TM1’ from ‘0:00 to 8:00,’ ‘TM2’ from ‘8:00 to 16:00’ and ‘TM3’ from ‘16:00 to 24:00,’ the present invention is not limited to such time period grouping, rather, grouping may be such that time periods are grouped into four or more groups, or implementation may be such that the time periods of each group are of different lengths, such as ‘TM1a’=‘0:00 to 1:00’ and ‘TM2a=1:00 to 2:30,’ and so on, for example. Note that when the lengths of the groups are made different, the number of times which make up a learning target varies, i.e. there are twelve measurement values at five minute intervals each in ‘TM1a’ but eighteen measurement values at five minute intervals in ‘TM2a,’ for example. Although any slight variation in learning time that may occur may be ignored, when this variation is not slight, this may be taken into account and the process flow of the learning period adjustment unit 709 may be modified so that the measurement value count is approximately the same.

Further, the operation plan repository 1614 can be configured with different values from actual operation plans. Even when the operation of the task servers 110 known as ‘ap1’ and ‘ap2’ has actually been scheduled for the date ‘2012-04-31’ in the operation plan repository 1614 of FIG. 22, for example, if performance prediction is desired when the task server 110 known as ‘ap1’ is down, ‘0’ can be configured in the ‘apt column and ‘1’ in the ‘ap2’ column in row ‘2012-04-31’ of the operation plan repository instead of configuring ‘1’ in the ‘ap1’ column and ‘ap2’ column.

Performance prediction is thus also possible for a plan which differs from the actual operation plan, that is, for a hypothetical operation plan.

In addition, the sales prediction and results repository 1612 (FIG. 20) can also be configured with values which differ from the actual operation plans. Even when ‘SVC2 total sales prediction (k units)’ on the date ‘2012-04-31’ is actually ‘1520,’ for example, in the sales prediction and results repository 1612 in FIG. 20, if performance prediction is desired when there is an increase of ‘30 k units’ to ‘1550,’ ‘1550’ can be configured instead of ‘1520’ in the ‘SVC2 total sales prediction (k units)’ column in row ‘2012-04-31.’ Performance prediction is thus also possible for a plan which differs from the actual operation plan, that is, for a hypothetical operation plan.

Furthermore, the business day calendar repository 1613 (FIG. 21) may also be configured with different values from the actual operation plans. For example, even when ‘1,’ which signifies that a store business day with the date ‘2012-04-31’ is actually a business day, appears in the business day calendar repository 1613 in FIG. 21, if performance prediction is desired when the store is closed, ‘0’ can be configured instead of ‘1’ in the store business day column in row ‘2012-04-31.’ Performance prediction is thus also possible for a plan which differs from the actual operation plan, that is, for a hypothetical operation plan.

Moreover, although a case was described in the foregoing embodiment in which the business day calendar repository 1613 (FIG. 21) has a store business day field 1613B indicating whether or not it is a business day for the store (manned store), the present invention is not limited to such a field, rather, a special device business day field which indicates whether a vending machine, ATM or another special device is operating, may also be provided instead of the store business day field 1613B.

Note that, although the value of the store business day field 1613B in the business day calendar repository 1613 is either ‘0’ or ‘1’ according to the forgoing embodiment, such numbering could also be expanded to natural numbers such as the number of open stores, instead of the store business day field 1613B. For example, groups with the group names ‘SHOP0,’ ‘SHOP1’ and ‘SHOP10+’ may be prepared as the group names and ‘SHOP0’ may be defined as ‘0’ open stores, ‘SHOP1’ may be defined as ‘1 to 9’ open stores, and SHOP10+′ may be defined as ‘10 or more’ open stores. In such a case, the act of referencing the grouping repository in step SP3207 of the learning period adjustment processing described hereinabove with reference to FIG. 32 uses these group names and therefore this has the effect of contributing to a reduction in the number of combinations (merely reduces the number of dates in combination) in an identical operation state which are to be added in the learning period adjustment processing. Further, since these group names are used in steps SP4408 and SP4413 of the past time of day identical time average value calculation processing described earlier with reference to FIG. 42, this also affords the effect of enabling the selection of dates used in the average value calculation by group name when these dates are considered to be in an identical operation state.

In addition, although a case was described in the foregoing embodiment in which information is stored and held using ‘date’ units in the sales prediction and results repository 1612 (FIG. 20), business day calendar repository 1613 (FIG. 21), operation plan repository 1614 (FIG. 22) and operation results repository 1615 (FIG. 23), the present invention is not limited to such units, rather, periods obtained by subdivision into smaller units than ‘dates,’ such as periods obtained by subdividing a single day into a.m. and p.m. (‘2013-04-31 AM’ and ‘2013-04-31 PM’), for example, may be taken as information storage units or the date and time (‘2013-04-31 T09:**:**’) may be adopted as information storage units.

Moreover, although a case was described in the foregoing embodiment in which the monitoring service provider system 302 is installed in a separate location (the monitoring service provider site) from the customer site where the customer system 301 is installed, the present invention is not limited to such a location, rather, the monitoring service provider system 302 could also be installed on the customer site together with the customer system 301 with the objective of performing fault prediction for an information system product instead of performing fault prediction for service provision.

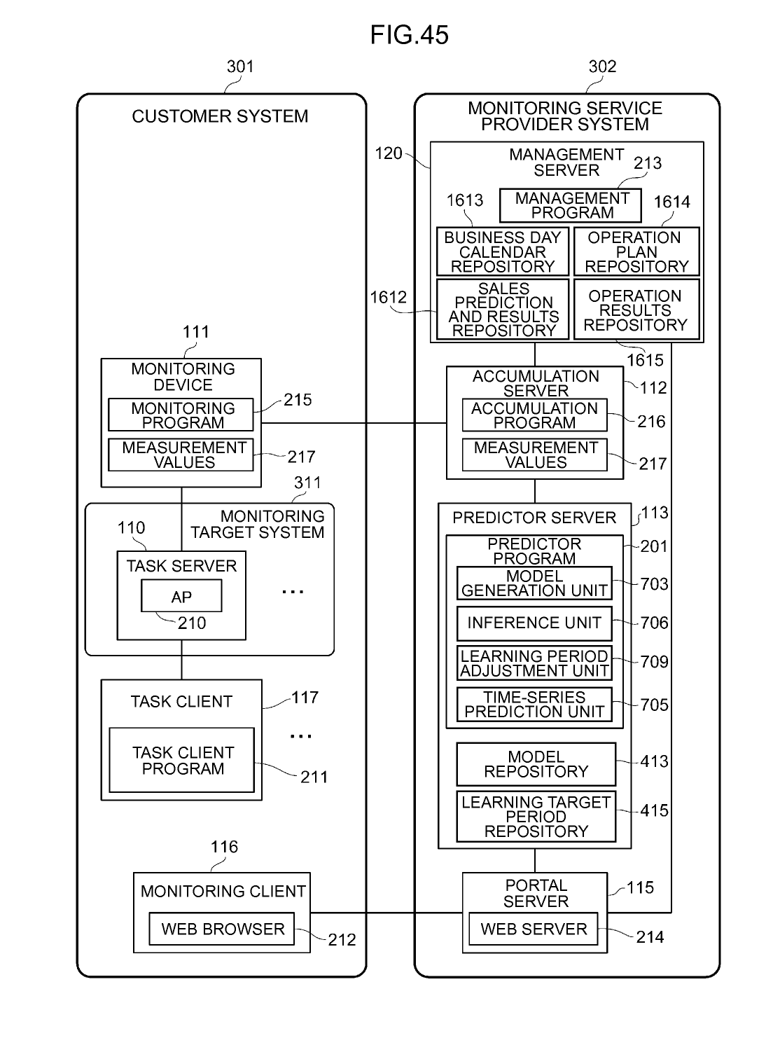

Furthermore, although a case was described in the foregoing embodiment in which the management server 120 is installed on the customer site as part of the customer system 301, the present invention is not limited to such a case, rather, the management server 120 could also be installed on the monitoring service provider site as part of the monitoring service provider system 302 as shown in FIG. 45, for example, for the purpose of also providing the management of task operation and system operation plans and results as a service, in addition to providing a fault predictor service. In this case, the management program contained in the management server 120 is amended to enable I/O of commands and information via the portal server 115 instead of I/O of commands and information via the console 105 (FIG. 1).

Furthermore, although a case was described in the foregoing embodiment where the accumulation server 112 is configured, as per FIG. 1, as an accumulation device for acquiring and accumulating measurement values which are collected by the monitoring device 111, and where the predictor server 113 is configured, as per FIGS. 1 and 7, as a performance prediction device which generates a probability model (Bayesian network) for the monitoring target system 311 and uses this probability model to calculate the probability that a target event will be generated, the present invention is not limited to such configurations, rather, a variety of other configurations can be widely applied as configurations for the accumulation server 112 and predictor server 113.

### INDUSTRIAL APPLICABILITY

The present invention can be applied widely to information processing systems with a variety of configurations for providing a monitoring service for detecting predictors of fault generation in a customer monitoring target system and notifying the customer of the detected predictors.

### REFERENCE SIGNS LIST

110 Task server
111 Monitoring device
112 Accumulation server
113 Predictor server
115 Portal server
116 Monitoring client
117 Task client
120 Management server
210 Application program
211 Task client program
212 Web browser
213 Management program
214 Web server
215 Monitoring program
216 Accumulation program
217 Measurement values
301 Customer system
302 Monitoring service provider system
413 Model repository
415 Learning target period repository
703 Model generation unit
705 Time-series prediction unit
706 Inference unit
709 Learning period adjustment unit
1612 Sales prediction and results repository
1613 Business day calendar repository
1614 Operation plan repository
1615 Operation results repository

1. A performance prediction method for predicting a performance of a monitoring target system including one or more information processing devices, comprising:
a first step of acquiring a plurality types of measurement values from the monitoring target system at regular intervals;
a second step of generating a probability model for calculating a probability that the measurement values respectively lying within a specific value range;
a third step of predicting a value at a future time of a reference index which is a portion of the measurement values; and
a fourth step of calculating a probability on which a target event will occur, based on the probability model, the target event being an event in which a specific measurement value, which is different from the reference index at the future time, lies within the specific range, with the value of the reference index regarded as a prerequisite,
wherein an operation results value of the monitoring target system is included in the measurement values of the second step,
wherein an operation plan value of the monitoring target system is included in the reference index of the third step, and
wherein the reference index is time-series predicted in the third step.

2. The performance prediction method according to claim 1,
wherein, in the third step, the value at the future time of the reference index is time-series predicted by means of a linear regression method.

3. The performance prediction method according to claim 1,
wherein, in the third step, the value at the future time of the reference index is time-series predicted by means of a method which finds an average value of the measurement values at an identical time on a predetermined number of past dates as the value at the future time of the reference index.

4. The performance prediction method according to claim 1,
wherein the measurement values include a resource usage amount or a resource usage ratio of the monitoring target system,
wherein the reference index includes an input amount to the monitoring target system, and
wherein the target event includes a probability on which a response time of the monitoring target system or a throughput of the monitoring target system will lie within a certain value range.

5. The performance prediction method according to claim 1,
wherein the operation plan value and the operation results value includes at least one plan value and results value, such as: a multiplicity of one or more subsystems on the monitoring target system; an amount and/or number of a product or service dealt with by the monitoring target system; and presence or absence, a transaction amount and/or a channel number regarding a transaction channel other than the monitoring target system.

6. The performance prediction method according to claim 5, further comprising, as the operation plan value and the operation results value:
information indicating whether the transaction channel other than the monitoring target system is either a manned store or an unmanned store.

7. The performance prediction method according to claim 1, further comprising:
a screen data generation step of generating screen data of a target event generation probability display screen which displays a probability on which the target event occurs,
wherein the probability on which the target event occurs is represented by at least one of a color and a metaphor on the target event generation probability display screen.

8. The performance prediction method according to claim 1,
wherein the measurement values used in the second step are appropriately selected,
wherein the method of appropriately selecting the measurement values is a method in which an oldest reference index is discarded in a group which was grouped using a combination of the value of the reference index and a range of the value.

9. The performance prediction method according to claim 3,
wherein the past dates are previous dates in the same operation state as an operation plan regarding the reference index at the future time.

10. The performance prediction method according to claim 1, comprising:
a reduction processing step of executing reduction processing on the probability model to exclude a portion of the reference indices from the probability model.

11. The performance prediction method according to claim 10,
wherein the specific reference index is included in the probability model.

12. The performance prediction method according to claim 1,
wherein multiple of the monitoring target systems exist and priorities for processing can be configured for each of the monitoring target systems,
wherein, in the fourth step,
priority is given to calculating the target event generation probability for the monitoring target system with the highest priority.

13. A performance prediction system for predicting a performance of a monitoring target system including one or more information processing devices, the system comprising:
an accumulation device which acquires and accumulates a plurality types of measurement values from the monitoring target system at regular intervals; and
a performance prediction device which generates a probability model for calculating a probability on which the measurement values respectively lie within a specific value range, predicts a value at a future time of a reference index which is a portion of the measurement values, and calculates a probability on which a target event occur, based on the probability model, the target event being an event in which another specific measurement value, which is different from the reference index at the future time, lies within the specific range, with the value of the reference index regarded as a prerequisite,
wherein an operation results value of the monitoring target system is included in the measurement values,
wherein an operation plan value of the monitoring target system is included in the reference index, and
wherein the performance prediction device time-series predicts the reference index.

14. A program for causing an information processing device to execute performance prediction processing for predicting a performance of a monitoring target system including one or more information processing devices, the performance prediction processing comprising:
a first step of generating a probability model for calculating a probability on which a plurality types of measurement values, which was acquired at regular intervals from the monitoring target system, lie within a specific value range;
a second step of predicting a value at a future time of a reference index which is a portion of the measurement values; and
a third step of calculating a probability on which a target event will occur, based on the probability model, the target event being an event in which a specific measurement value, which is different from the reference index at the future time, lies within the specific range, with the value of the reference index regarded as a prerequisite,
wherein an operation results value of the monitoring target system is included in the measurement values of the first step,
wherein an operation plan value of the monitoring target system is included in the reference index of the second step, and
wherein the reference index is time-series predicted in the second step.
